(19) United States
(12) Patent Application Publication
(10) Pub. No.: US 2023/0141471 A1
(43) Pub. Date: May 11, 2023

(54) ORGANIZING UNSTRUCTURED AND STRUCTURED DATA BY NODE IN A HIERARCHICAL DATABASE

(71) Applicant: VideoXRM Inc., Las Vegas, NV (US)

(72) Inventor: David N. Baker, Las Vegas, NV (US)

(21) Appl. No.: 18/050,924

(22) Filed: Oct. 28, 2022

Related U.S. Application Data
(60) Provisional application No. 63/277,046, filed on Nov. 8, 2021.

(51) Int. Cl. G06F 16/41; G06N 20/00

(52) U.S. Cl. CPC G06F 16/41; G06N 20/00

(57) ABSTRACT

This document presents methods, systems, and apparatuses for self-building hierarchically indexed multimedia databases and product and service-hierarchy databases that include multiple branches and multiple trees of nodes. The databases hierarchically organize video, audio, and documents per node. The documents can be architectural plans, investor presentations, technical specifications, product or service guides, market research reports), news, messages, industry information, regulatory status, licensing, blogs, etc. in some embodiments, the databases disclosed organize and track company market performance and stock investment information for issuers and inventors based on the products and services produced and offered by each competitor. The databases also organize and track podcasts-by-node, messages-by-node, text, voice messages-by-node, and voice calls-by-node.

### CROSS-REFERENCE TO RELATED APPLICATIONS

This application claims the benefit of U.S. Provisional Pat. Application No. 63/277,046, filed on Nov. 8, 2021, entitled “ORGANIZING UNSTRUCTURED AND STRUCTURED DATA BY NODE IN A HIERARCHICAL DATABASE,” and incorporated herein by reference in its entirety.

### FIELD OF THE INVENTION

This description relates generally to multimedia databases and specifically to self-building hierarchically indexed multimedia databases.

### BACKGROUND

A product and service-hierarchy database can organize comparable industry, sector, subsector, and group market performance and stock investment information centered around products produced and services performed by each company and its competitors, with each product or service type created as an index. Such product hierarchy enables the creation of an index for each product or service type that can be valued and measured. The product hierarchy database organizes and tracks company market performance and stock investment information by the products and services produced and offered by each competitor.

The product hierarchy is created in the database independently of the companies. The companies that produce each product are relationally linked to each product in the hierarchy that corresponds to a product produced or service performed by each company. An investment information service includes the product hierarchy database and makes it accessible to investor and analyst subscribers through a query system across the Internet. Data entry personnel load qualitative and quantitative information about companies and their products through a product hierarchy generator connected to the product hierarchy database. Subscribers can punch-through to query individual data items, and they can find out what relationships exist between important aspects of the companies and the products being tracked. Such a database also provides performance criteria by industry, sector, sub-sector, and group, thereby allowing industry, sector, sub-sector, and group-based qualitative assessment.

### SUMMARY

This document presents methods, systems, and apparatuses for self-building hierarchically indexed multimedia databases and product and service-hierarchy databases that include multiple branches and multiple trees of nodes. The databases hierarchically organize video-by-node, audio-by-node, and documents-by-node. The documents can be architectural plans, investor presentations, technical specifications, product or service guides, market research reports), news, messages, industry information, regulatory status, licensing, blogs, etc. In some embodiments, the databases disclosed organize and track company market performance-by-node and stock investment information-by-node for issuers and inventors based on the products and services produced and offered by each competitor. In some embodiments, the databases disclosed organize and track podcasts-by-node, messages-by-node, text, voice messages-by-node, and voice calls-by-node.

In embodiments, a computer system receives a request at a first node of a hierarchically indexed multimedia database categorizing at least one issuer entity or investor entity. The request is for performing a node-to-node action involving the first node and a second node of the hierarchically indexed multimedia database. The request excludes a location of the second node in the hierarchically indexed multimedia database. From the request, features indicative of the location of the second node are extracted. Using a machine learning module, a branch supporting a node tree of the hierarchically indexed multimedia database is located. The machine learning module is trained using other received requests involving the second node. The node tree includes the second node. The node tree is traversed using a structure of the hierarchically indexed multimedia database to determine the location of the second node. The node-to-node action involving the first node and the second node is performed to satisfy the request. A response is sent to the at least one issuer entity or investor entity. The response indicates that the node-to-node action has been performed.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 is a block diagram illustrating a public company analysis system, in accordance with one or more embodiments.

FIG. 2 is a flow diagram illustrating a process for cross indexing and automated growth of a hierarchically indexed multimedia database, in accordance with one or more embodiments.

FIG. 3 is a flow diagram illustrating hierarchy building, in accordance with one or more embodiments.

FIG. 4 is a flow diagram illustrating media upload, storage, and hosting for a self-building hierarchically indexed multimedia database, in accordance with one or more embodiments.

FIG. 5 is a drawing illustrating a system network architecture, in accordance with one or more embodiments.

FIG. 6 is a flow diagram illustrating an example process for serving media on user query flow, in accordance with one or more embodiments.

FIG. 7 is a drawing illustrating an example graphical user interface displaying a hierarchy dashboard for a self-building hierarchically indexed multimedia database, in accordance with one or more embodiments.

FIG. 8 is a drawing illustrating an example graphical user interface displaying a hierarchy of a self-building hierarchically indexed multimedia database, in accordance with one or more embodiments.

FIG. 9 is a flow diagram illustrating an example process for self-building hierarchically indexed multimedia databases, in accordance with one or more embodiments.

FIG. 10 is a block diagram illustrating an example computer system, in accordance with one or more embodiments.

FIG. 11 is a drawing illustrating an example graphical user interface displaying an issuer profile questionnaire, in accordance with one or more embodiments.

FIG. 12 is a drawing illustrating an example graphical user interface displaying a media questionnaire, in accordance with one or more embodiments.

FIG. 13 is a flow diagram illustrating an example process for direct messaging and transactions within a self-building hierarchically indexed multimedia database, in accordance with one or more embodiments.

FIG. 14 is a drawing illustrating example node-to-node direct messaging within a self-building hierarchically indexed multimedia database, in accordance with one or more embodiments.

FIG. 15 is a drawing illustrating example node-to-node transactions performed across a self-building hierarchically indexed multimedia database, in accordance with one or more embodiments.

FIG. 16 is a block diagram illustrating example node-to-node direct messaging and transactions performed across a self-building hierarchically indexed multimedia database, in accordance with one or more embodiments.

FIG. 17 is a drawing illustrating an example of organizing unstructured and structured data by node using communication and collaboration in a self-building hierarchically indexed multimedia database, in accordance with one or more embodiments.

FIG. 18 is a drawing illustrating an example of organizing unstructured and structured data by node using communication and collaboration in a self-building hierarchically indexed multimedia database, in accordance with one or more embodiments.

FIG. 19 is a drawing illustrating an example of organizing unstructured and structured data by node using communication and collaboration in a self-building hierarchically indexed multimedia database, in accordance with one or more embodiments.

FIG. 20 is a block diagram illustrating an example of organizing unstructured and structured data by node using communication and collaboration in a self-building hierarchically indexed multimedia database, in accordance with one or more embodiments.

FIG. 21 is a flow diagram illustrating an example process for organizing unstructured and structured data by node in a hierarchical database, in accordance with one or more embodiments.

FIG. 22 is a block diagram illustrating an example structure including a portion of a blockchain, in accordance with one or more embodiments.

FIG. 23A is a drawing illustrating an example hash algorithm, in accordance with one or more embodiments.

FIG. 23B is a block diagram illustrating an example cryptographic wallet, in accordance with one or more embodiments.

FIG. 24 is a block diagram illustrating an example machine learning (ML) system, in accordance with one or more embodiments.

FIG. 25 is a block diagram illustrating an example computer system, in accordance with one or more embodiments.

### DETAILED DESCRIPTION

In the following description, for the purposes of explanation, numerous specific details are set forth in order to provide a thorough understanding of the present embodiments. It will be apparent, however, that the present embodiments may be practiced without these specific details.

This document presents methods, systems, and apparatuses for self-building hierarchically indexed multimedia databases and product and service-hierarchy databases that include multiple branches and multiple trees of nodes. The databases hierarchically organize video-node, audio-node, and documents-node. The documents can be architectural plans, investor presentations, technical specifications, product or service guides, market research reports), news, messages, industry information, regulatory status, licensing, blogs, etc. In some embodiments, the databases disclosed organize and track company market performance-node and stock investment information-node for issuers and inventors based on the products and services produced and offered by each competitor. In some embodiments, the databases disclosed organize and track podcasts-by-node, messages-by-node, text, voice messages-by-node, and voice calls-by-node.

In some embodiments, the disclosed product and service-hierarchy databases categorize comparable industry, sector, and group market performance and stock investment information centered around the products produced and services performed by each company and its competitors. Examples of a product and service-hierarchy database are described in more detail in U.S. Pat. No. 6,338,067 and U.S. Pat. No. 6,405,204, each of which is incorporated herein in its entirety.

In some embodiments, the disclosed self-building hierarchically indexed multimedia databases organize multimedia content associated with issuer entities and tracks company market performance and stock investment information by the products and services produced and offered. Embodiments include a hierarchically indexed and cross-indexed issuer video and audio database, searchable by industry, sector, group, product, service, and company. Embodiments use combinatorial queries for video and audio search with unique qualitative criteria: global geography, filing status, shareholder meetings, analyst day, trading and reporting status, corporate actions, regulatory status, etc., and overlay the search with standard quantitative criteria.

The embodiments generate video and audio correlated trading alerts based upon viewing and listening activity and measure video and audio sentiment on the platform. Embodiments provide shared community input and triggers to continue constructing and evolving an adaptive, automated, self-building database. In some embodiments of the invention, a hierarchy is built multidimensionally by supervised training, e.g., by an administrator, by unsupervised training, e.g., on the basis of operations performed on the back end by an issuer/company and by query operations performed by a user. For example, a user’s queries automatically create a path in the hierarchy.

The hierarchy is organized in the self-building hierarchically indexed multimedia database among multiple branches categorizing different industries, with at least one branch per industry. Each branch supports a node tree of nodes associated with issuer entities. Multimedia content associated with an issuer entity is stored at one or more nodes. The hierarchy can be implemented as a series of tables, with one table for each level in the hierarchy. The tables contain references to all category levels above that level, with a direct reference to a parent node. Additionally, each node in a level is assigned a “Primary Key” to uniquely identify that node.

Automated self-building (e.g., add nodes, remove nodes, edit existing nodes, and manage relationships between existing nodes) using machine learning is a key feature of the hierarchical system. The service system uses a machine learning module to detect patterns within node trees and determines whether patterns match closely enough to replicate additional nodes from one pattern to the other. For example, if “Branch A” (a chain of directly related nodes) contains four nodes, and three of the node names closely match (e.g., with greater than 98% word similarity) three nodes of the same relationship pattern in another industry’s “Branch B,” the system would indicate adding the 4th node from Branch A to Branch B in the same position.

The advantages and benefits of self-building hierarchically indexed multimedia databases using the embodiments described herein include increased investment community visibility for public and private companies compared to traditional databases. The advantages and benefits of organizing the unstructured and structured data by node and performing multiple operations by node using communication and collaboration in a self-building hierarchically indexed multimedia database include reducing the amount of irrelevant data retrieved and searches necessary, and targeting the industry category by node.

The embodiments provide scalable, global, and cost-effective exposure for issuer entities utilizing the video and audio content and functionality provided by the embodiments. The multiple searchable attributes enable investor entities to readily find issuer entities, compared to traditional video/audio platforms that are not issuer-specific. The self-building hierarchically indexed multimedia database drives investors, partners, and suitors to an issuer’s business, website, crowdfunding platform, or traded security. For example, an issuer can communicate with buy-side, sell-side, and strategic partners, providing the issuer with investment sponsorship, fundraising opportunities, and economically efficient access to investors.

The benefits and advantages for investor entities includes enabling an investor to conduct diligence on an issuer entity via various video and audio content types using the functionality provided by the embodiments, e.g., company overview, product introduction, shareholder meetings, analyst day, etc. The enhanced functionality can be used to find issuers for investment via a variety of searchable attributes, e.g., geography, filing status, industry, products, trading and reporting status, intellectual property (IP), headcount, etc. Diligence time and travel expenses are reduced compared to traditional methods by displaying issuer video/audio. Moreover, video and audio alerts can be triggered based upon quantitative and qualitative factors. Enhanced communication between company executives is achieved, giving investors, partners, and suitors on-demand access to companies. In additional, the accuracy of peer group analysis and relative valuation comparisons based upon the embodiments is increased compared to traditional methods.

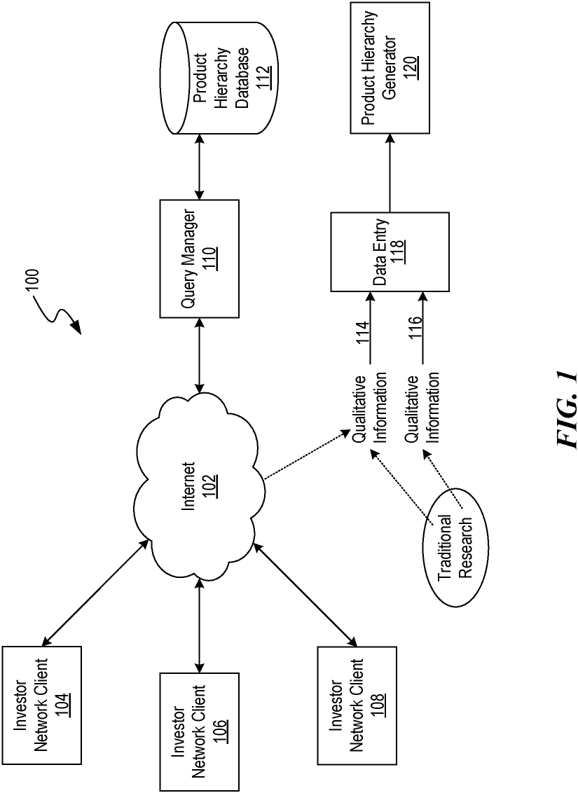

FIG. 1 is a block diagram illustrating a public company analysis system 100, in accordance with one or more embodiments. The system 100 operates over the Internet 102 and can support the securities investment informational needs of multiple investor entities (sometimes referred to as “investors”), represented in FIG. 1 as investor network clients 104, 106, and 108. An investor refers to an entity (such as a firm or mutual fund) that commits capital to financial instruments to earn profits or a rate of return. An issuer (sometimes referred to as an “issuer entity”) refers to an entity that develops, registers and sells securities. Issuers can be corporations, investment trusts, or domestic or foreign governments.

In some embodiments, a query manager 110 appears as a Web page and interfaces the network clients 104, 106, and 108 with a product hierarchy database 112. Qualitative and quantitative information 114 and 116 about public traded companies and their products are input through a data entry system 118 to a product hierarchy generator 120. The qualitative and quantitative information 114 and 116 can come from Web-based research or traditional research based on documents and publications. The product hierarchy generator 120 builds the database 112 as a relational database that is structured by product or service type.

The database 112 is useful in the analysis of competing companies and their markets through the use of database relationships that are based on product/service hierarchies. Investors are able to conduct comprehensive comparative valuation analysis by industry, sector, sub-sector, and group product and service. Investors can also obtain hierarchical industry, sector, sub-sector, and group profiles. A combination of qualitative and quantitative data queries can be supported. Database 112 preferably allows investors to conduct queries by searching on individual or multiple qualitative and quantitative categories. Database 112 preferably allows investors to conduct qualitative analysis of quantitative data and quantitative analysis of qualitative data. Database 112 can be used in securities analysis of publicly traded or private companies and to increase partnership investment performance.

The database 112 is an investment research database 112 that provides qualitative and quantitative data for publicly traded and private companies in a single source accessible via the Internet. Database 112 supports industry, sector, sub-sector, and group hierarchical classifications based on specific products or services. Queries through the Internet 102 allow investors to determine how specific companies are positioned by group within a particular industry, sector, sub-sector, as well as relative industry, sector, sub-sector, and group by industry, sector, sub-sector, and group performance.

In some embodiments, creation of industries, sectors, sub-sectors, and groups, and the proper classification of companies enable comparative valuation and peer group analysis. The product/service hierarchy generator 120 categorizes companies into appropriate industries, sectors, sub-sectors, and groups, and product areas according to a hierarchy within their respective industries. In this way, investor users can get peer group analysis, relative valuation comparisons, and qualitative queries within a chosen industry, sector, sub-sector, or group. The hierarchy is built based on products produced or services performed within industries, which is a bottoms-up approach to company classification.

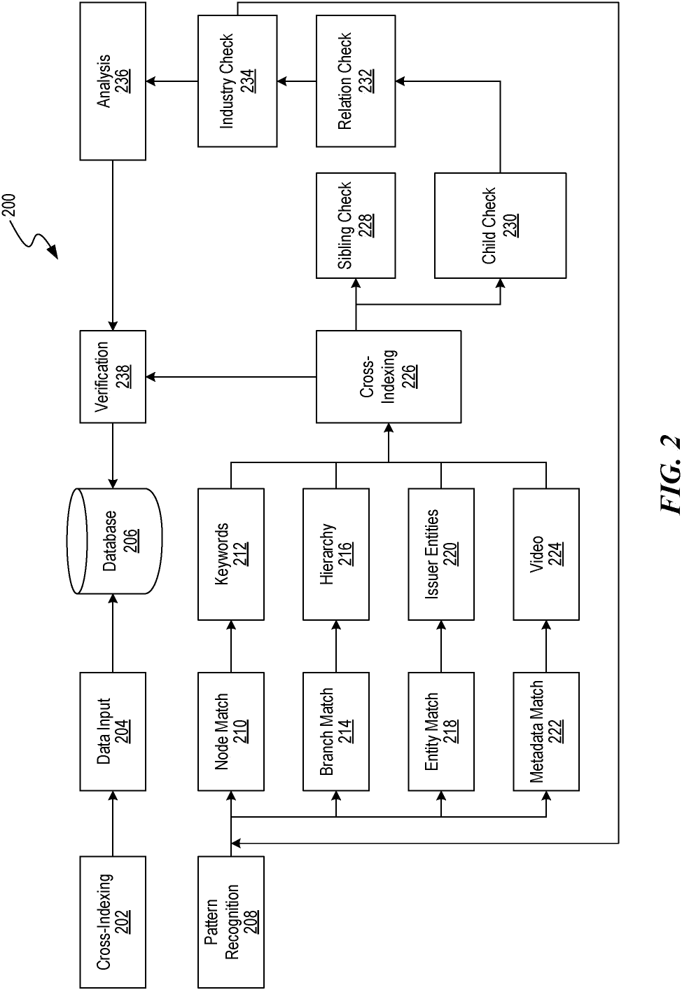

The embodiments disclosed herein implement the creation of industries, sectors, sub-sectors, and groups, and the proper classification of companies in a hierarchically indexed multimedia database. The hierarchically indexed multimedia database is the same as or similar to the hierarchically indexed multimedia database 206 illustrated and described in more detail with reference to FIG. 2. The hierarchically indexed multimedia database can learn and create and add industries, sectors, sub-sectors, and groups, and the proper classification of companies to the hierarchy (product hierarchy database 112) using supervised training. The hierarchically indexed multimedia database generates an index based upon industry, sector, node, product type, and service type, especially where entries are cross indexed to otherwise unrelated nodes within the hierarchy. Further, the hierarchically indexed multimedia database provides access to multimedia content (sometimes referred to as “media”), such as video corporate communications, podcasts, webcasts, and the like.

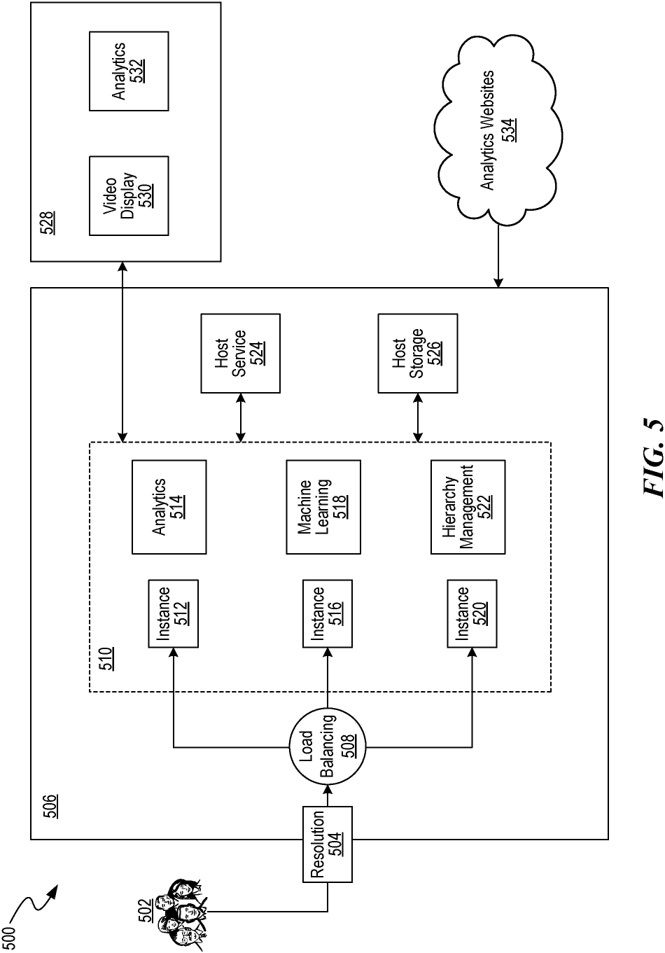

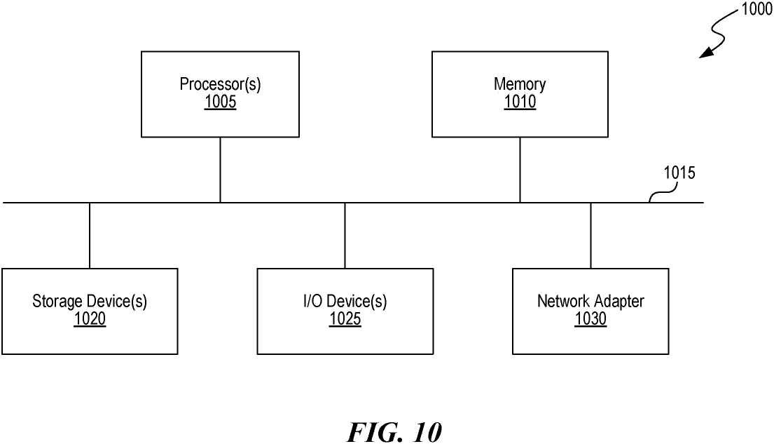

FIG. 2 is a flow diagram illustrating a process for cross indexing and automated growth of a hierarchically indexed multimedia database 206, in accordance with one or more embodiments. In some embodiments, the process 200 of FIG. 2 is performed by a computer system, e.g., the example computer system 1000 illustrated and described in more detail with reference to FIG. 10. Particular entities, for example, the hierarchically indexed multimedia database 206 itself or a host service perform some or all of the steps of the process in other embodiments. Likewise, embodiments may include different and/or additional steps, or perform the steps in different orders. The host service is the same as or similar to the host service 524 illustrated and described in more detail with reference to FIG. 5.

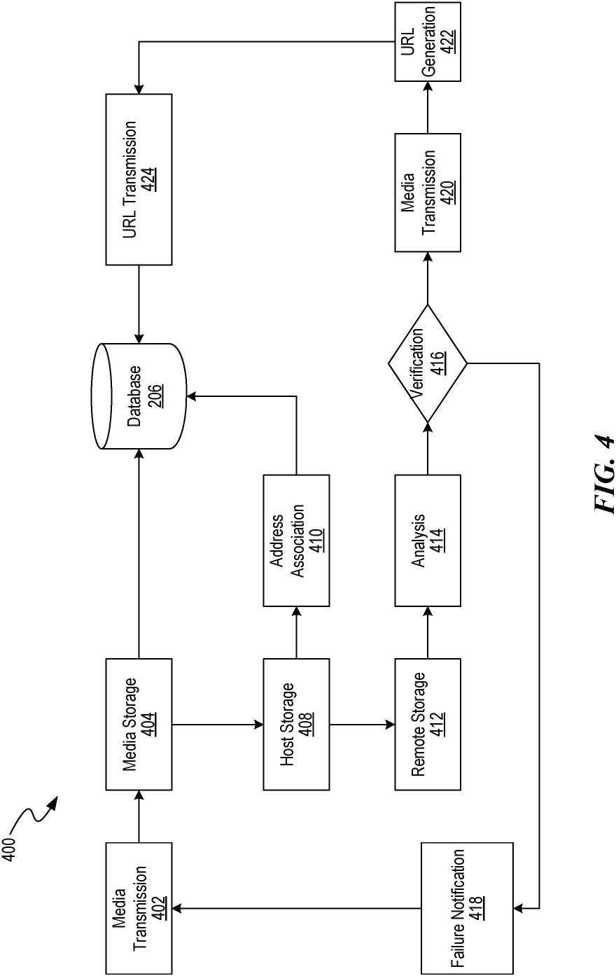

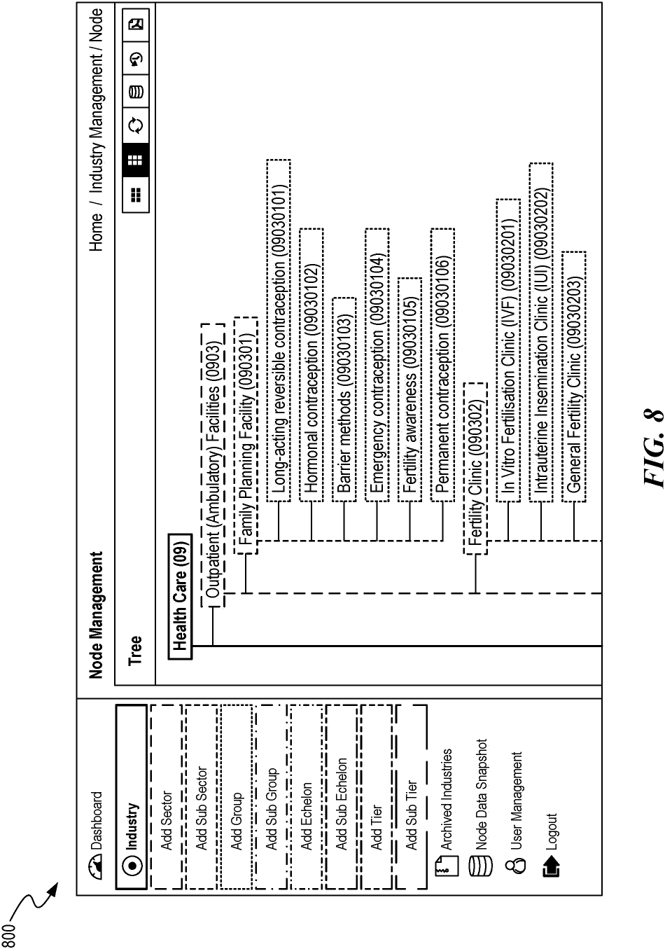

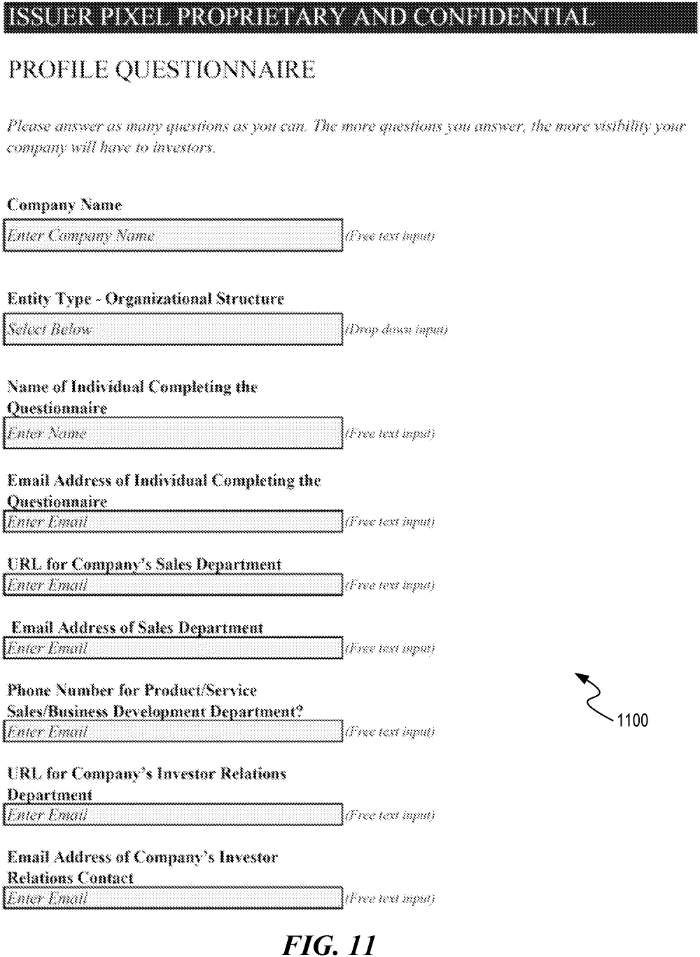

In some embodiments, the computer system receives issuer profile questionnaires describing multiple issuer entities. Each issuer profile questionnaire is the same as or similar to the example issuer profile questionnaire 1100, illustrated and described in more detail with reference to FIG. 11. An example of receiving an issuer profile questionnaire is illustrated and described in more detail in step 402 with reference to FIG. 4. The computer system generates the hierarchically indexed multimedia database 206 categorizing the multiple issuer entities based on the issuer profile questionnaires. The hierarchically indexed multimedia database 206 includes at least one branch associated with a respective industry and supports at least one node. An example branch “Health Care” is illustrated and described in more detail with reference to FIG. 8. Each node references at least one issuer entity of the multiple issuer entities. An example node “Fertility Clinic” is illustrated and described in more detail with reference to FIG. 8.

In some embodiments, the issuer profile questionnaire includes metadata to provide that an issuer entity is uniquely identifiable within the system, and that when the issuer registers with the hierarchically indexed multimedia database 206, the computer system detects that the issuer already exists. The issuer will be able to recognize the existing company profile as belonging to it when the computer system displays the profile. In some embodiments, audio/video file node associations in the hierarchically indexed multimedia database 206 are the same as or a descendant of issuer profile node associations. A node is not associated below the minimum mandatory node level to an issuer. Once an issuer has registered and claimed an administratively created profile, its profile is not deleted.

In some embodiments, the graphical user interface for issuer profile creation includes a new page for issuer creation, a new page for viewing existing issuers in a table, a new page for editing/viewing issuer details, and a list of each issuer associated to a node in a “node details page” and a button that redirects a user to the issuer creation page within the node details page. The button autofills the associated node ID in issuer creation process. In some embodiments, additional logic for duplicate issuer creation and issuer deletion is included. In some embodiments, a minimum amount of metadata is included in order to uniquely distinguish a company that is entered into the hierarchically indexed multimedia database 206. The data fields can require special formatting if needed, e.g., a Data Universal Numbering System (DUNS) number, founding date, headquarters, other uniquely identifying fields. A graphical user interface of the hierarchically indexed multimedia database 206 displays pre-selected nodes to an issuer as indicative of analyst requests. An issuer entity can thus remove a suggested node association or leave the request if appropriate.

In some embodiments, a group of a parent node, direct child node, and direct grandchild node is called a branch. When two branches have significant naming or description overlap with another industry, a cross-index relationship is indicated between these branches. Branches can be cross-indexed more than once. Branch sizes may vary, with larger matching branches having a stronger suggested correlation than smaller branches. Competitors in company profiles across nodes/branches can be matched, e.g., when two companies in different nodes/industries claim to have the same competitors, that indicates a relationship between those nodes that could be weighted. Using the same weighting system as with weighting user requests, it is possible to weigh potential relationships within the hierarchies and their relevance.

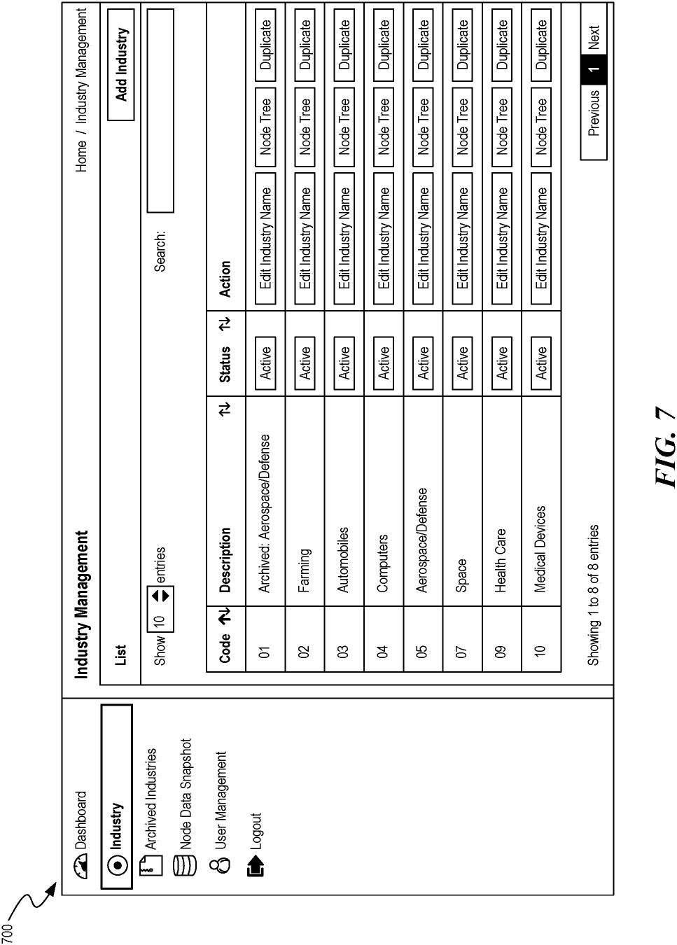

The computer system extracts metadata, using a machine learning module, from multimedia content received from each issuer entity. The machine learning module is the same as or similar to the machine learning module 518 illustrated and described in more detail with reference to FIG. 5. In some embodiments, the multimedia content includes video, audio, text, or encrypted data. For example, only authorized investor entities are allowed access to decrypt the data. The metadata is indicative of the respective industry. The computer system identifies, the node using the machine learning module, based on the metadata. The machine learning module is trained based on a structure of the hierarchically indexed multimedia database 206, e.g., the structures shown in FIGS. 7 and 8. The computer system stores the multimedia content at the node, such that the multimedia content is associated with the respective industry and an issuer entity. In this manner, the computer system generates the hierarchically indexed multimedia database 206 categorizing multiple industries and issuer entities.

In some embodiments, the computer system traverses the hierarchically indexed multimedia database 206, which includes multiple branches categorizing multiple industries. Each branch supports at least one node tree associated with at least one issuer entity and stores multimedia content associated with the at least one issuer entity, as illustrated in more detail with reference to FIG. 8. The term “warp” is sometimes used to mean traverse. The term “warp” means that the database platform provides the ability for a user to be in/at any node level, any video or any audio, or within any industry, and transport the user to any other node level, other video or other audio in another industry or the same industry. The hierarchically indexed multimedia database 206 enables users to warp, i.e., move, from one video or audio at one node level to another video or audio at another node level, or from one node to another node, without searching through the hierarchically indexed multimedia database 206 manually, but instead by entering a description of another video or audio or node, in a field, next to the metadata of the current video or audio or node. Users can enter a node name, audio or video title, description or any unique identifier and the platform transports them and brings up that new video or audio.

Referring to FIG. 2, the computer system performs (208) a scheduled process for automated pattern recognition triggers for self-building of the hierarchically indexed multimedia database 206. For example, in step 210, the computer system performs node name text matching. The computer system determines (212) whether keywords or phrases between two nodes in the tree match each other. In some embodiments, the computer system references a library of synonymous or equivalent words or named. The hierarchy structure is stored in the database. As the user browses the hierarchy, the system returns the hierarchy to the user to view. Videos are associated to each hierarchy node and as the system returns the video metadata and multimedia content host’s universal resource locator (URL) to be embedded in the web page, either as a thumbnail or an embedded, playable video. A URL, or web address, is a reference to a web resource that specifies its location on a computer network and a mechanism for retrieving it. The multimedia content host is the same as or similar to the multimedia content host 528 illustrated and described in more detail with reference to FIG. 5.

In some embodiments, the computer system extracts a first pattern from a first node tree supported by a first branch of the hierarchically indexed multimedia database 206 using a machine learning module trained based on the hierarchically indexed multimedia database. The first branch is associated with a first industry. For example, in step 214, the computer system performs branch matching within the hierarchically indexed multimedia database 206. The computer system determines (216) whether there are surrounding nodes within a directly linked chain of one or many nodes. Every video is associated to the issuer who uploaded the video through a field in a video table which references the issuer’s Primary Key.

In some embodiments, the computer system extracts a second pattern from a second node tree supported by a second branch of the hierarchically indexed multimedia database 206 using the machine learning module. The second branch is associated with a second industry different from the first industry. The first node tree includes at least one node more than the second node tree. For example, the computer system performs (218) issuer/competitor matching within the hierarchically indexed multimedia database 206. The computer system determines (220) whether there are multiple issuers associated with the same two nodes and whether the same competitors are associated to issuers at different nodes.

In some embodiments, the computer system determines that the first pattern matches the second pattern using the machine learning module. The machine learning module is trained to compare two patterns extracted from the hierarchically indexed multimedia database 206. For example in step 222, the computer system matches (222) video metadata and performs speech-to-text recognition on content stored in the hierarchically indexed multimedia database 206. The computer system determines (224) whether there are similarities between the content of the videos associated to (or stored at) a first node and the videos associated to a second node.

In some embodiments, the computer system cross-indexes at least one of the new node or the second node tree with the first node tree based on the first pattern. For example in step 226, the computer system determines whether any of the four steps 212, 216, 220, and 224 were successful. If so, a cross-indexed node match is indicated. The computer system verifies (238) review and approval for the cross-indexing. The hierarchy is a node tree that exists on two planes, up/down and left/right a single tree. It is possible to consider the various industries as a third dimension, with nodes being linked between industries as well. This would be accomplished by using a cross-industry reference (cross-indexing) table to track the relationships between nodes between different industries, or even between branches of the same industry if needed. The hierarchy is three dimensional and has cross-indexing between nodes at different industries.

The computer system determines (228) whether a first node has a sibling second node on the same level and not present elsewhere in the hierarchically indexed multimedia database 206. In some embodiments, an investor is enabled to search for and browse videos according to the hierarchy. The hierarchically indexed multimedia database 206 (referred to as an “issuerPixel database”) stores videos and tracks their hierarchical categorization in a reference table which contains a record of the VideoID (the Primary Key identifier for every video in the video table) and the HierarchyNodeID (the Primary Key identifier for every node in the industry categorization table). The reference table provides a single table which the system can search either based on the VideoID or the HierarchyNodeID, and allows for multiple videos to be associated to a single categorization node and for a single video to be associated to multiple categorization nodes.

The computer system determines (230) whether a first node has a child node not present under the other (second) node. In some embodiments, each categorization node in the hierarchy has an ID associated to it, and each video is associated to at least one hierarchy node. As a user views a graphical user interface of the issuerPixel application (see FIGS. 7-8) and browses or searches according to hierarchy, the issuerPixel application looks up the relevant hierarchy nodes and then searches the reference table for those HierarchyNodeIDs. The system determines the VideoIDs associated to those HierarchyNodeIDs and looks up the video’s hosting address to begin the process of retrieving the video from a multimedia content host (e.g., YouTube in a particular implementation), so that the user can view a thumbnail of the video and begin playing the video if desired. The multimedia content host is the same as or similar to the multimedia content host 528 illustrated and described in more detail with reference to FIG. 5.

The computer system determines (232) whether the child nodes, sibling nodes, or ancestor nodes (parent, grandparent, great grandparent, etc.) are similar. In some embodiments, the hierarchy structure is stored in the database so that as the user browses the hierarchy the system returns the hierarchy to the user to view. Videos are associated to each hierarchy node and the system returns the video metadata and multimedia content host’s URL to be embedded in the web page (either as a thumbnail or an embedded, playable video).

The computer system determines (234) whether the nodes are in the same industry, in industries with cross-indexed nodes, or nodes generated from matched patterns. In some embodiments, each video is associated to the issuer that uploaded the video through a field in the video table which references the issuer’s Primary Key. Each video has an issuer associated to it, and issuers cannot be deleted (they can be inactivated, but a record of them will remain in the database), so that data integrity is not lost. In addition to being associated to an issuer, the video is also associated directly to a company (here, an issuer user and an issuer company are differentiated).

In some embodiments, responsive to determining that the first pattern matches the second pattern, the computer system incorporates a new node corresponding to the at least one node within the second node tree in accordance with the first pattern. For example, in step 236, the computer system analyzes the results of previous checks and potentially indicates a node addition (e.g., child or sibling node) to the hierarchically indexed multimedia database 206. An example of node addition is illustrated and described in more detail with reference to FIG. 8.

The computer system reviews (202) the hierarchy of the hierarchically indexed multimedia database 206 and determines cross-indexed nodes. In step 204, the computer system performs data entry for storage in the hierarchically indexed multimedia database 206. A new node is added to the hierarchically indexed multimedia database 206. In some embodiments, the hierarchy is a node tree that exists on two planes: up/down and left/right as a single tree. The various industries can be implemented as a third dimension, with nodes being linked between industries as well. This is accomplished by using a “Cross-Industry Reference” cross-indexing table to track the relationships between nodes between different industries, or even between branches of the same industry if needed. The hierarchy is three-dimensional and performs cross-indexing between nodes of different industries and sometimes, within the same industry.

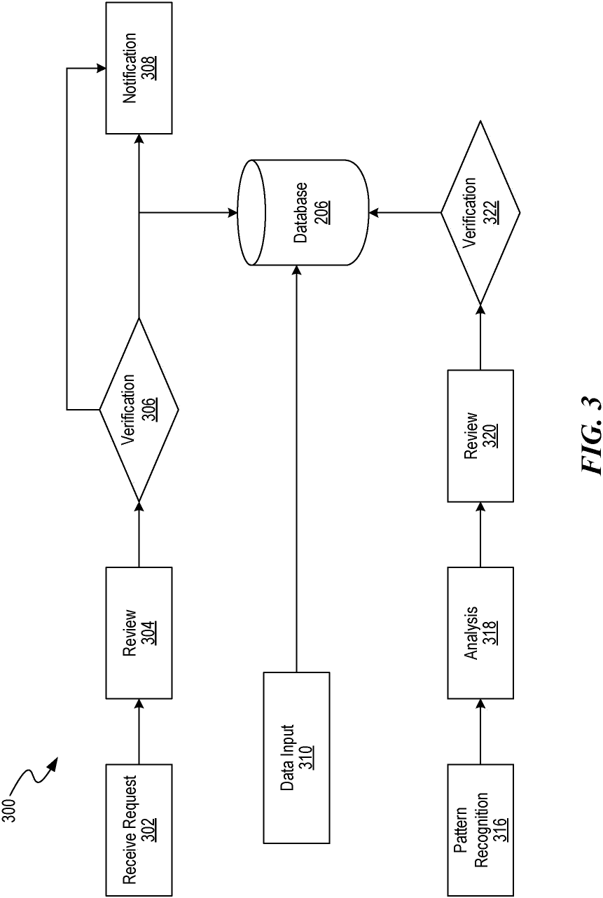

FIG. 3 is a flow diagram illustrating hierarchy building, in accordance with one or more embodiments. The hierarchy building is performed for a hierarchically indexed multimedia database 206, illustrated and described in more detail with reference to FIG. 2. In some embodiments, the process 300 of FIG. 3 is performed by a computer system, e.g., the example computer system 1000 illustrated and described in more detail with reference to FIG. 10. Particular entities, for example, the hierarchically indexed multimedia database 206 or a host service perform some or all of the steps of the process in other embodiments. Likewise, embodiments may include different and/or additional steps, or perform the steps in different orders. The host service is the same as or similar to the host service 524 illustrated and described in more detail with reference to FIG. 5.

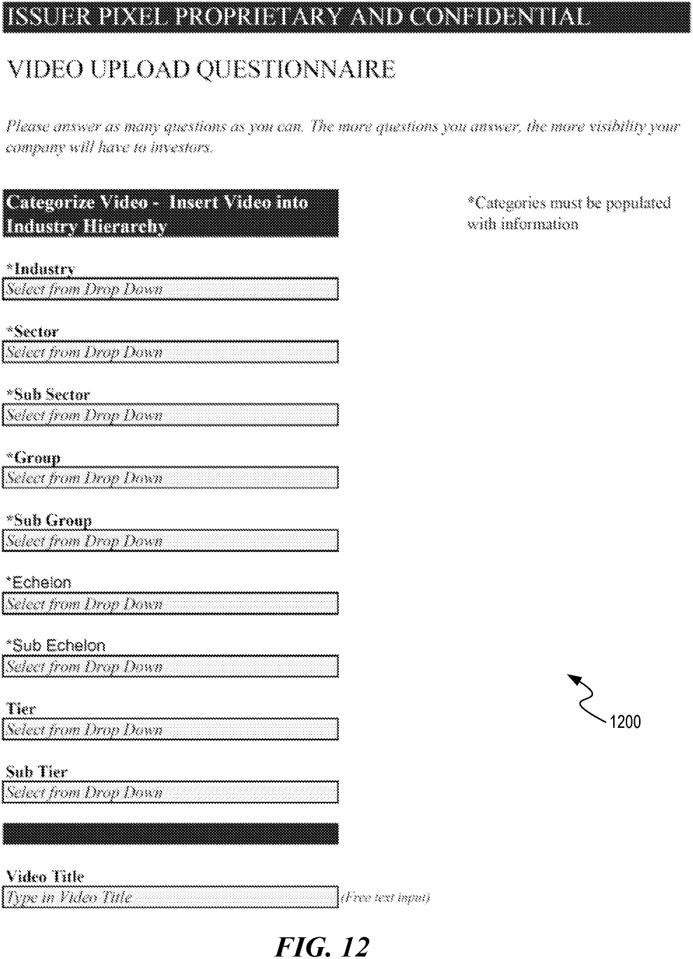

The computer system receives (302) a request to modify a node of the hierarchically indexed multimedia database 206 categorizing multiple issuer entities. The request is received from an investor entity or an issuer entity. The hierarchically indexed multimedia database 206 includes at least one branch associated with a respective industry and supports a node tree including the node to be potentially modified. For example, the computer system enables investors and issuers (company users) to provide requests in the hierarchy which are then implemented if approved. Users can submit requests to add, edit, or subtract nodes to the hierarchy through a suggestion box available for every visible node within the hierarchy view. In some embodiments for issuers, the hierarchy tree shows in the issuer profile questionnaire and in a media questionnaire. The issuer profile questionnaire is the same as or similar to the issuer profile questionnaire 1100, illustrated and described in more detail with reference to FIG. 11. The media questionnaire is the same as or similar to the media questionnaire 1200 illustrated and described in more detail with reference to FIG. 12. For investors, the hierarchy tree shows in their homepage and video browsing/search pages, where they can browse through the hierarchy or search based on the hierarchy accordingly.

In some embodiments, the computer system extracts features indicative of a priority of the request. A feature is an individual measurable property or characteristic of the raw input data. For example, features can be numeric or structural, such as strings or graphs. The features include a position of the node in the structure of the hierarchically indexed multimedia database 206. The features are extracted from the request, other requests received to modify the node, and a structure of the hierarchically indexed multimedia database 206. For example in step 304, the computer system analyzes the request to determine the priority of the request based on the features using a machine learning module trained based on the structure of the hierarchically indexed multimedia database 206 and the other requests. The machine learning module is the same as or similar to the machine learning module 518 illustrated and described in more detail with reference to FIG. 5.

The computer system verifies (306) the request. In some embodiments, the computer system positions the request within the other requests based on the priority. For example, the computer system weighs the value of the request based on factors, such as who submitted the request (a list of high weight email domain names is used to lend specific users more weight with their requests), how many requests were submitted for the same node (more weight for more requests for the same node), and the position of the node in the hierarchy, as well as others. A request having a higher weight shows higher in the administrator panel’s list to be reviewed.

In some embodiments, once an administrator approves of a request, the suggested change is automatically implemented by the computer system and the user is notified of the change. Changes include adding a node under the target node, removing a target node and all descendants of that node, and changing the name of a node. An administrator can review each change before it is implemented, and may conditionally accept a change of a node so that the user is notified the change was accepted. The computer system transmits (308) a response to the investor entity or the issuer entity of the multiple issuer entities. The response indicates that the request to modify the node is satisfied.

In some embodiments, the computer system bypasses the request mechanism to directly modify a node based on prior, internal analysis (310) of the hierarchically indexed multimedia database 206. In some embodiments, the hierarchically indexed multimedia database 206 categorizes videos according to a proprietary industry classification tree. Additional metadata and files are also associated to each video (depending on user-generated content) to provide users with the ability to search for and find videos using detailed fields such as the categorization hierarchy and other qualitative characteristics based on the issuer profile questionnaire and media questionnaire metadata. In some embodiments, audio media files have separate questionnaires with audio specific fields and dropdowns. Additionally, the hierarchically indexed multimedia database 206 application supports playing audio files using a podcast player. Audio files take the format of either MP3 or M4A files. MP3 (sometimes referred to as MPEG-1 Audio Layer III or MPEG-2 Audio Layer III) is a coding format for digital audio. MP4A (sometimes referred to as MPEG-4 Part 3 or MPEG-4 Audio) is part of an international standard for audio coding. The hierarchically indexed multimedia database 206 application can convert audio files from common formats to MP3 or M4A.

In some embodiments, the computer system performs (316) automated pattern recognition, using the machine learning module, triggered by changes in the hierarchically indexed multimedia database 206. In some embodiments, more adaptive node pattern matching is implemented, e.g., by matching patterns in node names or similarities in node names across branch chunks. A parent node, direct child node, and direct grandchild node (etc.) are called a branch. When two branches have significant naming or description overlap with another industry, an automatic cross-index relationship between these branches is indicated. Branches can be cross-indexed more than once. Branch sizes vary, with larger matching branches having a stronger “suggested correlation” than smaller branches. In some embodiments, matching competitors in company profiles across nodes/branches is performed. When two companies in different nodes/industries have the same competitors, a relationship between those nodes that could be weighed by an administrator is indicated. Using the same weighting system as with weighting user requests, it is possible to weigh potential relationships within the hierarchies and their relevance.

In step 318, the computer system analyses (318) a textual name of the node as well as metadata present within multimedia content saved at the node, and performs data processing to identify an indicated change in the node. In some embodiments, data elements are stored in the hierarchically indexed multimedia database 206 in a table designated for issuer profile questionnaire answers. Each answered issuer profile questionnaire is given a unique ID and is represented by a single row in an issuer profile questionnaire table, with answers either in the form of alphanumeric input or as a Foreign Key reference to another table of stored dropdown/checkbox inputs. For example, in a media questionnaire, the possible answers of “CEO,” “VP,” “COO,” etc., are all stored in a separate “Presenter” table and each has a unique stored ID. In the issuer profile questionnaire table, for the column “Presenter” the values would all be Foreign Keys which reference a unique ID for one of the “Presenter” table values. When the computer system displays a Presenter, it will reference the issuer profile questionnaire table, pull the Foreign Key value in the presenter column, and then lookup which Presenter type matches that ID in the Presenter table.

The computer system reviews (320) the other requests received to modify the node from users, investors, issuers, or the computer system itself (310). In some embodiments, requests are prioritized from some users over others in accordance with who submitted the request (e.g., a list of high-weight email domain names will be used to lend specific users more weight with their requests), how many requests were submitted for the same node (e.g., more weight for more requests for the same node), or a position of the node in the hierarchy (e.g., more weight for nodes in a higher position, since a change would affect more nodes). In some embodiments, requests are prioritized based on an age of the industry, an age of the node, a last modified date of the node, a number of parent nodes (of all replicas), a number of child nodes, a number of replica nodes, a number of recent requests for industry, a number of recent requests for ancestor nodes, a number of companies associated to this node or descendant nodes, or a number of media files associated to this node or descendant nodes.

The computer system verifies (322) the node change. In some embodiments, the computer system positions the request within the other requests based on the priority. In some embodiments, the hierarchy supports up to nine category levels (from the highest level of “Industry” to the lowest of “Sub-Tier”), and is capable of supporting more. Authorized users are able to add, duplicate, subtract, and edit existing nodes as well as to create additional connections between existing nodes (both in the form of adding an association between nodes of adjacent levels in the same tree, and by cross-indexing nodes). Application users (both company users and investors) are able to submit requests to add, edit, and subtract nodes to the hierarchy through a suggestion box available for every node they can see within the hierarchy tree views allowed to them. For issuers, the hierarchy tree would show in the issuer profile questionnaire and in the media questionnaire. For investors, the hierarchy tree would show in their homepage and video browsing/search pages, where they can browse through the hierarchy or search based on the hierarchy accordingly. The suggestion box is displayed in a few different ways, e.g., a button next to each hierarchy node which, when clicked, shows a new popup window with the node’s information (including the all of the direct ancestors of the node and the immediate children nodes of that node) along with the three request types of Add, Remove, or Edit and a textbox for the user to explain their request. Requests will be tied to the user’s profile.

In some embodiments, the computer system modifies the node tree with respect to the structure of the hierarchically indexed multimedia database 206, such that the request to modify the node is satisfied. The hierarchically indexed multimedia database 206 is not only 1) automatically self-building and 2) not only being built by analysts. There is also an important 3) shared community building of the hierarchically indexed multimedia database 206. The shared community consists of users on the front end of the platform. Here with the hierarchically indexed multimedia database 206, users are running queries and analyzing the node tree of each industry hierarchy and they have the ability to press icons at each node level, to suggest to the system to add a node, delete a node, or replace a node with a new node. Therefore, the shared community is one of the ways that the database continues to build and expand.

FIG. 4 is a flow diagram illustrating media upload, storage, and hosting for a self-building hierarchically indexed multimedia database 206, in accordance with one or more embodiments. The hierarchically indexed multimedia database 206 is illustrated and described in more detail with reference to FIG. 2. In some embodiments, the process 400 of FIG. 4 is performed by a computer system, e.g., the example computer system 1000 illustrated and described in more detail with reference to FIG. 10. Particular entities, for example, the hierarchically indexed multimedia database 206, a multimedia content host or a host service perform some or all of the steps of the process 400 in other embodiments. Likewise, embodiments may include different and/or additional steps, or perform the steps in different orders. The host service is the same as or similar to the host service 524 illustrated and described in more detail with reference to FIG. 5. The multimedia content host is the same as or similar to the multimedia content host 528 illustrated and described in more detail with reference to FIG. 5.

The computer system receives (402) a media questionnaire and multimedia content from a particular issuer entity of multiple issuer entities categorized by the hierarchically indexed multimedia database 206. The media questionnaire is the same as or similar to the media questionnaire 1200, illustrated and described in more detail with reference to FIG. 12. The hierarchically indexed multimedia database 206 is stored by a multimedia content host or host service. The hierarchically indexed multimedia database 206 includes at least one node referencing the particular issuer entity. For example, videos are categorized according to an industry classification tree. The system also associates additional metadata and files to each video, depending on user generated content, to provide users with the ability to search for and find videos using detailed fields, such as the categorization hierarchy and other qualitative characteristics, e.g., based on issuer profile questionnaire metadata or media questionnaire metadata. The issuer profile questionnaire is the same as or similar to the issuer profile questionnaire 1100, illustrated and described in more detail with reference to FIG. 11.

An issuer completes a media questionnaire for each video uploaded to the system. The media questionnaire values entered by the user are stored in the hierarchically indexed multimedia database 206 as a row of the media questionnaire table. Data elements are stored in the hierarchically indexed multimedia database 206 in a table designated for media questionnaire answers. Each answered media questionnaire is given a unique ID and is represented by a single row in the media questionnaire table, with answers either in the form of alphanumeric input or as a Foreign Key reference to another table of stored dropdown/checkbox inputs. For example, in a media questionnaire, the possible answers of “CEO,” “VP,” “COO,” etc., are all stored in a separate “Presenter” table and each have a unique stored ID. In the media questionnaire table, for the column “Presenter” the values would all be Foreign Keys which reference a unique ID for one of the “Presenter” table values. When the system needs to display who the Presenter was for this video, it references the media questionnaire table, pulls the Foreign Key value in the presenter column, and then looks up which Presenter type matches that ID in the Presenter table.

In step 404, the computer system extracts media questionnaire metadata and metadata from the multimedia content, stores the metadata in the hierarchically indexed multimedia database 206. For example, the computer system extracts the metadata, using a machine learning module, from the media questionnaire and multimedia content, where the metadata is indicative of an industry. The machine learning module is the same as or similar to the machine learning module 518 illustrated and described in more detail with reference to FIG. 5. The computer system identifies a branch using the machine learning module based on the metadata. In some embodiments, the computer system traverses the hierarchically indexed multimedia database 206 using a machine learning module, based on the multimedia content, to identify at least one node corresponding to the issuer entity.

The computer system stores (408) the video or audio at a node tree (including the node) supported by the branch, such that the video or audio is associated with the industry and the issuer entity. An address of the multimedia content stored in the hierarchically indexed multimedia database 206 is associated to the multimedia content. In some embodiments, videos are uploaded by a user from local storage after filling out a media questionnaire. The computer system verifies that the video is of an acceptable format and also verifies the integrity of the video using the ffmpeg command, which if specified to, reads the input file and reports any errors that appear. An example command line (for Linux) used is:

ffmpeg -v error -i file.avi -f null - 2 > error.log

Here, “-v error” refers to a certain level of verbosity (to show some errors that are normally hidden because they don’t affect playability a much). A full error log with some generic information about ffmpeg is output, which can be analyzed using filters written to perform batch check of similar files.

The multimedia content is pushed (412) to remote storage at the host service. For example, the computer system stores videos and files uploaded by users to the host service. The host service provides reliable, secure, and scalable data storage at a competitive price. Each file/video stored at the host service is assigned an address, and the service database contains references linking the uploader and the address, along with a unique, system-assigned ID for the video (a Primary Key). The database 206 also stores video metadata captured from a media questionnaire alongside a VideoID, such as the node(s) the video is associated to, the name of the video, the date the video was created, etc.

In step 410, the computer system performs address association for the video. In some embodiments, the computer system retains a copy of the video at the host service storage for backup/future reference. If the computer system is unable to retrieve the video from the 528, the computer system can either play the video directly (through a built-in video player) or play the video through another backup hosting service. In some embodiments, once the computer system has determined which videos need to be retrieved based on a user’s search criteria, the system looks up those video entries in the video table and then looks up the multimedia content host (e.g., YouTube in a particular implementation) URL associated to every video entry. This URL is pulled and then used in the front-end of the web application to embed the target video in the web app for viewing. The multimedia content host is the same as or similar to the multimedia content host 528 illustrated and described in more detail with reference to FIG. 5.

The computer system analyzes (414) integrity of the multimedia content stored at the host service. If the analysis fails (416), the issuer entity is notified (418) of the file integrity failure and the issuer entity is requested to resubmit the multimedia content. If the analysis passes, the multimedia content is pushed (420) to a multimedia content host, which can be the same as or different from the host service. For example, once the video is uploaded and stored at the host service, the computer system begins the process of automatically submitting the video to a multimedia content host through the multimedia content host’s application programming interface (API). An API is a computing interface that defines interactions between multiple software or mixed hardware-software intermediaries. The host service automatically sends the multimedia content host the video file and metadata and, once successfully uploaded to the multimedia content host, the multimedia content host returns a video URL. The host service stores this video URL with a VideoID and references this URL whenever the application needs to retrieve and play the video. The video stored at the host service, the address generated, and the database entries of the video address and metadata are generated simultaneously by the database 206 at the time of the video submission by the user.

In some embodiments, the computer system receives a URL from the multimedia content host referencing the multimedia content stored at the node. For example, in step 422, the host service or multimedia content host generates a URL corresponding to the multimedia content. The computer system receives (424) the URL from the multimedia content host for the media embed, and the URL is stored in the hierarchically indexed multimedia database 206 and associated to the media object. The computer system can receive a combinatorial query from an investor entity requesting the multimedia content. Responsive to receiving the query, the computer system displays the multimedia content using the URL on a graphical user interface.

FIG. 5 is a drawing illustrating a system network architecture 500, in accordance with one or more embodiments. The system network architecture 500 includes users 502 (e.g., investor entities, issuer entities, and administrators), a cloud service 506, a multimedia content host 528, and analytics websites (534). Likewise, embodiments may include different and/or additional components, or connected in different implementations. The system network architecture can be implemented using components of the computer system 1000 illustrated and described in more detail with reference to FIG. 10.

The cloud service 506 provides an on-demand cloud computing platform and APIs, e.g., on a metered pay-as-you-go basis. The cloud service provides a variety of abstract technical infrastructure and distributed computing building blocks and tools. The cloud service 506 includes a Domain Name System (DNS) resolver 504, an application load balancer 508, a container 510, an instance 512, an analytics module 514, an instance 516, a machine learning module 518, an instance 520, a hierarchy management tool 522, a host service 524, and remote host storage 526. DNS refers to a hierarchical and decentralized naming system for computers, services, or other resources connected to the Internet or a private network. The DNS resolver 504 is a server on the Internet that converts domain names into Internet Protocol (IP) addresses. IP refers to the principal communications protocol in the Internet protocol suite for relaying datagrams across network boundaries.

In a particular implementation, the hierarchically indexed multimedia database (referred to as an “issuerPixel database”) stores all videos and files uploaded by users to Amazon S3 storage under an issuerPixel Amazon Web Services (AWS) account. S3 refers to Amazon Simple Storage Service, a service offered by Amazon Web Services that provides object storage through a web service interface. S3 storage provides reliable, secure, and scalable data storage at a competitive price. Each file/video stored in S3 is assigned an address, and the issuerPixel database contains references linking the uploader and this address, along with a unique, system-assigned ID for that video (a Primary Key). Once the video is uploaded and stored in S3, the computer system will then begin the process of automatically submitting the video to the issuerPixel database’s multimedia content host 528 (e.g., YouTube in a particular implementation) through the multimedia content host 528’s API. The issuerPixel application will automatically send the multimedia content host 528 the video file and the metadata, and once successfully uploaded to the multimedia content host 528’s issuerPixel account, the multimedia content host 528 will return the video URL. The issuerPixel application will then store this video URL with the VideoID and will reference this URL whenever the application needs to retrieve and play the video.

The computer system retains the copy of the video in S3 storage for backup/future reference, so if the system is unable to retrieve the video from the multimedia content host 528 (e.g., YouTube in a particular implementation), the computer system can either play the video directly (through a built-in video player) or play the video through another backup multimedia content host service (e.g., Vimeo, Panopto, Vidyard, etc., in particular implementations). The issuerPixel application stores all of the data collected via the issuer profile and media questionnaires, user feedback, and user activity on the website in the database in the form of tables. The issuer profile questionnaire is the same as or similar to the issuer profile questionnaire 1100, illustrated and described in more detail with reference to FIG. 11. The media questionnaire is the same as or similar to the media questionnaire 1200, illustrated and described in more detail with reference to FIG. 12.

The issuerPixel application uses a relational database (e.g., MySQL in a particular implementation), which is structured to maintain data integrity and to inherently support the relationships between objects such as users and questionnaire responses. MySQL refers to an open-source relational database management system built using Structured Query Language (SQL). The hierarchically indexed multimedia database is hosted using Amazon’s Relational Database Service (RDS) service under the issuerPixel AWS account in a particular implementation. Amazon RDS refers to a distributed relational database service by Amazon Web Services. It is a web service running “in the cloud” designed to simplify the setup, operation, and scaling of a relational database for use in applications. Videos are stored in Amazon’s S3 storage service with each video being assigned an address by S3. This address is stored in the hierarchically indexed multimedia database and associated to the uploader as well as the video metadata (hierarchical categorization, date, name of video, etc.). The video being stored in S3, the address being generated, and the hierarchically indexed multimedia database entries of the video address and metadata are all generated simultaneously by the issuerPixel application at the time of the video submission by the user. The application load balancer 508 automatically distributes incoming traffic across multiple targets, such as Amazon Elastic Compute Cloud (EC2) instances, containers, and IP addresses, in one or more availability zones. Amazon EC2 is a part of Amazon’s cloud-computing platform, Amazon Web Services.

The container 510 is administered by a scalable container management service that isolates the container 510 from others and bundles its software, libraries and configuration files. The container 510 is isolated from other containers and bundles its own software, libraries, and configuration files. The container 510 communicates with other containers through well-defined channels.

The instances 512, 516, and 520 are each instances of the application for users 502 to operate a hierarchically indexed multimedia database, such that each instance is a provisionable entity, and a combination of IT resource instance (target connectivity and connector configuration) and resource object (provisioning mechanism). The hierarchically indexed multimedia database is the same as or similar to the hierarchically indexed multimedia database 206 illustrated and described in more detail with reference to FIG. 2.

The analytics module 514 provides financial analytics and views. In some embodiments, the computer system uses the analytics module 514 to determine a first metric quantifying social media engagement, communication network activity, a trading volume, and a stock value associated with a particular issuer entity. The social media engagement includes at least one of a social sentiment API feed or a social sentiment indicator. The social media engagement measured includes, but is not limited to, Facebook, Instagram, Pinterest, Twitter, Wechat, Ozone, Tumblr, Messenger, Reddit, SnapChat, Line, TikTok, etc. Social sentiment sites and platforms include sites such as Stock Twits, etc. The social sentiment API feeds include Social Sentiment.io, Social Market Analytics, and Hedge Chatter. Messenger Apps include WhatsApp, Viber, Telegram, and Facebook Messenger. The communication network activity includes at least one of instant messaging activity, instant messaging frequency, or a chat room population. The trading volume, and a stock value can be obtained from the analytics websites 534. In some embodiments, the computer system mines the Internet to aggregate changes in the social media engagement, the communication network activity, the trading volume, and the stock value associated with the particular issuer entity. Mining refers to a process of discovering patterns in large data sets and across the Internet using searches, machine learning, statistics, and database systems. Determining the first metric is based on the changes. In some embodiments, determining the second metric includes triangulating between the social media engagement, the communication network activity, the trading volume, and the stock value associated with the first issuer entity.

The machine learning module 518 encapsulates a specific machine learning algorithm, function, or code library that builds a model based on sample data, known as “training data,” in order to make predictions or decisions without being explicitly programmed to do so. The machine learning module 518 applies machine learning techniques to generate a machine learning model that, when applied to extracted features, outputs indications of whether the features have an associated property. As part of the generation of the machine learning model, the machine learning module 518 forms a training set of features by identifying a positive training set of features that have been determined to have the property in question, and, in some embodiments, forms a negative training set of features that lack the property in question. In one embodiment, the machine learning module 518 applies dimensionality reduction (e.g., via linear discriminant analysis (LDA), principle component analysis (PCA), or the like) to reduce the amount of data in the features for content items to a smaller, more representative set of data.

The machine learning module 518 uses supervised machine learning to train the machine learning model, with the features of the positive training set and the negative training set serving as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The machine learning model, when applied to the features extracted, outputs an indication of whether the features have the property in question.

In some embodiments, the computer system mines the Internet for multimedia content associated with multiple industries using the machine learning model 518. The machine learning model 518 is trained using features indicative of at least a particular industry of the multiple industries. The multiple industries are categorized by the hierarchically indexed multimedia database, which includes multiple branches including a particular branch associated with the particular industry.

In some embodiments, the computer system uses the machine learning model 518 to cluster the multimedia content among multiple issuer entities of the particular industry using deep learning. Deep learning architectures include deep neural networks, deep belief networks, recurrent neural networks, and convolutional neural networks. Deep learning involves the use of multiple layers in the network having an unbounded number of layers of bounded size, which permits practical application and optimized implementation. In some embodiments, the deep learning is configured to determine a relationship from the multimedia content between each issuer entity of the multiple issuer entities and each other issuer entity of the multiple issuer entities.

In some embodiments, the hierarchically indexed multimedia database automatically populates the same video or audio of the same company at the same node level with the same name under a different industry in the hierarchy. The hierarchically indexed multimedia database automatically populates multiple companies and their attached videos and audio recordings located at multiple node levels within and across multiple industries. The hierarchically indexed multimedia database is constantly scanning the industry hierarchies looking for patterns of identical paths of multiple node levels in one industry to copy the missing node levels with associated companies and their corresponding audio and videos to another industry. In this way, the database is both cross-indexing and automatically building itself.

The hierarchy management tool 522 adds nodes to node trees, replicates portions of node trees, instantiates branches, updates node trees, and cross-indexes nodes based on new multimedia content and information from the analytics websites 534. In some embodiments, rule sets are defined for use in hierarchy management. For example, an issuer is associated with at least one node, determined in the issuer profile questionnaire. An issuer can select a higher tier node to associate to its profile, because a company can provide multiple services and products. An issuer can have multiple nodes associated to it, both within the same industry and across industries. To select multiple nodes, the issuer can use a hierarchy dropdown selection and choose to add a node to its profile. Issuer signups are reviewed by the computer system before they are approved in the platform; optionally, mandatory review-alerts are triggered if multiple nodes are selected by a company. The nodes associated to video/audio files can be different from what is associated to an industry but is a direct descendant of one of the company’s profile nodes. A Video/Audio node is the lowest node level in a branch.

In some embodiments, a rule set is used to associate Video/Audio nodes to a maximum of three nodes, and they can be associated to a cross-indexed node. These are lowest tier nodes (see FIG. 8). An alternative to this is to allow a video/audio file to be associated to multiple nodes, but they are lowest-level nodes under the company node. Cross-indexed nodes are considered functionally equivalent, meaning if a video is associated to node cross-indexed to another, then searching either node should show the same video. All nodes are considered products for the purposes of categorization, but in the media questionnaire and in the metadata associated to each video, the computer system will differentiate between the media files as either product-related, service-related, or both.

In some embodiments, the computer system uses the hierarchy management tool 522 to generate a node tree structured in accordance with the relationship between each issuer entity and each other issuer entity. Each node of the node tree is associated with a respective issuer entity. The hierarchy management tool 522 incorporates the node tree within the hierarchically indexed multimedia database, such that the node tree is supported by the particular branch. In some embodiments, the computer system determines that video or audio stored on the particular branch of the hierarchically indexed multimedia database mismatches the particular industry. The hierarchy management tool 522 transfers the video or audio to a second branch of the hierarchically indexed multimedia database, wherein the video or audio matches a second industry associated with the second branch.

The cloud service 506 includes the host service 524, which refers to a Web-based or cloud-based hosting service that provides object storage using a scalable storage infrastructure through a Web service interface. Objects, which allow for uses such as storage for Internet applications, backup and recovery, disaster recovery, data archives, data lakes for analytics, and hybrid cloud storage can be stored.

The host storage 526 refers to a distributed relational database service running in the cloud for setup, operation, and scaling of the hierarchically indexed multimedia database for use in applications. In some embodiments, videos and metadata are kept private through configuring the host’s storage and retrieval account settings. For example, in a particular implementation, YouTube has three video listing settings: Public, Private, and Unlisted. Public allows all users in YouTube to search for the video and see the video based on the video name/metadata. Private prevents any user except the owner and up to fifty authorized YouTube users from viewing the video or seeing the video in search results. Unlisted prevents users from seeing the video in search results, but allows users to view the video if they have the URL of the video. The Unlisted setting is sometimes used for each of the videos. Thus, the proprietary categorization information is only stored and available through the hierarchically indexed multimedia database, and no meta data besides the video name is passed to the multimedia content host 528. Thus, none of the proprietary categorization hierarchy data would be passed to the multimedia content host 528.

The multimedia content host 528 refers to an online video platform that enables users to view, download, upload, share videos, or live stream videos using the Internet. The multimedia content host 528 includes a video display service 530 and an analytics engine 532. The video display service 530 provides playback, interactive video tools, and a customizable player. In some embodiments, a home page provides videos and audio and links to videos (videos and list formats) and audio, such as news-related videos and audio of the day, industry videos and audio of the day, sector videos and sector audio of the day, group videos and audio of the day, videos and audio of a specific node level, product type, or service type, volume-related videos of the day, volume-related audio of the day, price-related videos of the day, price-related audio of the day, high-viewing activity videos, high listening activity audios, growth in rate of viewing activity of videos, or growth in rate of listening activity of audio.

The embodiments that are disclosed herein in connection with video apply as well to audio, for example, podcasts. Video and audio (podcasts, webcasts, management conference calls, webinars, etc.,) content is all subject to categorization within the hierarchy, video and audio trading alerts, video and audio thumbnails, video and audio cross indexing, video and audio correlated trading analysis, video and audio (podcast) trading alerts, and a self-building hierarchy for video and audio.

The analytics engine 532 provides built-in video viewing analytics of who is watching the videos, or listening to the audios, such as conference calls/podcasts (e.g., analysts, individual investors, portfolio managers, CEOs, C-level executives, competitors, recruiters, or vendors and suppliers to the company within an industry, sector, subsector, node level). The analytics engine 532 determines what is being watched/listened to (e.g., company video or audio, industry, such as aerospace, robotics, sector video or audio, subsector video or audio, or video or audio at node levels). The analytics engine 532 determines how many separate viewers or listeners are watching the videos or listening to the audio (e.g., by company, industry, sector, subsector, or node levels).

In some embodiments, the analytics engine 532 determines for how long they are watching it or listening to it (e.g., seconds, minutes, hours, days, weeks, months, or years). The analytics engine 532 determines how many times have they watched the same video or listened to the same audio about a particular company or a specific node level. The analytics engine 532 determines growth in number of viewers/listeners watching it or listening to it (e.g., last 15 minutes, 30 minutes, 45 minutes, last hour, 1, 2, 3, 4, 5, 6, 7, 8, 9, 10 hours, etc., last 24 hours, 1-30 days, month, quarter, week-to-date, month-to-date, year-to-date, or last 12 months). The analytics engine 532 determines how many times a user watched videos or audio about a particular industry, sector, subsector, or a node level. In some embodiments, video viewing activity (viewing metrics) and audio listening activity (audio metrics) is automatically recorded and correlated, including: who is watching/listening, what are they watching or listening to, how many viewers are watching it/listening to it, how long are they watching or listening, or how many times they are watching it or listening to it, at any node level.

In some embodiments, the computer system uses the analytics engine 532 to determine a second metric quantifying user engagement with multimedia content stored at a node of the hierarchically indexed multimedia database. The multimedia content and the node are each associated with the particular issuer entity of the multiple issuer entities, where the hierarchically indexed multimedia database categorizes the multiple issuer entities. In some embodiments, the computer system determines a multidimensional correlation of the first metric to the second metric. For example, the viewing and listening metrics are correlated to a security price change (stock/bond/any type of security), a trading volume/change in volume by security, a security price and volume changes of all public companies at a specific node level, security performance/change in performance of a composite (index/ETF etc.,) resulting from change in price performance of underlying companies that make up that index or ETF, etc., resulting from video viewing activity or audio listening activity, changes in money flow into/out of an industry, sector, group, sub-sector, or a node level, group and sector rotation, e.g., out of In-Vitro Fertility companies and into In Vivo Fertility, companies trend analysis, increase in funding of private companies currently conducting a financing that have posted videos and or audio to the platform and the correlation between number of views/viewers or listens/listeners to the progress of the private company’s funding campaign. An exchange traded fund (ETF) is a type of security that tracks an index, sector, commodity, or other asset, but which can be purchased or sold on a stock exchange the same as a regular stock.

In some embodiments, video viewing and audio listening on the platform is determined based upon a multiplicity of metrics, which can be amount of video viewers/audio listeners, growth in viewers/listeners, and can also be time-based metrics with respect to video views and audio listens, and measuring these video viewing and audio listening metrics at the industry, sector, group, node level or company level. The system then simultaneously receives, warehouses, and measures engagement from the various social media platforms, sentiment from the social sentiment web sites and platforms, and messaging metrics, such as chat activity, chat frequency, growth in chat room populations.

The computer system ranks the particular issuer entity among the multiple issuer entities based on the multidimensional correlation. The computer system uses the hierarchy management tool 522 to update the node to include data describing a rank of the particular issuer entity among the multiple issuer entities based on the ranking. In some embodiments, the computer system displays a graphical user interface representing the multi-dimensional correlation (e.g., a bar chart of video watchers and audio listeners, a line chart of video watchers and audio listeners, regression analysis with two standard error bands across multiple time periods, or trend analysis by day, week, month, quarter, or year-to-date). In some embodiments, the computer system displays a graphical user interface representing histograms, scatter grams, pie charts, flow charts, binary tree charts, time lines, or area charts showing the multi-dimensional correlation.

In some embodiments, change in video and audio metrics are compared, which is measured at any node level, and which could be at the company level or industry, sector, sub-sector, group or any node level including company level, to the change in the social media engagement, e.g., Twitter or Facebook, and social sentiment indicators, e.g., Stocktwits, and messenger activity of a specific stock or general stock chat group, frequency change in chatter and other messenger metrics of the messenger apps, e.g., WhatsApp, Viber, etc. The computer system provides bi-directional and multi-directional correlations of the viewing/listening activity of the platform to the social media engagement, social sentiment indicators, and messenger app activity. Measurements and correlations are one to one, one to many, and many to many.

The system has a large selection of alerts that can be set based upon quantitative levels of views/listens, social engagements, social sentiment indicators, messenger activity and their correlations. The social media or social sentiment or messenger activity may be sourced directly from these sources or via an API, or from the company/issuer’s social media or social sentiment or messenger app account which they have provided to us to access. For example, “Notification Alert: Send Alert to User via email and SMS/text when: Video Views or Audio Listens of XYZ Company increase by 100 within the last eight hours and social engagements,” e.g., likes, increase by 1000 in the last twelve hours, positive social sentiment increases by 30% within the last four days, and messenger chatter activity in stock chat room increases by 50 people in the last week.

The analytics websites 534 refer to entities that provide stock analysis, financial analysis, brokerage recommendations, and bond credit ratings. In some embodiments, the computer system mines the analytics websites 534, using the machine learning module 518, to identify a change in a rating of the particular issuer entity. The rating is provided by the analytics websites 534 for multiple issuer entities. The computer system transmits the multimedia content and the change in the rating of the particular issuer entity to the multimedia content host 528 for storage at the identified node.

In some embodiments, trading, viewing, and listening alerts are created by setting alerts on parameters, e.g., who is watching the video or listening to the audio (competitor company, wall street analyst), what type of video are they watching, or audio are they listening to (e.g., company presentation, video about Food and Drug Administration (FDA) approval, video re proxy 14A, 14F), watching video or listening to audio at company level, industry level, sector level, node level, how many viewers are watching it/listeners are listening to it, how long (duration) are they watching or listening, how many times they are watching it or listening to it (company video, videos or company audio or multiple audios), security price change (stock, bond, any type of security), trading volume/change in volume by security, security price and volume changes of all public companies at a specific node level, or security performance/change in performance of a composite (index/ETF, etc.) resulting from change in price performance of underlying companies that make up that index or ETF, etc., resulting from video viewing activity or resulting from audio listening activity. FDA refers to the federal agency under the U.S. Department of Health and Human Services.

In some embodiments, trading, viewing, and listening alerts are created by setting alerts on parameters, e.g., changes in money flow into/out of an industry, sector, group, sub-sector, node level, group and sector rotation, e.g., out of In-Vitro Fertility companies and into In Vivo Fertility companies, correlation coefficient based alert, e.g., correlation coefficient of 0.95 of two public companies within two standard error bands over a six month period (e.g., a geometric increase in views of a video or listens of an audio of one company versus another company at the same node level or one node level above or below could trigger a pairs trade with one of the pair long and the other pair short, all precipitated from video views of the pairs), changes in viewing and listening activity as it relates to company and industry news, or technical analysis indicators correlated to viewing and listening activity and vice versa, e.g., moving averages, stochastics, etc.

In some embodiments, natural language processing, e.g., linguistics, computer science, and artificial intelligence and facial recognition/emotion recognition from the video or audio is used to predict confidence or lack thereof in company representations (e.g., operating results, earnings, cash flow, revenue, etc.), product launching on time, likelihood of closing a merger, management succession or lack thereof, confidence of completing a financing or lack thereof. A classification system for issuers and an alert system is provided by embodiments based on the issuer profile questionnaire used to enter an issuer’s data into the hierarchically indexed multimedia database.

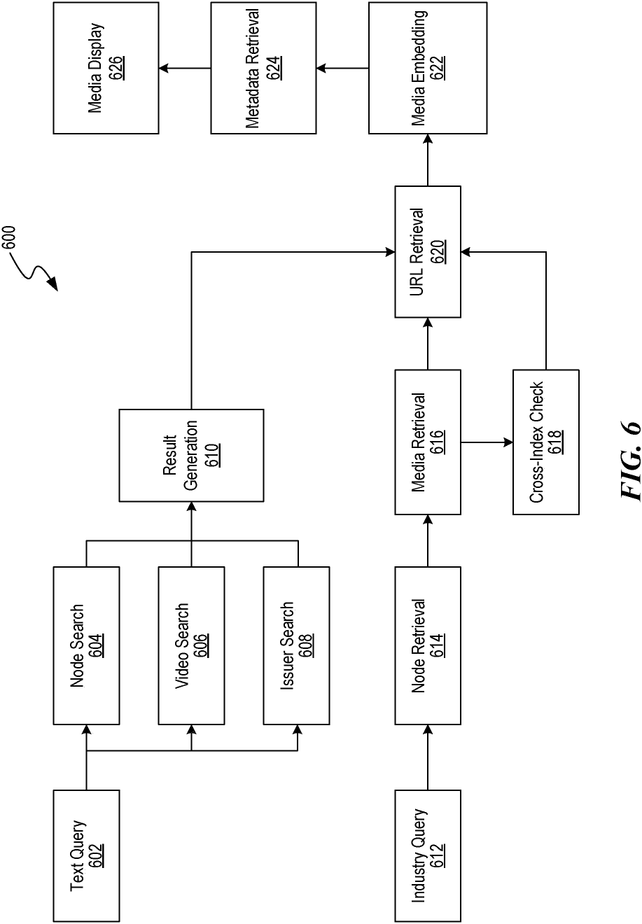

FIG. 6 is a flow diagram illustrating an example process for serving media on user query flow, in accordance with one or more embodiments. The media is organized in a hierarchically indexed multimedia database. The hierarchically indexed multimedia database is the same as or similar to the hierarchically indexed multimedia database 206, illustrated and described in more detail with reference to FIG. 2. In some embodiments, the process 600 of FIG. 6 is performed by a computer system, e.g., the example computer system 1000 illustrated and described in more detail with reference to FIG. 10. Particular entities, for example, the hierarchically indexed multimedia database or a host service perform some or all of the steps of the process in other embodiments. Likewise, embodiments may include different and/or additional steps, or perform the steps in different orders. The host service is the same as or similar to the host service 524 illustrated and described in more detail with reference to FIG. 5.

The computer system receives (602) a combinatorial query from an investor entity that is searching for multimedia content based on text. In some embodiments, the computer system receives a combinatorial query from an issuer entity, referencing interactions with the multimedia content stored at a node. For example, the query is combinatorial to allow search on any and all parameters at once, as well as additional parameters that can include (when recently posted, last day, week, month, quarter, this calendar year, or date range) or price. In some embodiments, a data feed is provided for price change versus previous day, price performance for day, week, month, quarter, YTD, or market cap.

The computer system performs (604) a node search for node names in branches of the hierarchically indexed multimedia database. For example, a user search consists of text and dropdown selections, and each of the dropdown selections are used to narrow the results of the search and the text input is used to search across video names and descriptions. As videos are found which match the various criteria, their URLs and metadata are retrieved and shown to the user. The multimedia content host URLs and remote storage addresses are stored in the video table along with other video-specific information. When the system looks up a video, it also has access to these addresses. The multimedia content host is the same as or similar to the multimedia content host 528 illustrated and described in more detail with reference to FIG. 5.

The computer system performs (606) a video search for video titles and descriptions. In some embodiments, the investor-facing front end includes multiple text boxes joined together by Boolean operators to allow users to search for videos, audio files, or issuers based on AND/OR conditions. These text boxes act as search terms in addition to the dropdown selectors available in the screener tool. In some embodiments, the hierarchically indexed multimedia database provides front end users with the ability to search for companies and nodes that have identical strategic partners and overlapping or identical key suppliers/vendors, and overlapping or identical founders by company and node level, and provide the names and percentage overlapping or identical strategic partners and key suppliers/vendors and founders. Users also have the ability to run searches by correlation coefficient (in decimals or percentages) of overlapping or identical key partners and key vendors/suppliers and overlapping or identical founders.

The computer system performs (608) an issuer search for company names and competitor names. In some embodiments, during issuer signup, a database entry in the issuer table is populated along with all of the profile data associated with that company (e.g., name, company type, ticker symbol, etc.). Each company has a unique, system generated ID (Primary Key) associated with it, which is also used as a Foreign Key in the video table so that each video is associated with a company. When the computer system retrieves company/video data to show to the user, it can also lookup and retrieve the company profile data using these reference IDs (Primary/Foreign Keys) to see the relationships between entries in each table.

The computer system identifies (610) result nodes that fit the search criteria as well as cross-indexed nodes. In some embodiments when no result node is found, the computer system uses a hierarchy management tool to instantiates a new node in the hierarchically indexed multimedia database based on the combinatorial query. The new node is associated with an issuer entity. The hierarchy management tool stores the multimedia content at the new node. The hierarchy management tool is the same as or similar to the hierarchy management tool 522 illustrated and described in more detail with reference to FIG. 5.

The computer system receives (612) an industry query from an investor search based on industrial categorization, hierarchy, and other qualitive fields of the hierarchically indexed multimedia database. Investor users can search for and browse videos according to the hierarchy (industry categorization nodes) and video metadata (title, company, description, etc.). The computer system stores videos and tracks their hierarchical categorization in the reference table, which contains a record of the Video’s ID (the Primary Key identifier for every video in the video table) and the HierarchyNodeID (the Primary Key identifier for every node in the industry categorization table). FIG. 6 illustrates an example of how the computer system returns media files/companies based on investor text searches or by browsing the categorization hierarchies.

The computer system retrieves (614) child nodes of the hierarchically indexed multimedia database as the investor selects an industry and a sublevel of the hierarchically indexed multimedia database. In some embodiments, the computer system analyzes individual user usage of the hierarchically indexed multimedia database application. For issuers, the system analyzes data, such as video/podcast uploads, media questionnaires, issuer profile questionnaires, node associations, and user engagement to provide recommendations to improve issuer experience/success. The issuer profile questionnaire is the same as or similar to the issuer profile questionnaire 1100, illustrated and described in more detail with reference to FIG. 11. The media questionnaire is the same as or similar to the media questionnaire 1200, illustrated and described in more detail with reference to FIG. 12.

Recommendations can be displayed on a graphical user interface using a profile strength bar/meter showing the relative strength and/or completion of a profile, as well as the strength of the questionnaires and other uploaded files. Additional metrics used to incentivize following recommendations include issuer profile view counts, miscellaneous file view counts, product link view counts, search appearances for an issuer and for each of the issuer’s uploaded media files. Investor recommendations include recommendations for profile completion, recommended issuers, industries, or issuer content based on a user’s interests and previous activity (e.g., search history, viewing/listening history, file access history, or product link history).

The computer system retrieves (616) media and companies associated to nodes as each level is selected. The media is filtered based on qualitative criteria selected by the investor. In some embodiments, the hierarchically indexed multimedia database (referred to as an “issuerPixel database”) returns data for security price changes, trading volume/changes, or security price and volume changes, and provides reports showing correlations and comparisons between these sets of data. Data sources for these include services such as finnhub.io and tiingo.com, which provides detailed trading information to recognize financial movement patterns as they relate to the IssuerPixel application’s video and audio usage.

The computer system performs (618) a cross-index check to determine whether a result node is cross-indexed to another node. Videos from both nodes are displayed by a video display module, e.g., the video display module 530, illustrated and described in more detail with reference to FIG. 5. For example, the reference table is searched by the computer system based on the Video ID or the HierarchyNodeID, and enables multiple videos to be associated to a single categorization node and for a single video to be associated to multiple categorization nodes. Examples of these two cases are provided below, where video 5673 occurs twice in the table and is associated to two different nodes, indicating that the video has been categorized under two distinct categorizations, either within the same Industry or in separate industries. Additionally, hierarchy node 243 occurs twice in the table, indicating that two separate videos (46 and 5673) are both associated with this node.

| ReferenceID | VideoID (Foreign Key) | HierarchyNodeID (Foreign Key) |
|---|---|---|
| 51 | 46 | 243 |
| 52 | 5673 | 427 |
| 53 | 3432 | 139 |
| 54 | 5673 | 243 |

Each video is associated with an issuer who uploaded the video through a field in the video table that references the issuer’s Primary Key. Each video has an issuer associated to it. Issuers are not deleted (they can be inactivated, but a record of them remain in the database), such that the system never loses data integrity. In addition to being associated with an issuer, the video is also associated directly to a company.

The computer system retrieves (620) a URL provided by the multimedia content host. The multimedia content host is the same as or similar to the multimedia content host 528 illustrated and described in more detail with reference to FIG. 5. The URL is associated to media objects associated to the result nodes. Once the system has determined which videos need to be retrieved based on a user’s search criteria, the system looks up those video entries in the video table and then looks up the multimedia content host’s URL associated to every video entry. This URL is pulled and then used in the front-end of the web application to embed the target video in the web app for viewing.

The computer system embeds (622) a media file thumbnail and a title in the results provided. For example, when the URL is pulled from the database, the URL is sent to the Web application where the software retrieves the video from the URL and embeds the video in the web page for viewing. The call made to retrieve the video from the URL may require sending credentials to the host service in order to access the video. If a user clicks on a specific media file, the computer system retrieves the media file metadata.

The computer system displays (626) a file details page, the media file using an embedded media file player, the metadata, and company data, etc. The media may be displayed using the video display module 503, illustrated and described in more detail with reference to FIG. 5. For example, the computer system displays a change in a rating of an issuer entity on a graphical user interface in response to a query referencing a result node. In another example, responsive to receiving a combinatorial query from an investor entity referencing a node tree, the computer system transmits a multidimensional correlation to the investor entity. The multidimensional correlation is described in more detail with reference to FIG. 5. In some embodiments, responsive to receiving a combinatorial query from an investor entity referencing a particular industry, the computer system displays a graphical user interface displaying a node tree associated with the industry to the investor entity.

In some embodiments, the computer system transmits investor activity to an issuer entity responsive to receiving a combinatorial query. For example, an analytics module can determine investor activity viewing multimedia content. The analytics module is the same as or similar to the analytics module 514 illustrated and described in more detail with reference to FIG. 5. The analytics module aggregates interactions of the investor entity with the multimedia content stored at the node into investor activity formatted in accordance with the structure of the hierarchically indexed multimedia database. In some embodiments, the computer system receives a combinatorial query from an investor entity referencing a node. The computer system transmits a rank of an issuer entity associated with the node, among the multiple issuer entities, to the investor entity in response to the combinatorial query. Ranking multiple issuer entities is described in more detail with reference to FIG. 5.

In some embodiments, the computer system analyzes and compares videos and audio against each other with respect to characteristics, such as views or listens. For example, the computer system can compare media using screening (screener page) characteristics including industry taxonomy-related, company characteristics, media type (e.g., vlog, etc.), reporting status, or research coverage type. The media can be compared based on the media questionnaire characteristics, social media characteristics, fundamentals (ratios and operating metrics), technicals (stock technical analysis), duration, subject matter (video/audio subject), or meta data. In some embodiments, a machine learning module is used to compare the media using association rule learning, a rule-based machine learning method for discovering relationships between variables in large databases. For example, the machine learning module uses rule-based machine learning to identify a set of relational rules that collectively represent the knowledge captured by the database. The rule-based machine learning approach includes learning classifier systems, association rule learning, and artificial immune systems.

FIG. 7 is a drawing illustrating an example graphical user interface displaying a hierarchy dashboard 700 for a self-building hierarchically indexed multimedia database, in accordance with one or more embodiments. The hierarchy dashboard 700 is presented in the form of the graphical user interface to an investor entity or an issuer entity. The hierarchically indexed multimedia database is the same as or similar to the hierarchically indexed multimedia database 206 illustrated and described in more detail with reference to FIG. 2.

In some embodiments, a computer system receives video or audio from an issuer entity. The computer system is the same as or similar to the example computer system 1000 illustrated and described in more detail with reference to FIG. 10. The computer system determines that the issuer entity belongs to an industry excluded from the multiple industries of the self-building hierarchically indexed multimedia database. The determining is performed using a machine learning module based on the video or audio. The computer system generates a new branch associated with the excluded industry. The computer system incorporates the new branch within the hierarchically indexed multimedia database as shown in FIG. 7. For example, the computer system generates a new node associated with the issuer entity and supported by the new branch. The computer system stores the video or audio at the new node. A suggestion box to edit nodes in the hierarchy can be displayed in different ways. In some embodiments a button is displayed next to each hierarchy node which, when clicked, shows a new popup window with the node’s information (including direct ancestors of the node and the immediate child nodes of that node) along with the three request types of Add, Remove, or Edit and a textbox for the user to explain their request (see FIG. 7). Requests are tied to the user’s profile.

In some embodiments, the industry hierarchies shown in FIG. 7 are used as a mechanism to create lead generation for sales of products and services of the issuer and further investment community visibility for the issuer, via the front end user, who is an investor or prospective product/service purchaser, who has direct access to the issuer via the platform’s industry hierarchies, for both sales of products and services of the issuer and further investment community visibility for the issuer on a per transaction-per click basis. For example, an issuer profile questionnaire is modified to include a URL for the company’s product/service sales department, email address for sales department, phone number for product/service sales/business development department, URL for a company’s investor relations department, email address for company’s investor relations contact, phone number for company’s investor relations contact, or company credit information. The issuer profile questionnaire is the same as or similar to the issuer profile questionnaire 1100, illustrated and described in more detail with reference to FIG. 11.

In some embodiments, front-end users use industry hierarchies not only for investment research, but also for a company’s product/service-related sales, via lead generation for the sales of its products/services (sales leads for the issuer) and providing direct access for investors to the issuer, providing the issuer with investment community visibility to the issuer. At any node level an investor/user can click a button to go to a company’s URL for product/service sales, a company’s email address, or call the company.

The investment community is also provided with a visibility-pay per click feature. At any node level, an investor/user can click a button to go to a URL for an issuer’s investor relations department, an e-mail address for the company’s investor relations contact, a phone number for the company’s investor relations contact, etc. Each action transmits remuneration to the hierarchically indexed multimedia database 206 on a per-click basis, emanating from the hierarchy at the lowest node level. For example, a front-end user clicks on a “Flight Management Systems” node. The main flight management systems manufacturers (Honeywell International Inc. (U.S.), Thales Group (France), General Electric Company (U.S.), Leonardo-Finmeccanica S.p.A (Italy), Rockwell Collins (U.S.), Esterline Technologies (U.S.), and Garmin Ltd.) are listed. The user then clicks on any one of these companies. The user then has a choice. They can click on Videos or Audio. They can instead opt for: 1. Contact product sales; or 2. Contact investor relations. Then, they can select any one of the above “Click Actions.” Each action charges the issuer on a per-click basis and initiates the selected action.

Referring to FIG. 7, the hierarchically indexed multimedia database application provides the following features. “Node Warp”: a button next to a node or set of “Industry” level search results where the user can warp to a related node as suggested by the application (or administrators). This feature is useful in nodes that can fall within multiple industries (cross-indexed nodes or otherwise similar nodes). For example, if an issuer associated to a node in Medical Devices enters the Healthcare industry tree, and then goes to Medical Services → Medical Services (non-transport) → Transplant Surgery → Heart Transplant → Medical Devices, the application displays a button that allows that user to go to Medical Devices pertaining to Heart Transplants, within the Medical Device Industry tree. “Cross Indexing Notes for nodes”: This feature allows administrators to add free-text notes to nodes. This is primarily intended to track cross-indexed nodes, but may also be used for other note taking purposes. “Search Text Box on Back End”: to search nodes by name or ID. “Tracking and Logging for Duration for Issuer to go Through Questionnaire”: The application will detect when the user lands on a page and when a form is submitted. Additionally, user input is tracked in fields even before the form is submitted. This allows the capture of more information from the user, such as user fall-off, partially input information, and general user flow through the issuer profile questionnaire. Greater insight into user behavior allows the issuer profile questionnaire to be adjusted in terms of content, layout and format so as to improve user retention. Additionally, the partially completed forms may be automatically saved when users leave or close the page so that the form is restored when users return to the same form. This improves a media questionnaire completion and video upload rates. The media questionnaire is the same as or similar to the media questionnaire 1200, illustrated and described in more detail with reference to FIG. 12.

In some embodiments, the hierarchically indexed multimedia database application provides the following features. “Duration Logging for Research Analysts Viewing Industry Hierarchy Pages”: the application will periodically ping the browser to see if that page is still open, and will display a log of the duration spent on each industry page by user and timestamp. This feature, in addition to the logging of each node’s creation by user and timestamp, will provide administrators with greater insight into hierarchy completion rates, problematic industry hierarchies, analyst efficiency and strengths, and rates of research improvement. “Allowing Administrators to Add and Remove ‘Test’ Companies to the System”: for verification, the application is tested by adding companies to the system by going through the registration process in the development environment, including the issuer profile questionnaire for issuers and media questionnaires for media files. This will allow tests and ensure the web application is functioning as expected, as well as assuring the quality of the user experience for issuers.

In some embodiments, the hierarchically indexed multimedia database application provides the following features. “Front End - Boolean Logic Search”: in addition to drop downs for front end user’s searching of video and audio files. The investor-facing front end will include multiple text boxes joined together by Boolean operators to allow users to search for videos, audio files, or issuers based on AND/OR conditions. These text boxes may act as search terms in addition to the dropdown selectors available in the screener tool. “Issuer - User private chat functionality with issuer (‘Issuer Online’)”: the application will include a real-time communication protocol between issuers and users (a chat feature). This communication protocol will mirror other common customer support chat protocols. The chat protocol will be an optional feature for issuers which will need to be activated either during issuer registration or in the issuer’s preferences.

On the investor-facing front end, each registered front end user has access to communicate with the issuer through the chat popup window when they see/are notified “Issuer Online.” Users can use this chat feature to ask questions and communicate privately with the representative of the issuer. This would create more investment community visibility for issuers so issuers can gather more prospective investors/users by creating more direct contact with them. Users can also search for companies where issuers representatives are online and available to chat. Additional methods to display to/notify users that issuers are online include adding a section on the home page highlighting industries/sectors where issuer representatives are online; and “Companies” section (on home page) where issuer representatives are online. This feature is considered a stretch goal post-launch.

In some embodiments, the hierarchically indexed multimedia database application provides the following features. “Analysis-Based Suggestions”: an automated requests feature for issuers, using market data analysis and/or application data analysis to suggest what kind of content to post, metadata to add to existing content, and video characteristics/qualities to improve on. Requests may be made directly through the issuer dashboard or through email notifications, these requests may be directed en-masse to issuers based on platform wide data analysis. “Recommendation Engine”: individually tailored recommendations for additional metadata, video files, and audio files based on system or administrator analysis for issuers and investor front-end users. The application will analyze individual user usage of the application. For issuers, the system will analyze data such as video/podcast uploads, media questionnaires, issuer profile questionnaires, node associations, and user engagement to provide recommendations to improve issuer experience/success. One method of displaying this recommendation is through a Profile strength bar/meter showing the relative strength and/or completion of their profile, as well as the strength of their issuer profile questionnaire and other uploaded files. Additional metrics to incentivize following recommendations include issuer profile view counts, file view counts, product link view counts, search appearances for the issuer and for each of the issuer’s uploaded media files. Investor recommendations may include recommendations for profile completion, or recommended issuers, industries, or issuer content based on that user’s interests and previous activity (e.g., search history, viewing/listening history, file access history, product link history).

In some embodiments, the hierarchically indexed multimedia database application provides the following features. “Smart Searches Which Ignore ‘Clutter’ Terms”: searches that include words like “company”/“companies” or other common phrases like “LLC” should accurately provide results without cluttering results with other companies that have the word “company” in the title. Some possible solutions to this issue include either fully ignoring these common words or performing two searches and merging their results, or performing a search with these exact results but ignoring other results based on these “clutter” words. “Utilize Natural Language Processing”: the application will analyze the direct message traffic between issuers and investors via the chat feature. The application (or administrators) could then make requests to issuers about new video and audio files to post based on interest/need shown in chats. Investors will also be able to suggest to issuers the types of videos that they would like to see. This would encourage issuers to post more video and audio files to the platform.

In some embodiments, the hierarchically indexed multimedia database application provides the following features. “News Blog and RSS feeds”: the platform (referred to as an “issuerPixel platform”) includes a blog containing articles/posts written by authorized users and the site administrators. These blog posts improve site SEO and provide more value content for users of the site. In addition to adding content for site visitors, the aspect promotes features within the site or issuers who pay for such promotions (sponsored articles/promotions). In addition to the posts or articles generated by the issuerPixel application, the site contains an RSS feed pulling articles and/or news from other investor institutions and sources. This feed is curated by administrators so as to provide value relevant to issuers on platform and current market trends/investor interests. “Virtual Assistant”: the issuerPixel application features a virtual assistant to facilitate communication with support tickets and sales appointments. This assistant integrates with the issuerPixel database’s external CRM system to better organize customer interactions. “Provide Videography Company Suggestions”: for issuers to facilitate easier and higher quality video production. The platform integrates with an advertising firm (on a commission basis) to get videography companies to be advertised on the recommended videographers list. This provides the benefits of: more videos from issuers around the globe, ad revenue from videography companies around the globe (without polluting the front end of the platform), improved media quality on platform, and additional awareness from various videography/audio production contacts.

In some embodiments, the hierarchically indexed multimedia database application provides the following features. “Front end users have the ability to suggest [via sending a submission to the research administrator just like with nodes] adding a company to a node level, at any node level, within any industry”: users can request adding a company (issuer) at any node level. The issuer profile questionnaire includes additions to support this feature include Strategic Partners, Key Suppliers/Vendors, Company Founders, Company Executives. The database takes the strategic partner and key supplier/vendor and founder data and compares the data between all companies in all industries and at all node levels, seeking overlapping (identical) partners and identical key suppliers/vendors and founder(s). The database provides front end users with the ability to search for companies and nodes that have identical strategic partners, overlapping or identical key suppliers/vendors, and overlapping or identical founders by Company and node level, and provide the names and percentage overlapping or identical strategic partners, key suppliers/vendors, and founders. Users also have the ability to run searches by correlation coefficient (in decimals or percentages) of overlapping or identical key partners, key vendors/suppliers, and founders.

In some embodiments, the hierarchically indexed multimedia database application provides issuers with the ability to add transcript files which the system will process using text-to-speech algorithms into audio files for user consumption. Issuers choose whether or not to convert the transcript to audio upon upload, and if they choose to do so the issuer then fills out the media questionnaire for the transcript file. The web application mines the SEC and other data sources for transcript files to be added to the database for companies. These files may be converted into audio files depending on whether it is deemed appropriate to do so.

FIG. 8 is a drawing illustrating an example graphical user interface displaying a portion 800 of a hierarchy of a self-building hierarchically indexed multimedia database, in accordance with one or more embodiments. The hierarchically indexed multimedia database is the same as or similar to the hierarchically indexed multimedia database 206 illustrated and described in more detail with reference to FIG. 2. The portion 800 of the hierarchy is displayed on a graphical user interface of the hierarchically indexed multimedia database application.

In some embodiments, the hierarchy tree includes nineteen levels (including “Industry”), and can be expanded to include more levels. Each level includes one or more nodes, which in turn include a description, a status, and parent/child relationships. Nodes can have one or more children, and also have a parent (except “Industry” nodes) but can be replicated under more than one parent. Child nodes can be created under any node except the bottom-most layer, and can be associated to any parent node on the same level. Parent-child relationships can also be created or removed at any time between existing adjacent layer nodes. Each replicated node is considered a new, unique node in that it has its own unique ID and can be altered independent of other versions of the same replicated node.

In some embodiments, the graphical user interface of the hierarchically indexed multimedia database application drives the following functionality. “Expand/Collapse Node’s Children”: clicking this button will expand or collapse the immediate children nodes of this node. “Cross-Indexed Nodes” (including icon): allows the user to cross-index a node with another node in a separate industry. This creates a relationship between two nodes which the computer system uses to understand that the two nodes can be treated as equivalent and interchangeable, so that issuers and media files associated to one cross-linked node would also appear as being associated to the twin-linked node. Cross-Indexed nodes are marked with a chain-linking icon on the node in the hierarchy tree. Users can view which nodes a selected node is linked to in the cross-indexed details, and may add more than one cross-indexed node association at once. “Description”: node values consist of text input, which is automatically formatted so that the first letter is always capitalized, and all following characters keep the case formatting as input. Node values are unique to that level, meaning if a duplicate node value is entered in the same level as an existing node, then that node will not be created and the user will be notified.

In some embodiments, the graphical user interface of the hierarchically indexed multimedia database application drives the following functionality. “Note”: allows users to add admin-only viewable and editable text. The purpose of this note field is to track cross-indexed node requests from the research analyst team, and can be used for general note taking purposes as well. Nodes with note fields have a comment bubble icon in their node visible on the hierarchy tree screen. “Status”: nodes can be marked as active/inactive; inactive nodes are hidden from non-administrative users and will eventually be deleted. Industry trees can be activated or inactivated; inactive trees are moved to a separate view to prevent clutter. Administrative users with the appropriate permissions can change the status at will at any time. “Delete Node”: delete node allows users to permanently delete a node; doing so also deletes all nodes underneath the target node. “Move”: allows user to move target node and all sub-nodes to becoming a child node destination node which is selected through a search dropdown (using Name and ID). “Duplicate as Industry”: allows user to duplicate targeted node to a new industry, so that the target node becomes an industry level node and all child-nodes are moved along with the node to their appropriate new levels (the sub-tree structure is maintained during move). “Copy Child Nodes”: allows user to copy any selection of a target node’s child nodes to be pasted underneath a destination parent node. This does not remove the original child nodes. “Update”: allows user to save any changes made to target node (e.g., description change), status change, associated parent/child nodes. “Select All” (parent/child node checkbox selection): allows the user to select all child or all parent nodes.

In some embodiments, the graphical user interface of the hierarchically indexed multimedia database application drives the following functionality. “Mass Node Create” (separated by semi colon): clicking an “Add <Industry Level>” button will allow users to add a node at that level, while selecting one or more parent nodes. Users can create multiple nodes at once by separating each new node with a semicolon. “Expand/Collapse All”: allows users to expand or collapse all nodes in the industry hierarchy tree at once. “Portrait/Landscape”: allows users to change the orientation of the industry hierarchy tree from top down to left right and back again. “Refresh”: allows the user to refresh the page so as to show the latest changes in the industry tree. “Save/Restore Backup”: industry node trees can be individually saved (up to ten saves per tree) and a saved version of a tree can be loaded at any time. Loading a save will overwrite existing tree data.

In some embodiments, the graphical user interface of the hierarchically indexed multimedia database application drives the following functionality. “Generate PDF”: generates a PDF version of the industry node tree showing all nodes of the tree. The displayed tree will match the current orientation of the industry tree. “Zoom In/Out”: allows the user to zoom in or out on the industry hierarchy tree without effecting the rest of the page. “Search Nodes”: allows the user to search all of the nodes within the current industry tree by description and ID. This feature will display a list of result nodes and allow the user to select a result to jump to that node in the tree. “Automated DB Backup”: system automatically backs up the entire DB on a weekly basis and stores the snapshots where a developer can restore it if needed. This requires direct database access to restore a previous version. “Node Change Logging”: node creation is tracked according to who made the node and the timestamp of the node creation. “Analyst Time Spent on Hierarchy View”: the system tracks the amount of time an analyst user has spent viewing a specific webpage according to when they started viewing the page and when they stopped. This is tracked by having the page periodically ping the server for as long as the page is open, so the server logs when the page was initially opened and for how long it was open. This log is visible in the administrative portal to users with the appropriate privileges. “Load Optimization”: the system has been optimized to load up to 40K nodes in a single hierarchy tree without crashing a web browser.

In some embodiments, the graphical user interface of the hierarchically indexed multimedia database application drives the following functionality. “Checkbox”: adding a checkbox next to each node in the hierarchy tree, with administrative users able to check multiple nodes at once and then select an action at the top of the tree to apply that action to the entire selection of nodes at once. Actions include Delete, Move, and Copy. Another button for “clear selection” will remove any selected nodes. “Add Company to Nodes”: administrators will be able to add companies directly to nodes with some subset of metadata to uniquely identify the company. Administrators can view what companies are in the system and what nodes they are associated to, as well as what companies are associated to each node in the node details of the hierarchy tree. Issuers will be able to view their existing company profile on signup and be able to choose to “claim” that company during the signup process. “Drag and Click Nodes”: administrators can click a node and drag it to another place within the same hierarchy tree. The administrator can connect and disconnect nodes together (in terms of parent/child relationships). The computer system can also detect if a connection should exist if a user drags a node on top of a line connecting an existing parent/child pair and insert itself as an additional node in between the parent and child, separating parent and child nodes while forming new relationships. The existing parent node becomes a parent node of the selected node, and the existing child node becomes a child of the selected node. Users can choose to click and drag an entire subtree. Users can connect subtrees back to the hierarchy tree by drawing a parent/child relationship between the top of the subtree and any desired parent node. This effectively “moves” the subtree underneath a target node location.

An example process of the self-building executes as follows. A Fertilization node exists under the Healthcare Industry but there are not any nodes below it in Healthcare. An issuer entity or user can enter the Medical Device industry hierarchy (see FIG. 7) and generate, or submit for approval, two nodes below Fertilization consisting of In Vitro Fertilization and In Vivo Fertilization. The entries are approved by the computer system and the hierarchically indexed multimedia database then performs the follow two actions automatically. First, the hierarchically indexed multimedia database adds the two nodes to the Medical Device industry hierarchy. Second, the hierarchically indexed multimedia database automatically recognizes the path in the Healthcare industry hierarchy and creates the two nodes under Fertilization of In Vitro Fertilization and In Vivo Fertilization.

In some embodiments, after the system makes the change, it alerts the computer system to perform verification. There are, thus, three methods for hierarchy building: automatic self-building hierarchy, service administration, and user requests, which can occur from one or more users simultaneously on the platform. For example, an issuer loads a video for their company under: Healthcare → Outpatient Facilities → Fertility Clinics → In Vivo Fertilization → Company. The database automatically populates the same video of the same company at the same node level with the same name called In Vivo Fertilization under a different industry in the hierarchy; in this case, the medical device industry. Thus unsupervised cross-indexing of videos throughout the hierarchies is performed. There are some industries where a company is providing a service and a product or there is a product that is facilitating a service by them or others. In this example, the service is under Healthcare and the product is under Medical Device. The feature is significant in solving the technical problem of unsupervised cross-indexing.

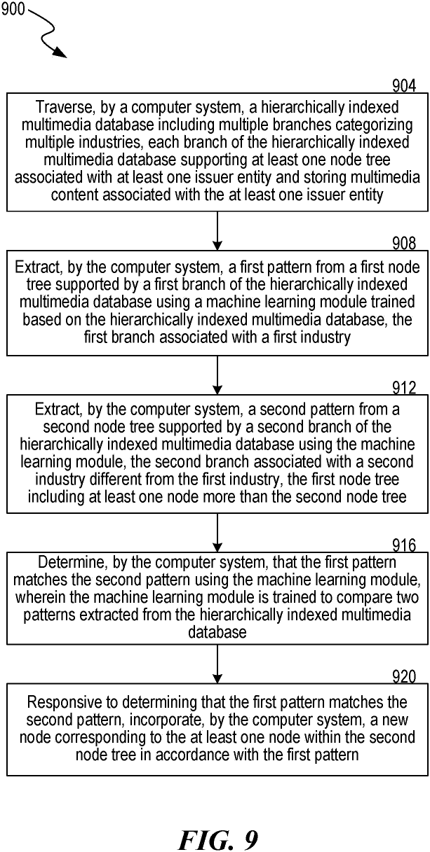

FIG. 9 is a flow diagram illustrating an example process for self-building hierarchically indexed multimedia databases, in accordance with one or more embodiments. The hierarchically indexed multimedia database is the same as or similar to the hierarchically indexed multimedia database 206, illustrated and described in more detail with reference to FIG. 2. In some embodiments, the process of FIG. 9 is performed by a computer system, e.g., the example computer system 1000 illustrated and described in more detail with reference to FIG. 10. Particular entities, for example, the hierarchically indexed multimedia database or a host service perform some or all of the steps of the process in other embodiments. Likewise, embodiments may include different and/or additional steps, or perform the steps in different orders. The host service is the same as or similar to the host service 524 illustrated and described in more detail with reference to FIG. 5.

The computer system traverses (904) the hierarchically indexed multimedia database, which includes multiple branches categorizing multiple industries. Each branch of the hierarchically indexed multimedia database supports at least one node tree associated with at least one issuer entity and stores multimedia content associated with the at least one issuer entity. In some embodiments, a group of a parent node, direct child node, and direct grandchild node is called a branch. When two branches have significant naming or description overlap with another industry, a cross-index relationship is indicated between these branches. Branches can be cross-indexed more than once. Branch sizes may vary, with larger matching branches having a stronger suggested correlation than smaller branches.

The computer system extracts (908) a first pattern from a first node tree supported by a first branch of the hierarchically indexed multimedia database, using a machine learning module, trained based on the hierarchically indexed multimedia database. The machine learning module is the same as or similar to the machine learning module 518 illustrated and described in more detail with reference to FIG. 5. The first branch is associated with a first industry. Using automated self-building, the hierarchically indexed multimedia database (referred to as an “issuerPixel database”) automatically detects patterns within the node trees and determines whether patterns match closely enough to suggest replicating additional nodes from one pattern to the other.

The computer system extracts (912) a second pattern from a second node tree supported by a second branch of the hierarchically indexed multimedia database using the machine learning module. The second branch is associated with a second industry different from the first industry. The first node tree includes at least one node more than the second node tree. The machine learning module is the same as or similar to the machine learning module 518 illustrated and described in more detail with reference to FIG. 5. The machine learning module encapsulates a specific machine learning algorithm, function, or code library that builds a model based on sample data, known as “training data,” in order to make predictions or decisions without being explicitly programmed to do so. The machine learning module 518 applies machine learning techniques to generate a machine learning model that, when applied to extracted features, outputs indications of whether the features have an associated property.

The computer system determines (916) that the first pattern matches the second pattern using the machine learning module. The machine learning module is trained to compare two patterns extracted from the hierarchically indexed multimedia database. For example, For example, if Branch A (a chain of directly related nodes) contains four nodes, and three of the node names closely match (e.g., greater than 98% word similarity) three nodes of the same relationship pattern in another industry’s Branch B, the computer system would then indicate adding the fourth node from A to B in the same position. The computer system can search for patterns using multiple weighted criteria, which can be adjusted. Other criteria which may be used to evaluate and determine if nodes should be added are whether two industries share many cross-indexed nodes, or if the system has previously suggested adding nodes from one to the other and those requests were accepted by an administrator.

Responsive to determining that the first pattern matches the second pattern, the computer system incorporates (920) a new node corresponding to the at least one node within the second node tree in accordance with the first pattern. In addition to the above methods of building the hierarchy, the issuerPixel application also allows investors and issuers (company users) to provide requests in the hierarchy that are then implemented. Users are able to submit requests to add, edit, and subtract nodes to the hierarchy through a suggestion box available for every node they can see within the hierarchy tree views allowed to them. For issuers, the hierarchy tree would show in an issuer profile questionnaire and in a media questionnaire. The issuer profile questionnaire is the same as or similar to the issuer profile questionnaire 1100, illustrated and described in more detail with reference to FIG. 11. The media questionnaire is the same as or similar to the media questionnaire 1200, illustrated and described in more detail with reference to FIG. 12. For investors, the hierarchy tree would show in their homepage and video browsing/search pages, where they would be able to browse through the hierarchy or search based on the hierarchy accordingly.

FIG. 10 is a block diagram illustrating an example computer system 1000, in accordance with one or more embodiments. In some embodiments, the computer system 1000 is a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

In some embodiments, the computer system 1000 includes one or more central processing units (“processors”) 1005, memory 1010, input/output devices 1025, e.g., keyboard and pointing devices, touch devices, display devices, storage devices 1020, e.g., disk drives, and network adapters 1030, e.g., network interfaces, that are connected to an interconnect 1015. The interconnect 1015 is illustrated as an abstraction that represents any one or more separate physical buses, point to point connections, or both connected by appropriate bridges, adapters, or controllers. In some embodiments, the interconnect 1015 includes, for example, a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (12C) bus, or an Institute of Electrical and Electronics Engineers (IEEE) standard 1394 bus, also called Firewire.

In some embodiments, the memory 1010 and storage devices 1020 are computer-readable storage media that store instructions that implement at least portions of the various embodiments. In addition, in some embodiments, the data structures and message structures are stored or transmitted via a data transmission medium, e.g., a signal on a communications link. Various communications links can be used, e.g. the Internet, a local area network, a wide area network, or a point-to-point dial-up connection. In some embodiments, the computer readable media include computer-readable storage media, e.g., non-transitory media, and computer-readable transmission media.

In some embodiments, the instructions stored in memory 1010 are implemented as software and/or firmware to program the processor 1005 to carry out actions described above. In some embodiments, such software or firmware are initially provided to the computer system 1000 by downloading it from a remote system through the computer system 1000, e.g., via network adapter 1030. The various embodiments introduced herein can be implemented by, for example, programmable circuitry (e.g., one or more microprocessors) programmed with software and/or firmware, or entirely in special purpose hardwired (non-programmable) circuitry, or in a combination of such forms. Special-purpose hardwired circuitry may be in the form of, for example, one or more ASICs, PLDs, FPGAs, etc.

FIG. 11 is a drawing illustrating an example graphical user interface displaying an issuer profile questionnaire 1100, in accordance with one or more embodiments. The example issuer profile questionnaire 1100 illustrated in FIG. 11 can include drop-down entries categorizing the company name, entity type - organizational structure, name of individual completing the questionnaire, e-mail address of individual completing the questionnaire, URL for company’s sales department, e-mail address of company’s sales department, phone number for product/service sales/business development department, URL for company’s investor relations department, or e-mail address of company’s investor relations contact for an issuer entity. The example issuer profile questionnaire 1100 can further include drop-down entries categorizing a phone number for company’s investor relations contact, the company founders, CEO, strategic partnerships, public or private company type, base currency, legal entity type, public trading and reporting status, audited financials, patents, or analyst rating for an issuer entity.

FIG. 12 is a drawing illustrating an example graphical user interface displaying a media questionnaire 1200, in accordance with one or more embodiments. The example media questionnaire 1200 illustrated in FIG. 12 can include drop-down entries categorizing the industry, sector, sub sector, group, sub group, echelon, sub echelon, tier, and sub tier for a video upload. The example media questionnaire 1200 can further include drop-down entries categorizing the video title, date of video publication, video presenter, type of video, media sub type, subject of company video, video description, recent road shows, investment bank hosted road show, name of investment bank, and top competitors for a video upload.

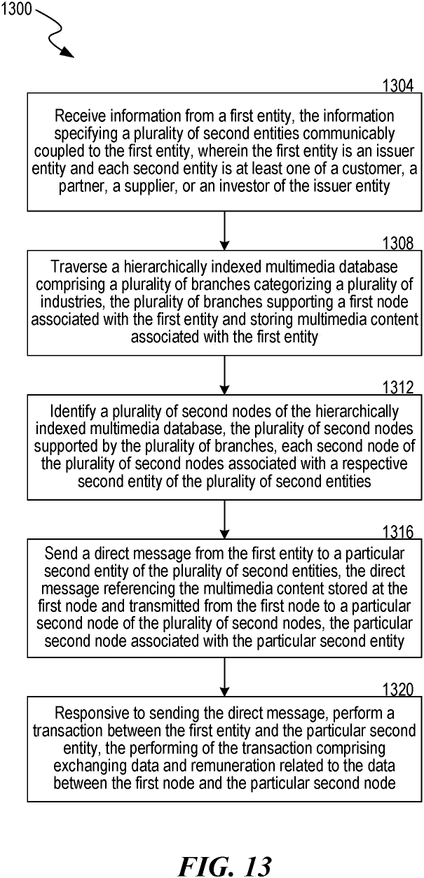

FIG. 13 is a flow diagram illustrating an example process 1300 for direct messaging and transactions within a self-building hierarchically indexed multimedia database, in accordance with one or more embodiments. The process 1300 is performed within a hierarchically indexed multimedia database 206, illustrated and described in more detail with reference to FIG. 2. In some embodiments, the process 1300 of FIG. 13 is performed by a computer system, e.g., the example computer system 1000 illustrated and described in more detail with reference to FIG. 10. Particular entities, for example, the hierarchically indexed multimedia database 206 or a host service perform some or all of the steps of the process in other embodiments. Likewise, embodiments may include different and/or additional steps, or perform the steps in different orders. The host service is the same as or similar to the host service 524 illustrated and described in more detail with reference to FIG. 5.

The computer system receives (1304) information from a first entity. The information specifies multiple second entities communicably coupled to the first entity. The first entity is an issuer entity and each second entity of the multiple second entities is at least one of a customer, a partner, a supplier, or an investor of the issuer entity. For example, the issuer entity can load (upload via a spreadsheet, a CSV file, or other file format) relationships that it currently possesses in its business into the hierarchically indexed multimedia database platform.

The computer system traverses (1308) a hierarchically indexed multimedia database including multiple branches categorizing multiple industries. The multiple branches support a first node associated with the first entity. The first node stores multimedia content associated with the first entity. The traversing is based on the information. In some embodiments, once the relationships are uploaded onto the hierarchically indexed multimedia database platform, the computer system searches for the relationships and reconciles the issuer entity’s relationships (e.g., customers, partners, suppliers, investors) against all the nodes in the hierarchically indexed multimedia database.

The computer system identifies (1312) multiple second nodes of the hierarchically indexed multimedia database. The multiple second nodes are supported by the multiple branches. Each second node of the multiple second nodes is associated with a respective second entity of the multiple second entities. In some embodiments, the computer system identifies for the issuer entity, all of the nodes and all business entities within the hierarchically indexed multimedia database that are on the platform. Once the nodes (and the business entities associated with the nodes) that are related to the issuer entity are identified, the computer system notifies the issuer entity and all of its related entities that they are on the platform, such that the relationships are visible to all parties. The first entity can select a particular second entity with whom to establish a direct messaging channel for communication.

The computer system sends (1316) a direct message from the first entity to a particular second entity of the multiple second entities. The direct message references the multimedia content stored at the first node. The direct message is transmitted from the first node to a particular second node of the multiple second nodes. The particular second node is associated with the particular second entity of the multiple second entities. In some embodiments, once the relationships have been connected with each other, stored videos, audio, photographs, specifications, quotes, etc., can be exchanged between the first entity and second entities. In other embodiments, the computer system receives a combinatorial query from the issuer entity. The combinatorial query references interactions by the particular second entity with the multimedia content. Sending the direct message to the particular second entity is performed responsive to receiving the combinatorial query.

In some embodiments, the computer system determines a metric quantifying social media engagement, communication network activity, a trading volume, and a stock value associated with the particular second entity. Determining the metric is illustrated and described in more detail with reference to FIG. 5. Sending the direct message to the particular second entity is based on the metric. In some embodiments, the computer system determines a multidimensional correlation between the metric and interactions by the particular second entity with the multimedia content. Determining the multidimensional correlation is illustrated and described in more detail with reference to FIG. 5. Sending the direct message to the particular second entity is further based on the multidimensional correlation. In some embodiments, determining the metric includes triangulating between the social media engagement, the communication network activity, the trading volume, and the stock value. For example, the social media engagement includes at least one of a social sentiment application programming interface (API) feed or a social sentiment indicator. The communication network activity includes at least one of instant messaging activity, instant messaging frequency, or a chat room population.

In some embodiments, the computer system mines the Internet to aggregate changes in social media engagement, communication network activity, trading volume, and a stock value associated with the particular second entity. Mining the Internet is illustrated and described in more detail with reference to FIG. 5. Sending the direct message to the particular second entity is based on the changes. In other embodiments, the computer system mines analytics websites using a machine learning module to identify a change in a rating of the particular second entity. Sending the direct message is based on the change in the rating.

Responsive to sending the direct message, the computer system performs (1320) a transaction between the first entity and the particular second entity of the multiple second entities. Performing the transaction includes exchanging data and remuneration related to the data between the first node and the particular second node of the multiple second nodes. In some embodiments, commercial transactions are performed in a “walled garden” of the hierarchically indexed multimedia database platform. A walled garden refers to a closed platform or closed ecosystem, in which the service provider has control over applications, content, and/or media, and restricts access to non-approved applicants or content. For example, issuer entities can conduct transactions with their suppliers and customers on the closed platform utilizing wire transfers, automatic clearing house (ACH), electronic checking, Apple Pay, Zelle, cash apps, Venmo, a payment gateway company, or the native payment interface provided by the closed platform. In some embodiments, the platform charges a subscription fee for the node-to-node commerce function or a per-transaction fee. In other embodiments, the platform charges a subscription fee for the node-to-node direct messaging communications and then a per-transaction fee for transactions conducted on the platform.

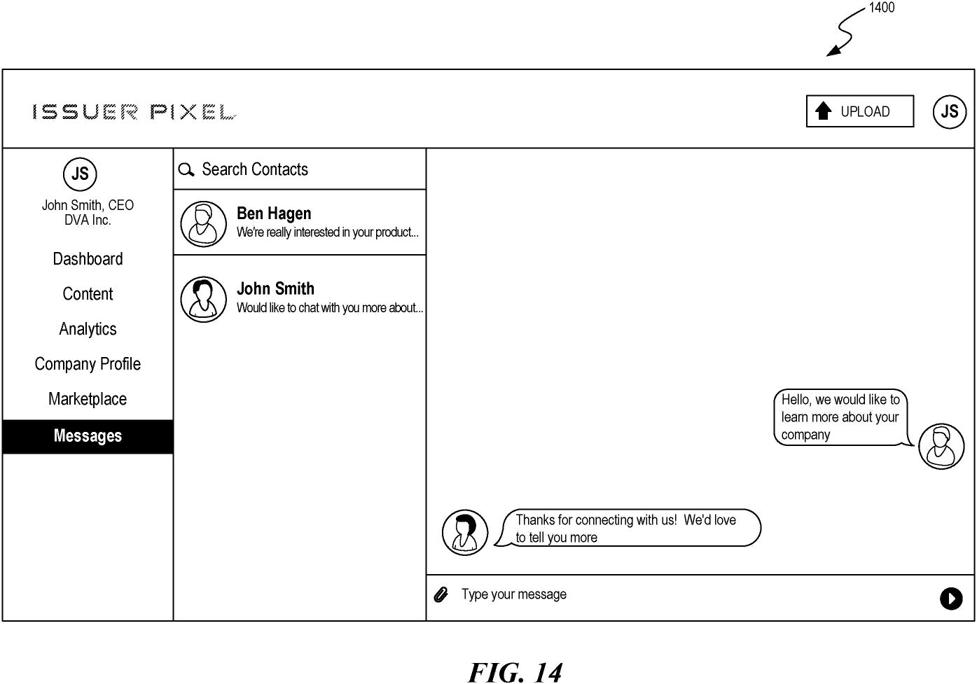

FIG. 14 is a drawing illustrating example node-to-node direct messaging within a self-building hierarchically indexed multimedia database, in accordance with one or more embodiments. The graphical user interface 1400 is used within the hierarchically indexed multimedia database 206, illustrated and described in more detail with reference to FIG. 2. In some embodiments, the node-to-node direct messaging is performed by a computer system, e.g., the example computer system 1000 illustrated and described in more detail with reference to FIG. 10. Particular entities, for example, the hierarchically indexed multimedia database 206 or a host service perform some or all of the node-to-node direct messaging in other embodiments. The host service is the same as or similar to the host service 524 illustrated and described in more detail with reference to FIG. 5.

The computer system sends node-to-node direct messaging from a first entity to a particular second entity, as illustrated and described in more detail with reference to FIG. 13. The direct messaging references the multimedia content stored at a first node. The direct message is transmitted from the first node to a particular second node. The particular second node is associated with the particular second entity. In some embodiments, once the relationships have been connected with each other, stored videos, audio, photographs, specifications, quotes, etc., can be exchanged between the first entity and second entities.

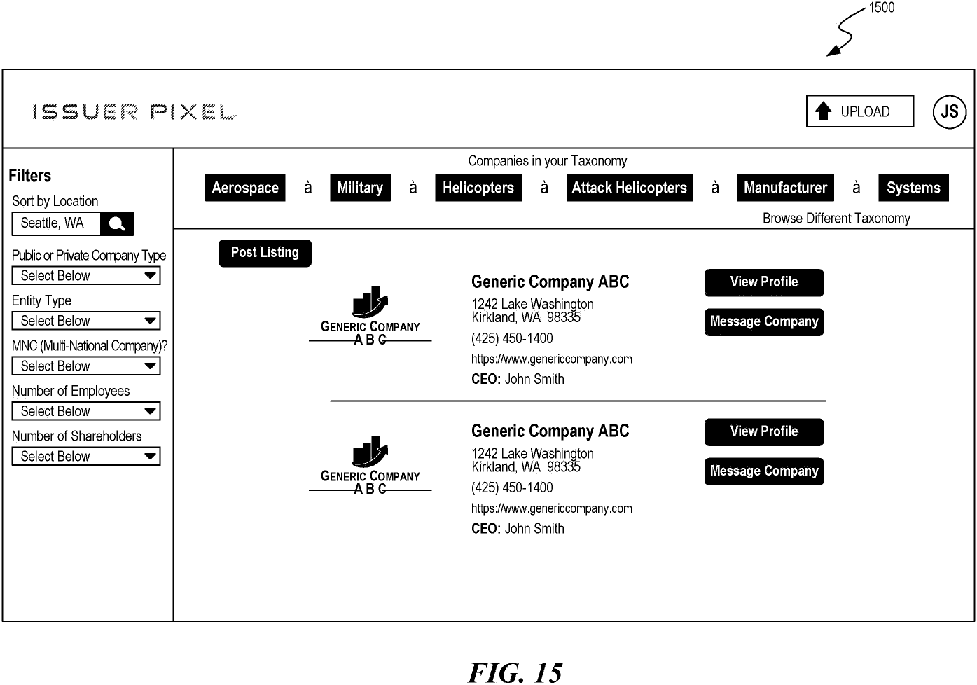

FIG. 15 is a drawing illustrating example node-to-node transactions performed across a self-building hierarchically indexed multimedia database, in accordance with one or more embodiments. The node-to-node transactions are performed using the user interface 1500 within the hierarchically indexed multimedia database 206, illustrated and described in more detail with reference to FIG. 2. In some embodiments, the node-to-node transactions are performed by a computer system, e.g., the example computer system 1000 illustrated and described in more detail with reference to FIG. 10. Particular entities, for example, the hierarchically indexed multimedia database 206 or a host service perform some or all of the node-to-node transactions in other embodiments. The host service is the same as or similar to the host service 524 illustrated and described in more detail with reference to FIG. 5. For example, the computer system performs a transaction between a first entity and a particular second entity.

Performing the transactions includes exchanging data and remuneration related to the data between a first node and a particular second node. In some embodiments, commercial transactions are performed in a “walled garden” of the hierarchically indexed multimedia database platform. A walled garden refers to a closed platform or closed ecosystem, in which the service provider has control over applications, content, and/or media, and restricts access to non-approved applicants or content. For example, issuer entities can conduct transactions with their suppliers and customers on the closed platform utilizing wire transfers, automatic clearing house (ACH), electronic checking, Apple Pay, Zelle, cash apps, Venmo, a payment gateway company, or the native payment interface provided by the closed platform. In some embodiments, the platform charges a subscription fee for the node-to-node commerce function or a per-transaction fee. In other embodiments, the platform charges a subscription fee for the node-to-node direct messaging communications and then a per-transaction fee for transactions conducted on the platform.

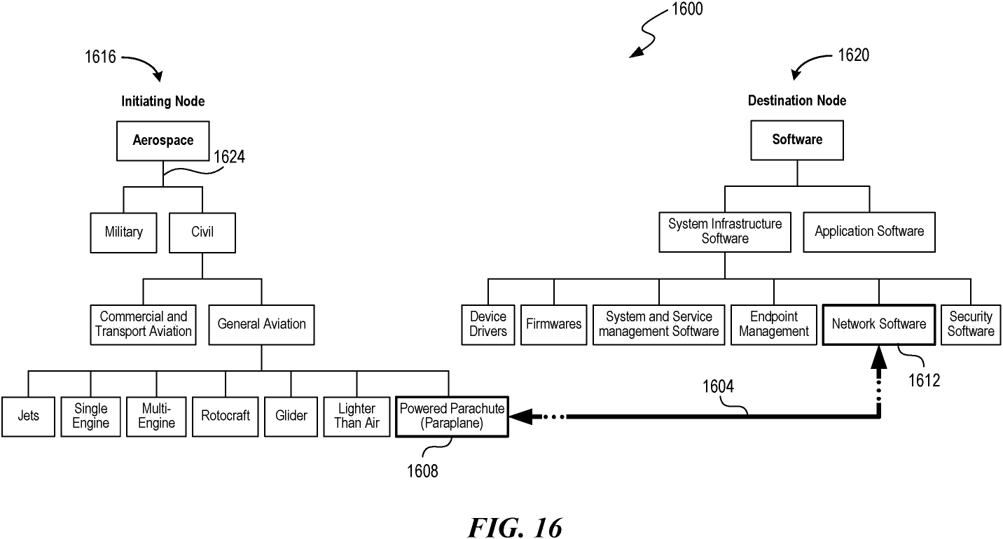

FIG. 16 is a block diagram illustrating example node-to-node direct messaging and transactions performed across a self-building hierarchically indexed multimedia database 1600, in accordance with one or more embodiments. The node-to-node direct messaging is performed using a user interface similar to or the same as the user interface 1400 illustrated and described in more detail with reference to FIG. 14. The hierarchically indexed multimedia database 1600 is the same as or similar to the hierarchically indexed multimedia database 206, illustrated and described in more detail with reference to FIG. 2. The node-to-node transactions are performed using a user interface similar to or the same as the user interface 1500 illustrated and described in more detail with reference to FIG. 15. In some embodiments, the direct messaging and the node-to-node transactions are performed by a computer system, e.g., the example computer system 1000 illustrated and described in more detail with reference to FIG. 10. Particular entities, for example, the hierarchically indexed multimedia database 1600 or a host service perform some or all of the node-to-node transactions in other embodiments. The host service is the same as or similar to the host service 524 illustrated and described in more detail with reference to FIG. 5.

The computer system receives information from a first entity, e.g. a company making powered parachutes. The information specifies multiple second entities communicably coupled to the first entity, wherein the first entity is an issuer entity and each second entity of the multiple second entities is at least one of a customer, a partner, a supplier, or an investor of the issuer entity. The computer system traverses the hierarchically indexed multimedia database 1600. The database 1600 includes multiple branches (e.g., branch 1624) categorizing multiple industries. The multiple branches support a first node 1608 associated with the first entity and store multimedia content associated with the first entity. The traversing is based on the information. The first node is part of a tree 1616 of nodes of the database 1600.

The computer system identifies multiple second nodes 1620 of the hierarchically indexed multimedia database 1600. The multiple second nodes 1620 are supported by the multiple branches. Each second node of the multiple second nodes 1620 is associated with a respective second entity (e.g., a company making application software) of the multiple second entities.

The computer system sends a direct message from the first entity (e.g., the company making powered parachutes) to a particular second entity (e.g., a company making network software) of the multiple second entities. The direct message references the multimedia content stored at the first node 1608 and is transmitted from the first node 1608 to a particular second node 1612 of the multiple second nodes 1620. The particular second node 1612 is associated with the particular second entity (e.g., the company making network software) of the multiple second entities. The direct message is sent on a communications channel 1604 that is opened for the transmission and is within the walled garden of the platform of the hierarchically indexed multimedia database 1600.

Responsive to sending the direct message, the computer system performs a transaction on the communications channel 1604 between the first entity (e.g., the company making powered parachutes) and the particular second entity (e.g., the company making network software) of the multiple second entities. Performing the transaction includes exchanging data and remuneration related to the data between the first node 1608 and the particular second node 1612 of the multiple second nodes 1620.

In alternative embodiments, a computer system receives a request to modify a node of a hierarchically indexed multimedia database categorizing multiple issuer entities. The request is received from an investor entity or an issuer entity of the multiple issuer entities. The hierarchically indexed multimedia database includes at least one branch associated with a respective industry and supports a node tree including the node. The computer system extracts features indicative of a priority of the request. The features are extracted from the request, other requests received to modify the node, and a structure of the hierarchically indexed multimedia database. The computer system determines the priority of the request based on the features using a machine learning module trained based on the structure of the hierarchically indexed multimedia database and the other requests. The computer system partitions the request within the other requests based on the priority. The computer system modifies the node tree with respect to the structure of the hierarchically indexed multimedia database, such that the request to modify the node is satisfied. The computer system transmits a response to the investor entity or the issuer entity of the multiple issuer entities. The response indicates that the request to modify the node is satisfied.

In some embodiments, the features include a position of the node in the structure of the hierarchically indexed multimedia database.

In some embodiments, a computer system receives issuer profile questionnaires describing multiple issuer entities. The computer system generates a hierarchically indexed multimedia database categorizing the multiple issuer entities based on the issuer profile questionnaires. The hierarchically indexed multimedia database includes at least one branch associated with a respective industry and supports at least one node. The at least one node references at least one issuer entity of the multiple issuer entities. The computer system extracts metadata using a machine learning module from multimedia content received from the at least one issuer entity. The metadata is indicative of the respective industry. The computer system identifies the at least one node using the machine learning module based on the metadata. The machine learning module is trained based on a structure of the hierarchically indexed multimedia database. The computer system stores the multimedia content at the at least one node, such that the multimedia content is associated with the respective industry and the at least one issuer entity. The computer system aggregates interactions of at least one investor entity with the multimedia content stored at the at least one node into investor activity formatted in accordance with the structure of the hierarchically indexed multimedia database. The computer system transmits the investor activity to the at least one issuer entity.

In some embodiments, the computer system receives a combinatorial query, from the at least one issuer entity, referencing the interactions with the multimedia content stored at the at least one node. Transmitting the investor activity to the at least one issuer entity is performed responsive to receiving the combinatorial query.

In some embodiments, a computer system receives multimedia content from a particular issuer entity of multiple issuer entities categorized by a hierarchically indexed multimedia database stored by a multimedia content host. The hierarchically indexed multimedia database includes at least one node referencing the particular issuer entity. The computer system mines analytics websites using a machine learning module to identify a change in a rating of the particular issuer entity. The rating is provided by the analytics websites for the multiple issuer entities. The computer system traverses the hierarchically indexed multimedia database using the machine learning module based on the multimedia content to identify the at least one node. The computer system transmits the multimedia content and the change in the rating of the particular issuer entity to the multimedia content host for storage at the at least one node. The computer system receives a URL from the multimedia content host referencing the multimedia content and the change in the rating stored at the at least one node. The computer system receives a combinatorial query from an investor entity requesting the multimedia content. Responsive to receiving the query, the computer system displays the multimedia content and the change in the rating of the particular issuer entity using the URL on a graphical user interface.

In some embodiments, a computer system determines a first metric quantifying user engagement with multimedia content stored at a node of a hierarchically indexed multimedia database. The multimedia content and the node are each associated with an issuer entity of multiple issuer entities. The hierarchically indexed multimedia database categorizes the multiple issuer entities. The computer system determines a second metric quantifying social media engagement, communication network activity, a trading volume, and a stock value associated with the issuer entity. The computer system determines a multidimensional correlation of the first metric to the second metric. The computer system ranks the issuer entity among the multiple issuer entities based on the multidimensional correlation. The computer system updates the node to include data describing a rank of the issuer entity among the multiple issuer entities based on the ranking. The computer system receives a combinatorial query from an investor entity referencing the node. The computer system transmits the rank of the issuer entity among the multiple issuer entities to the investor entity in response to the combinatorial query.

In some embodiments, the computer system mines the Internet to aggregate changes in the social media engagement, the communication network activity, the trading volume, and the stock value associated with the first issuer entity. Determining the second metric is based on the changes.

In some embodiments, determining the second metric includes triangulating between the social media engagement, the communication network activity, the trading volume, and the stock value associated with the first issuer entity.

In some embodiments, the social media engagement includes at least one of a social sentiment API feed or a social sentiment indicator.

In some embodiments, the communication network activity includes at least one of instant messaging activity, instant messaging frequency, or a chat room population.

In some embodiments, prior to determining the first metric, the computer system instantiates a node in the hierarchically indexed multimedia database based on the combinatorial query. The node is associated with the issuer entity. The computer system stores the multimedia content at the node.

In some embodiments, a computer system mines the Internet for multimedia content associated with multiple industries using a machine learning model trained using features indicative of at least a particular industry of the multiple industries. The multiple industries are categorized by a hierarchically indexed multimedia database including multiple branches including a particular branch associated with the particular industry. The computer system clusters the multimedia content among multiple issuer entities of the particular industry using deep learning. The deep learning is configured to determine a relationship from the multimedia content between each issuer entity of the multiple issuer entities and each other issuer entity of the multiple issuer entities. The computer system generates a node tree structured in accordance with the relationship between each issuer entity of the multiple issuer entities and each other issuer entity of the multiple issuer entities. Each node of the node tree is associated with a respective issuer entity of the multiple issuer entities. The computer system incorporates the node tree within the hierarchically indexed multimedia database, such that the node tree is supported by the particular branch. Responsive to receiving a combinatorial query from an investor entity referencing the particular industry, the computer system generates a graphical user interface displaying the node tree to the investor entity.

In some embodiments, the particular branch is a first branch and the particular industry is a first industry. The method further includes determining, by the computer system, that video or audio stored on the first branch of the hierarchically indexed multimedia database mismatches the first industry. The computer system transfers the video or audio to a second branch of the hierarchically indexed multimedia database. The video or audio matches a second industry associated with the second branch.

### Organizing Unstructured and Structured Data by Node

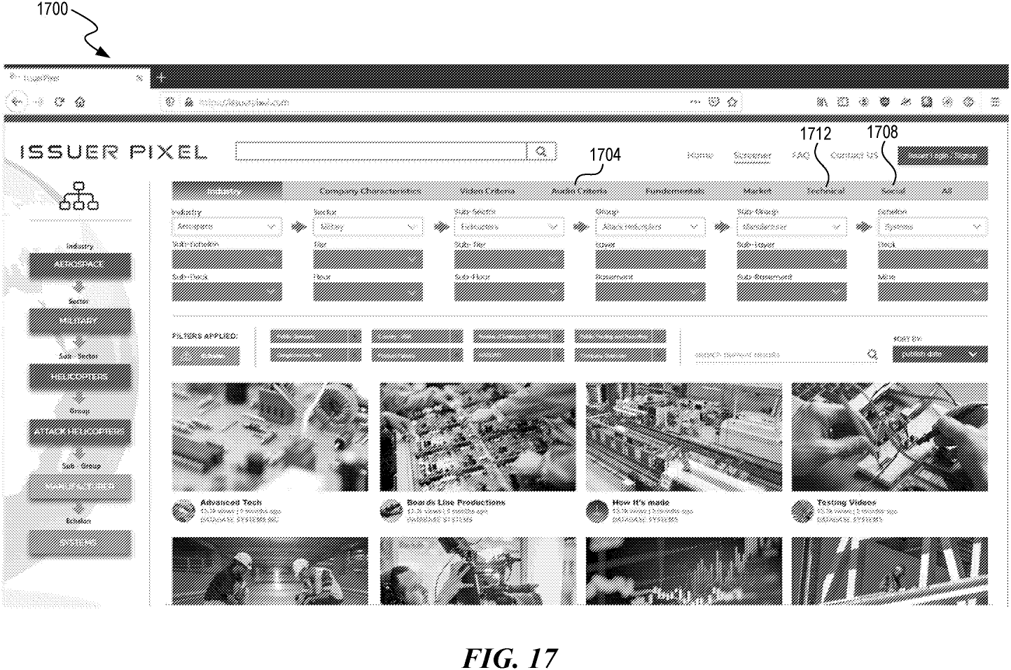

In some embodiments, a computer system organizes unstructured and structured data by node and performs multiple operations by node using communication and collaboration in a self-building hierarchically indexed multimedia database. The organization of the unstructured and structured data by node and performance of the multiple operations by node using communication and collaboration in a self-building hierarchically indexed multimedia database is illustrated and described in more detail with reference to FIGS. 17-25.

FIG. 17 is a drawing illustrating an example of organizing unstructured and structured data by node using communication and collaboration in a self-building hierarchically indexed multimedia database 1700, in accordance with one or more embodiments.

In embodiments, a self-building hierarchically indexed multimedia database 1700, such as a product and service-hierarchy databases includes multiple branches and multiple trees of nodes. The database hierarchically organizes video-by-node, audio-by-node, and documents-by-node. The documents can be architectural plans, investor presentations, technical specifications, product or service guides, market research reports), news, messages, industry information, regulatory status, licensing, blogs, etc. In some embodiments, the database disclosed organizes and tracks company market performance-by-node and stock investment information-by-node for issuers and inventors based on the products and services produced and offered by each competitor. In some embodiments, the databases disclosed organize and track podcasts-by-node, messages-by-node, text, voice messages-by-node, and voice calls-by-node.

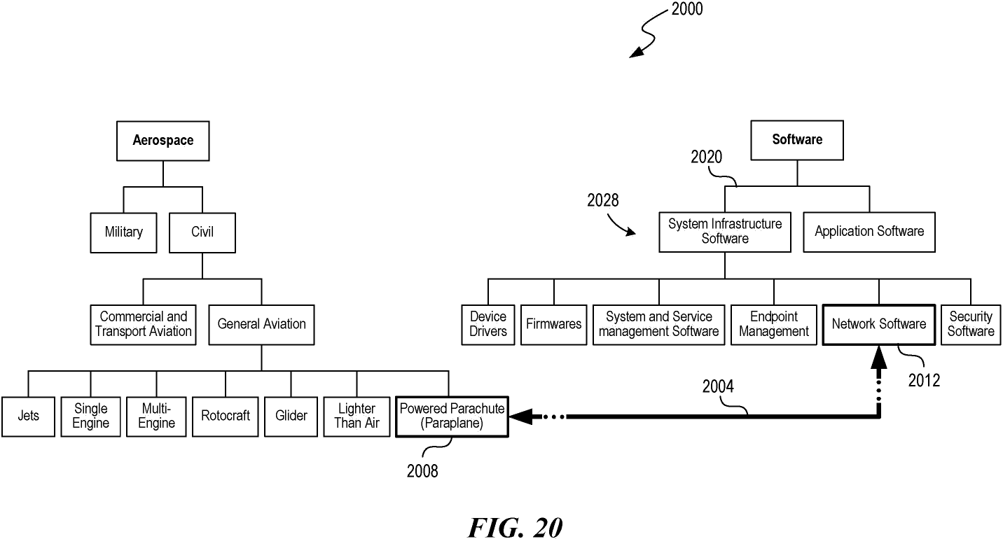

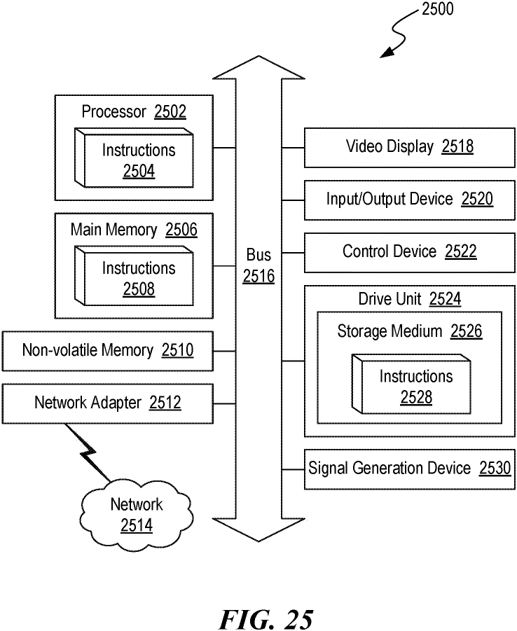

In embodiments, a computer system receives a request at a first node “Aerospace” of the hierarchically indexed multimedia database 1700. An example computer system 2500 is illustrated and described in more detail with reference to FIG. 25. An example first node 2008 is illustrated and described in more detail with reference to FIG. 20.

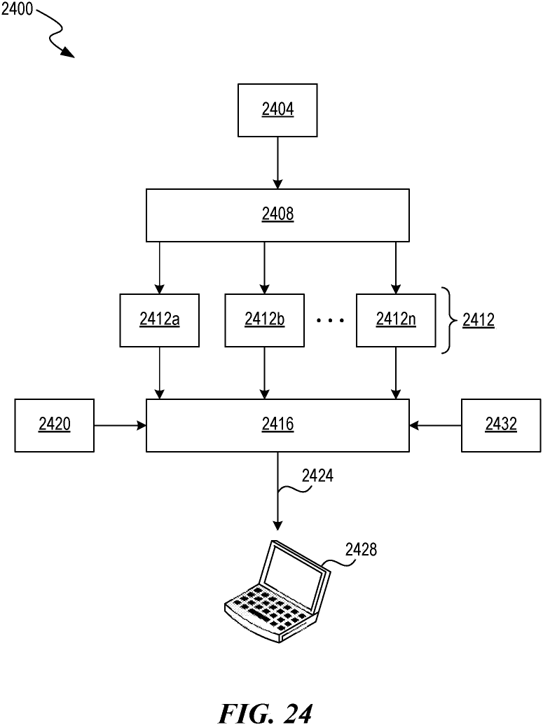

The request is for performing a node-to-node action involving the first node and a second node of the hierarchically indexed multimedia database. An example second node 2012 is illustrated and described in more detail with reference to FIG. 20. For example, the request indicates a search for digital content posted by the second node. Performing the node-to-node action includes searching, using a machine learning module, the digital content based on social media engagement 1708 performed at the first node. Audio criteria 1704 can be used to perform the search. An example machine learning model 2416 and example machine learning system 2400 are illustrated and described in more detail with reference to FIG. 24.

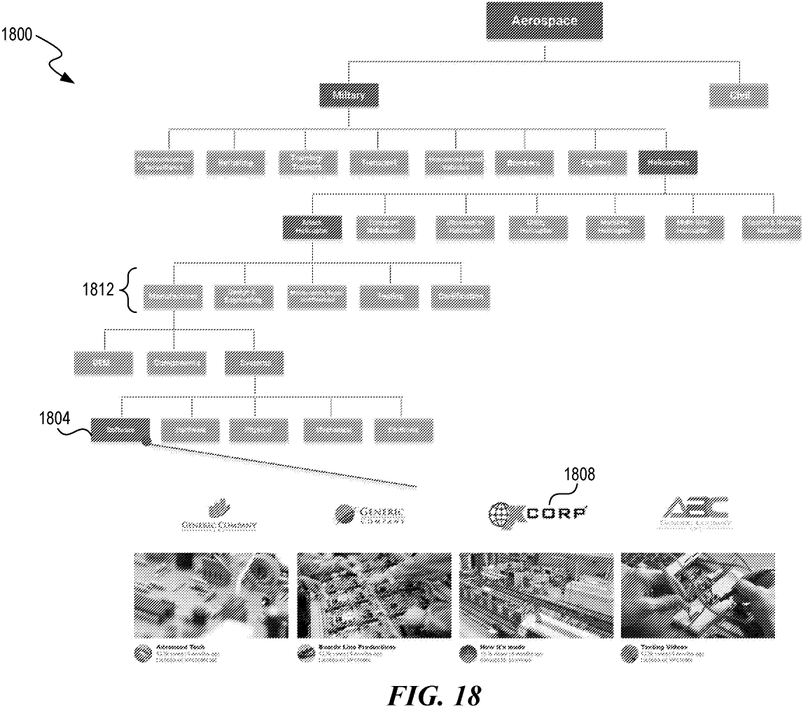

In some embodiments, video recording and audio recording by node is performed. For example, a computer system traverses the industry hierarchy and accesses video / audio by node, and submissions within industry (e.g., video/audio only within “22 nm, 7 nm node” or “aerospace → helicopters” node). In some embodiments, performing a per-node action includes generating a comparison between first technical indicators 1712 for a first industry associated with the first node (“Aerospace”) and second technical indicators for a second industry associated with the second node. The comparison is sent to at least one issuer entity or investor entity. An example issuer entity or investor entity 1808 is illustrated and described in more detail with reference to FIG. 18.

In some embodiments, the computer system organizes creates a newsfeed-per-node (e.g., “Aerospace”) for unstructured and structured data using communication and collaboration in the self-building hierarchically indexed multimedia database 1700. The newsfeed refers to the regular updating list of stories in the middle of a home page. For example, the news feed (newsfeed) can be a list of newly published content on a website. End users can receive push updates for new content on a site by subscribing to the site’s news feed. The feeds are designed to be machine-readable such that they can transfer information from one computer to another without human intervention. Browser plug-ins, client-side applications called readers or application program interfaces (APIs) translate the code into human-readable text. Typically, each item in a news feed consists of a headline that links to the actual content and a brief summary.

The newsfeeds generated using the embodiments described herein are useful for aggregating Web content by topic, author, or website. Instead of visiting multiple Web pages to check for new content, a user can look at the summaries and choose which links to follow for the full versions. There are two popular formats for creating news feeds: Atom and RSS. The news items can be organic, which means they are user generated, or they can be sponsored, which means a client has paid to have the content included in the newsfeed.

In some embodiments, a newsfeed includes status updates, photos, videos, links, app activity and likes from people, or pages and groups followed. For example, industry specific news-per-node is valuable to users of the self-building hierarchically indexed multimedia database 1700. In some embodiments, industry-specific news sources and industry-specific news is attached to different places on the self-building hierarchically indexed multimedia database 1700, e.g., on each company’s profile according to their industry. In other embodiments, the industry-specific news is attached to the appropriate node (e.g., “Military,” industry, sector, or subsector). In yet other embodiments, a company’s newsfeed is attached to the appropriate node.

In some embodiments, an archival per-node (e.g., news-by-node) function is performed (e.g., creation of a historical database of news-by-node) as well as real time news by node. Archiving of news content a node is able to gather is performed, with each piece of content (article, image, etc.) organized by node. In other embodiments, the computer system stores and generates personalized news-by-node, which is a daily updated feed of, e.g., 10-20 articles, the system displays to a user based on their nodes, location, and any other factors determined to be helpful. Both of these features are enables by the database 1700’s ability to match a piece of news content to a node.

In some embodiments, matching news articles to nodes is performed. Organizing news-by-node can be based on factors including node names, ancestor node names, and industry name. The computer system searches an article for any references to an industry name and bottom-most node names (lowest level), e.g., “Systems.” If no references to an industry’s bottom-most nodes are found in the article, then the system traverses up one level in the node tree and search for all those (2nd level from the bottom-one node up from lowest node level), e.g., “Manufacturer.” If no references are found, the computer system continues moving up the industry tree, level by level. The computer system continues doing this even when references are found, and keeps track of whatever node names are found referenced in that article. The system can then associate the article to those nodes.

In some embodiments, performing a node-to-node action includes weighting a relevance metric associated with the second node based on a number of times digital content for a particular industry was accessed at the second node. At the first node, multimedia content is retrieved based on the relevance metric associated with the second node. For example, methods of matching news articles to nodes can be refined further by implementing percent character matching overall, percent word matching, matching with node alternate names (percent character overall and percent word), number of relevant matches in same industry, number of relevant matches in same categorization level, number of relevant matches in same branch (direct ancestor or descendant nodes), key words associated to specific industries/nodes, key words to disregard or avoid (decreases relevance score) by node or industry, cross-indexed node relevance by the above characteristics, or a combination thereof. The methods listed herein of improving matching article to node can also be applied to more than just news articles, but also to other content such as social media posts, blog posts, files, images, transcriptions, etc.

In some embodiments, a request at a first node indicates a search for digital content posted by a second node. Performing a node-to-node action includes searching, using a machine learning module, the digital content based on social media engagement performed at the first node. For example, personalized news is generated per node. The personalized news can have several factors, which go into making a determination of what to show a user. The system can search for relevant articles based on (but not limited to) names of company members/executives, location, competitors, suppliers/vendors, company name, content (video/audio/files), names / description / transcriptions and other metadata, date, market metrics of relevant industries (e.g., bullish / bearish stock performance of related indexes or performance leaders, market metrics of cross-indexed nodes, social media trends of relevant nodes / industries, user’s previous search terms in the screener, previously contacted companies, previously clicked issuers / content when browsing for other issuers / content, previously searched/clicked news articles, time spent viewing content / articles, engagement with posts on social media made through our platform, source of the article/author, or a combination thereof. in some embodiments, archival news by node is used, e.g., machine learning is performed on relevance of the news to the user.

In some embodiments, the computer system determines user engagement or interest in different ways. The relevance metric is fed to an algorithm that adjusts how it weighs the importance of the above-listed variables. Weighted variables can be assigned a score based on quantifiable metrics such as number of clicks (how many times did a user click this article?), seconds spent viewing a piece of content, shares, etc. In addition to the above metrics, a “Was this article relevant to you?” or Like / Dislike function can be added, which enables users to provide direct feedback on the relevance of an article to them. Finally, users with similar profiles to the user are retrieved and articles they find relevant.

Different use cases that illustrate how to gather or use engagement metrics can be generated. In a first use case, a user visits their Issuer Dashboard and sees the personalized news feed on the Dashboard. They are shown ten articles, but only click one article of the ten. The computer system tracks which article was clicked on and marks that article as being more relevant to that user then the other nine articles, which can be used to inform the algorithm or administrators that the factors which were used to determine this article as being relevant enough to show are more accurate than the factors used to determine the other articles. For example, the article title contains a reference to the Issuer’s associated bottom-most node, and the other nine articles contain references only to the same industry. Thus, the bottom-most node name is more relevant than the industry name to users. In another example, a competitor’s name is contained in the header, and other articles contain the name of a vendor. The system learns about what variables users are most interested in seeing from news articles. These variables may be more relevant for some types of content (news articles) and less relevant for others (blog posts, videos, podcasts, etc.) which are of value.

In a second use case, a user clicks two articles from the personalized newsfeed, and spends 10 minutes viewing one article and one minute viewing another article. From these interactions, the computer system determines that the article with longer viewing time is more relevant to the user, and the variables used to recommend that article should therefore be weighed as more important in the future. In a third use case, a user views two articles but chooses to share only one article to their social media. In a fourth use case, a user views two articles, and then performs a search within the web application herein for an issuer or node name associated to one of the two articles. In a fifth use case, a user clicks one article out of ten, the one article is more recently published than any of the other articles. In a sixth use case, a user consistently clicks articles which comes from a specific source.

In some embodiments, the computer system attaches industry-specific news to the following places on the platform: (1) each company’s profile according to their industry; (2) the industry specific news to the appropriate node (industry, sector, subsector—wherever the news belongs); (3) the company’s newsfeed. For example, the system attaches the newsletters to the appropriate nodes and companies can opt in for their newsfeed.

In some embodiments, the computer system publishes articles-by-node for unstructured and structured data using communication and collaboration in the self-building hierarchically indexed multimedia database 1700. For example, the computer system can publish, post, search for, retrieve, and transmit industry trade associations by node, tradeshows by node, research reports by node, jobs by node, import/export data by node, or a combination thereof.

FIG. 18 is a drawing illustrating an example of organizing unstructured and structured data by node using communication and collaboration in a self-building hierarchically indexed multimedia database 1800, in accordance with one or more embodiments.

In some embodiments, the computer system generates a “Streamlist,” which is a playlist for video by node and audio by node that enables entities (e.g., entity 1808) and companies as well as front-end users to construct a Streamlist of companies to access and follow. An example Streamlist is shown at the bottom of FIG. 18. The Streamlist functionality enables companies, other entities, and front end users to construct multiple Streamlists and select their Streamlist company videos and audio. For example, video and audio can be selected, retrieved, and played back by company, any node (from lowest level node 1804 up to industry), subject type (e.g., “Military”), media Type, any data element on the self-building hierarchically indexed multimedia database 1800 that is searchable (e.g., ESG companies), or a combination thereof. In further embodiments, each Streamlist can be titled by the company/front-end User. For example, automatic population of playlists and videos/audio (which includes alerts) by node can be performed.

In some embodiments, automatic population of playlist videos or audio (which includes alerts) is performed. As a company in a user’s Streamlist (e.g., a user is another company or a front end user) produces and publishes a video to the platform, it then automatically populates to the appropriate Streamlist. For example, Intuitive Surgical^{R} publishes a new video with their DaVinci™ surgical robot. The computer system would populate to the user’s Streamlist (assuming the Streamlist was set up for Davinci™ or Davinci Surgical Robot™ or “Surgical Robots” or whatever the appropriate name/level of the node that was selected as one of the filters. In other embodiments, while the user (company or front end user) is setting up their own Streamlist(s), they can also move the videos/audio from one Streamlist to another with drag and drop capability, similar to the way a dating app allows a user to drag and drop a profile and ancillary photos in a priority of one’s choosing.

In some embodiments, performing a node-to-node action includes grouping employment categories referenced by the first and second nodes into groups of jobs 1812 based on shared characteristics. A taxonomic rank is assigned to each group. Groups of a particular rank are aggregated to generate a taxonomic hierarchy. The employment taxonomy is generated based on the taxonomic hierarchy. For example, investors can view company profiles, which contain granular characteristics of each company, as well as a list of video and audio content. In some embodiments, the computer system generates an employment taxonomy by node for unstructured and structured data using communication and collaboration in the self-building hierarchically indexed multimedia database 1800. The system performs automatic naming, defining (circumscribing), and classifying by node groups of jobs based on shared characteristics.

In an example, employment categories are grouped (e.g., group 1812), and these groups are given a taxonomic rank. Groups of a given rank can be aggregated to form a more inclusive group of higher rank, thus creating a taxonomic hierarchy. For example, analytical technology and the Linnaean system is used. In an example, “Employment Taxonomy: Software Developer → Machine Learning Programmer → Video Algorithm Engineer.” Using the taxonomy, the computer system attaches jobs to each node (similar to attaching video and audio to each node). Then, job searching can be performed with variable granularity. In an example, “Education Taxonomy: Education → Music → Saxophone → Tenor Saxophone.” The system can attach educational courses, lessons (i.e., music lessons), university courses/programs, by university, professors by node and even the world’s experts in a subject by node, etc. to each node (like how we attach video and audio to each node). Courses, university programs, lessons, professors and SME’s (subject matter experts), etc., can be searched by node with increasing granularity.

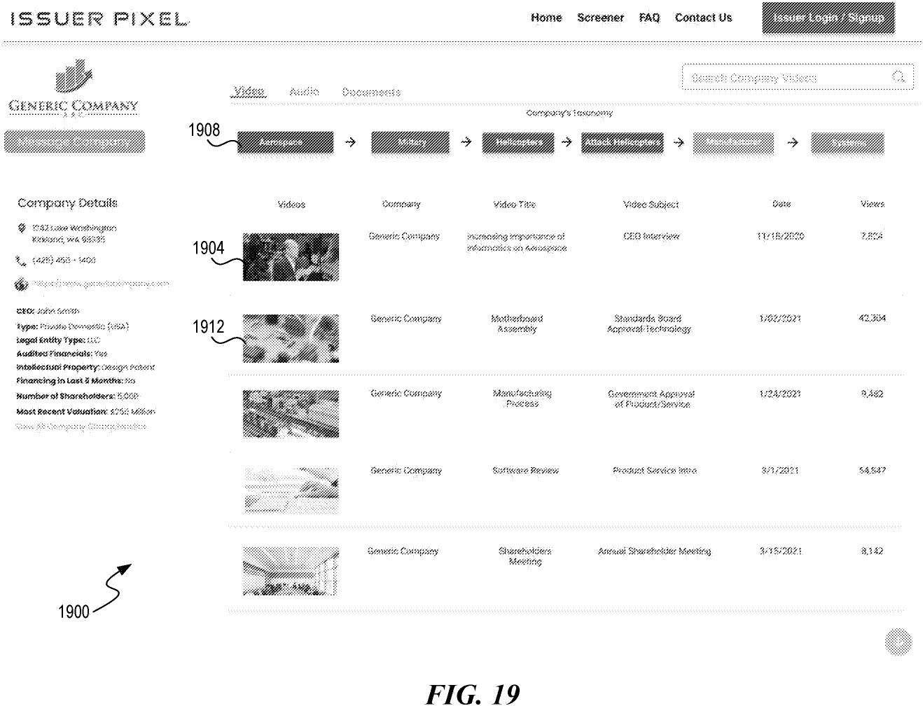

FIG. 19 is a drawing illustrating an example of organizing unstructured and structured data by node using communication and collaboration in a self-building hierarchically indexed multimedia database 1900, in accordance with one or more embodiments.

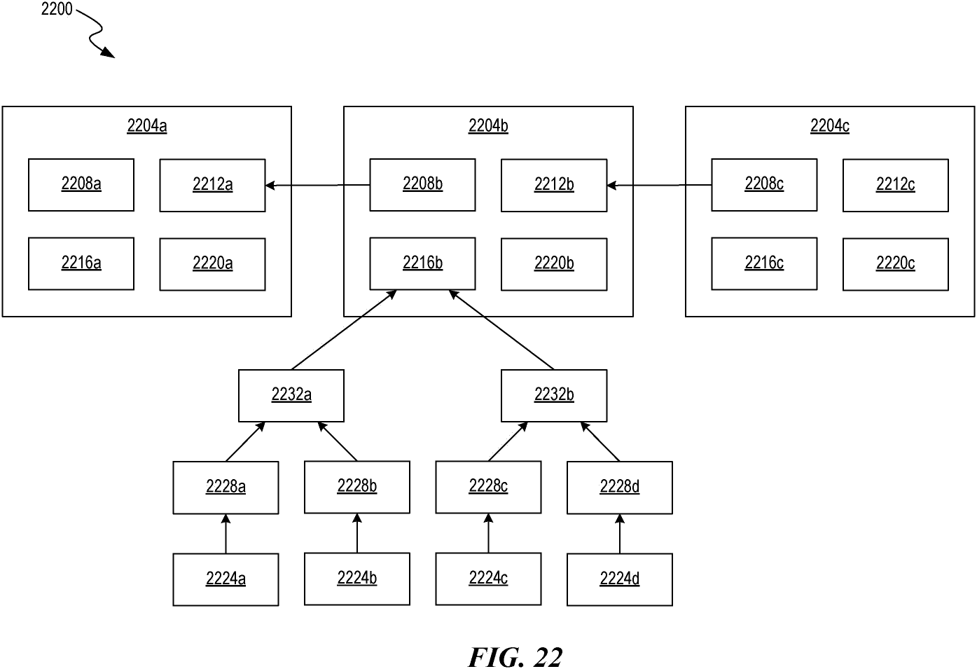

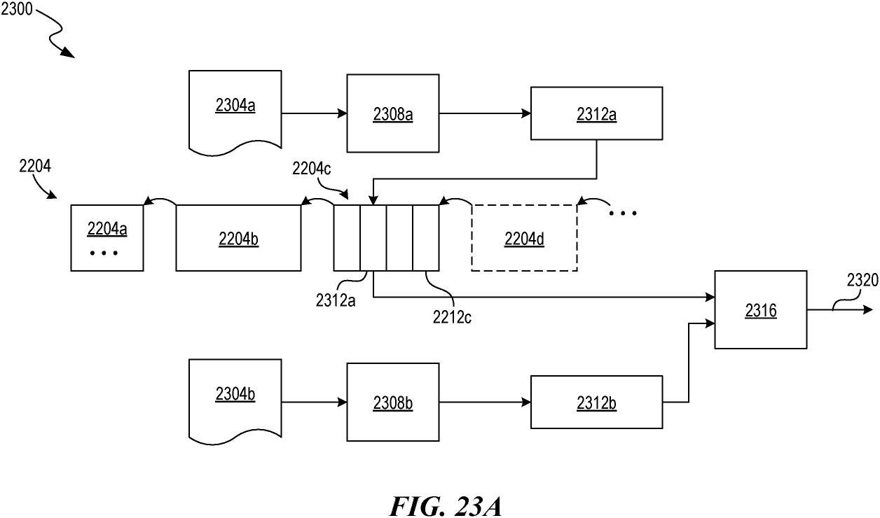

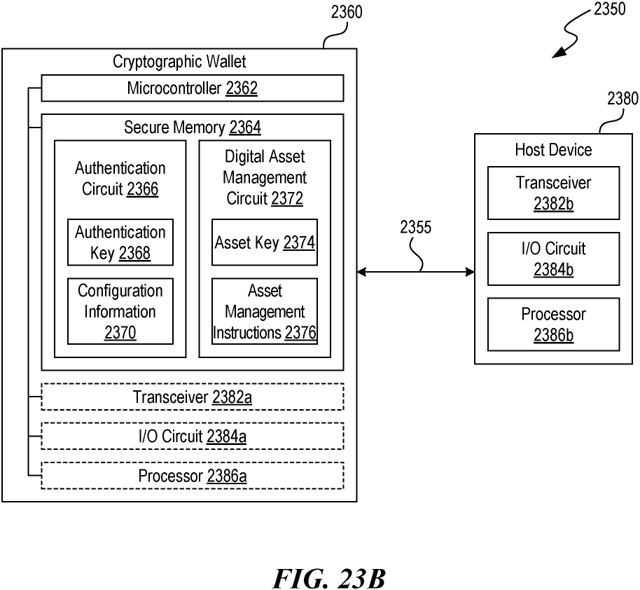

In some embodiments, performing a node-to-node action includes transferring ownership of a non-fungible token (NFT) from a first node 1908 to a second node. Example NFTs are illustrated and described in more detail with reference to FIG. 22-23A. The NFT is stored on a blockchain. An example blockchain 2204 is illustrated and described in more detail with reference to FIG. 22-23A. At least one cryptographic key referencing the NFT is sent from the first node 1908 to the second node to transfer the ownership. For example, the key can be stored in a crypto wallet. An example wallet is illustrated and described in more detail with reference to FIG. 23B.

In some embodiments, the computer system classifies NFTs by node for unstructured and structured data using communication and collaboration in the self-building hierarchically indexed multimedia database 1900. A non-fungible token is a unique and non-interchangeable unit of data stored on a digital ledger. NFTs can be used to represent easily-reproducible items such as photos, videos 1904, 1912, audio, and other types of digital files as unique items, and use blockchain technology to establish a verified and public proof of ownership. For example, an NFT identifies originality and copyright of video/audio on the hierarchical database by node. In some embodiments, the NFT can be linked to video/audio classified by node, news by node, broker-dealer research report by node, video/audio by node, NFT-enabled video by node, etc.

In some embodiments, methods for authenticating products, such as products from original manufacturers and/or resellers are supported. For example, the database 1900 provides a trusted and reliable mechanism for buyers and sellers to prove the authenticity of a product and for authenticators to establish an authentication that can be relied on during downstream transactions. In some embodiments, a blockchain-based product authentication system is provided that allows entities within a chain of commerce (e.g., suppliers, manufacturers, distributors, retails, consumers, consignors, resellers) to verify the authenticity of items by way of trusted authenticators and trusted audit processes. The product authentication system enables users to rely on product authentications via off-channel sales with the use of cryptography, blockchain, digital assets, and tagging hardware and software such as Near Field Communication (NFC) or other technologies that supports the need to define a digital twin of a physical product, non-fungible tokens (e.g., ERC721 non-fungible tokens), and so on. Thus, the product authentication system provides a product authentication service that reduces the amount of repeated or duplicated effort in authenticating products, thereby saving valuable resources required for performing such activities. The product authentication system provides a more transparent, efficient, and accessible solution that connects businesses and consumers.

In some embodiments, the product authentication system can be employed in a digital realm. For example, rather than (or in addition to) linking physical tags to physical products, the product authentication system can use non-fungible tokens associated with items that solely exist as virtual items, such as digital collectables issued by brands, generated from end users activating tags for physical products, and so on. In this manner, the product authentication system can be used to authenticate (and verify the authenticity of) virtual items, rather than relying on physical tags attached to physical items. For example, virtual items, such as virtual shirts, shoes, collectible trading cards, and so on, can be associated with non-fungible tokens and transactions involving those virtual items can be recorded in a secure, trusted tracking system, such as a distributed ledger. These virtual items may be used in various contexts, such as items acquired as part of a game, items worn by an avatar in a game or other virtual environment, and so on. Moreover, the system can act as a wallet or closet for users to store their digital items or collectibles, but they can also buy, sell, and trade the collectibles on a secondary marketplace.

In some cases, users can obtain virtual items through the purchase of drop boxes that include any number of virtual items or by purchasing or acquiring a corresponding physical item, such as a shirt for the user to wear and a corresponding virtual shirt for the user’s avatar to wear in a game or other virtual environment. Furthermore, the physical item may have an associated tag used for verifying ownership and authenticity of the physical item itself. In some examples, brands or companies generate digital non-fungible tokens that correspond to a specific virtual item and issue these non-fungible tokens as part of a drop box so that the exact virtual item (or items) is not visible at the time of purchase. As such, the user does not know which non-fungible token (and corresponding virtual item) they are purchasing. Furthermore, the product authentication system can provide a marketplace for users to search, buy, and sell their virtual items and to provide profile pages to see (or share) the items in their collection. In some cases, non-fungible tokens may be generated and exchanged or transferred using one or more smart contracts. For example, once a user opens a drop box and receives their virtual items, ownership of the virtual items can be transferred to the user and recorded in the blockchain or other secure, trusted tracking system and the user can then hold on to the virtual item, put the virtual item on sale in a virtual marketplace, transfer the virtual item to another user, and so on. If the item is purchased, the product authentication system and blockchain can be used to both verify the authenticity of the virtual item and verify that it is owned by the seller before it is transferred out of the current owner’s closet and into the new owner’s possession.

In some embodiments, the computer system displays advertisements by node for unstructured and structured data using communication and collaboration in the self-building hierarchically indexed multimedia database 1900. For example, a user can click on Aerospace → Military, and see all advertisements of device or procedure companies that have launched/released products on the subject of aerospace & military.

FIG. 20 is a block diagram illustrating an example of organizing unstructured and structured data by node using communication and collaboration in a self-building hierarchically indexed multimedia database 2000, in accordance with one or more embodiments.

In some embodiments, computer-implemented methods are used for performing a per-node operation. A computer system receives a request at a first node 2008 of the hierarchically indexed multimedia database 2000 categorizing at least one issuer entity or investor entity. The request is for performing a node-to-node action involving the first node 2008 and a second node 2012 of the hierarchically indexed multimedia database 2000. The request excludes a location of the second node in the hierarchically indexed multimedia database 2000.

From the request, features indicative of the location of the second node 2012 are extracted. Example feature extraction is illustrated and described in more detail with reference to FIG. 24. Using a machine learning module based on the features, a branch 2020 supporting a node tree 2028 of the hierarchically indexed multimedia database 2000 is located. The machine learning module is trained using other received requests involving the second node. The node tree 2028 includes the second node 2012. The node tree 2028 is traversed using a structure of the hierarchically indexed multimedia database 2000 to determine the location of the second node 2012.

The node-to-node action involving the first node 2008 and the second node 2012 is performed to satisfy the request. A response is sent to the at least one issuer entity or investor entity. An example issuer entity or investor entity 1808 is illustrated and described in more detail with reference to FIG. 18. The response indicates that the node-to-node action has been performed.

In some embodiments, performing the node-to-node action includes sending, at the first node 2008, a video of a website to the second node 2012. Responsive to receiving, from the second node 2012, an indication of receipt of the video, the computer system opens a communications channel 2004 between the first node 2008 and the second node 2012. For example, node-to-node video calls are performed. Business VoIP designed for small, medium, and large businesses can be used. In addition to voice and video calling, the service also has features such as call routing, Bring Your Own Device (BYOD), CRM sales enablement, and a host of other enterprise phone system features. In some embodiments, the VoIP platform offers basic voice and video calling in a web browser or on an app. In some embodiments, the database hierarchically organizes messaging-per-node. The service can also offer instant messaging, video conferencing, Direct Inbound Dialing (DID), phone number registration, calls to landline and mobile devices, SMS messaging, domestic and international calling, and cellular connectivity.

In some embodiments beyond initiating and receiving calls, the computer system routes, controls, and analyzes call traffic, and offers key features such as virtual receptionists, business hour rules, music on hold, customer queues, call recording, site-wide announcements, and dial-by-name directories. For example, the VoIP service can offer third party integrations with leading platforms to increase efficiency amongst employees, saving time and money in the process.

In some embodiments, the computer system performs VoIP-by-node. Voice over Internet Protocol, also called IP telephony, is a method and group of technologies for the delivery of voice communications and multimedia sessions over Internet Protocol networks, such as the Internet. The VoIP functionality can be performed as node based person to person, company to company, or one company to multiple companies and node to node communication and collaboration. for example, companies and users can contact each other, not only by messaging (DM) but by voice using VOIP.

In an example, an investor views a video (e.g., a webinar). The investor has a question for the Investor Relations Department. The investor can DM the Investor Relations Department. The investor and the IR department can start a “Voice Channel.” No email is needed. In another example, a company has a new development. The company wishes to canvass its lenders: the ones the company already knows and the ones the company doesn’t. The company finds the nodes with the banks that it wants to target. The company sends them a video of the site along with ancillary documentation (site plans, planning approval Notice of Final Action, etc.) The lenders in the appropriate node confirm receipt (or Issuer Pixel actually confirms receipt of documents sent within its “Walled Garden). The company then opens a line of communications with one lender at a time via the communications channel 2004. Alternatively, the company can open a channel with the lender, contractor, architect all at one time.

In some embodiments, the computer system performs e-mail integration by node for unstructured and structured data using communication and collaboration in the self-building hierarchically indexed multimedia database 2000. Email integrations are the tying together of systems, tools, and software for seamless processes around email marketing and communication. This feature enables companies and users to unite their email service provider with systems like their CRM or point-of-sale system for even more personalized, relevant, and efficient messages. For example, the Email Integration provides issuers the ability to integrate with their email providers such as MailChimp™, Active Campaign™, ZoHo™, etc., using Issuer Pixel™. By doing so, the users are enabled to share their video / audio content to their email lists via their email providers.

In some embodiments, email or contact lists enables issuers to upload their email or contact lists into the self-building hierarchically indexed multimedia database 2000 for advertising purposes. The computer system has a “profile matching” advertising module that will show the Issuers video / audio content to users / other issuers using AI / Machine learning advanced matching capabilities. In other embodiments, the Individual Node Contacts feature enables the self-building hierarchically indexed multimedia database 2000 to store individual contacts into the Issuer Pixels node tree 2028. Using machine learning / AI, questionnaires, etc., the computer system will be able to store individual contacts into a very specific category. In some embodiments, the computer system performs a “1 click share” function by node. This function gives a company on our platform, the ability to press 1 click of a button and share a Video, their corporate profile, or other information, by click of a button, to Facebook™ , Linkedln™, Twitter™, Instagram™, Reddit™, etc.

In some embodiments, the computer system performs money flow functions by node. For example, the system turns each node into an arithmetically, geometrically, and market cap weighted index that could be measured in terms of price performance and investment dollars (measured by calculations of Net shares purchased vs Sold (Buys-Sells) into each public company at a particular node level. In some embodiments, the system protects each node as a proprietary index consisting of the public companies at that node level and therefore in that index (arithmetically, geometrically and market cap weighted). In other embodiments, money Flow-by-Node functions (e.g., Net dollars = Net shares purchased vs. Sold (Buys-Sells) are performed.

Further, the system can perform Trading Volume-by-Node, Market Capitalization-by-Node, Technical Trading Indicators by Node (stochastics, moving averages, up volume vs. down volume, etc.,), Financial Ratios by Node (these include Liquidity ratios-by node, Leverage ratios by node, Efficiency ratios by node, Profitability ratios by node and Market value ratios-All of these by node), Financial Operating Metrics by-node (revenue-by-Node, Net Profit-by Node, Profit Margin-by Node, EBITDA Margin-by Node, loss-by-Node, or a combination thereof. For example, an investment banker or analyst (when we port a pricing feed and technical market data into the platform) could see for example that there is more positive money flow into field programmable gate arrays (node) within semiconductors than say computers; or More volume in the medical robotics node than the volume in any other areas of robotics; or the PE/Growth ratio of freight transport (trains) is lower (more compelling and less over-valued) than say the airlines. The advantages and benefits are to the entire buy-side and sell-side investment industry for institutions and individual investors and who knows who else because although the pricing data is commodity, the architecture makes it very valuable.

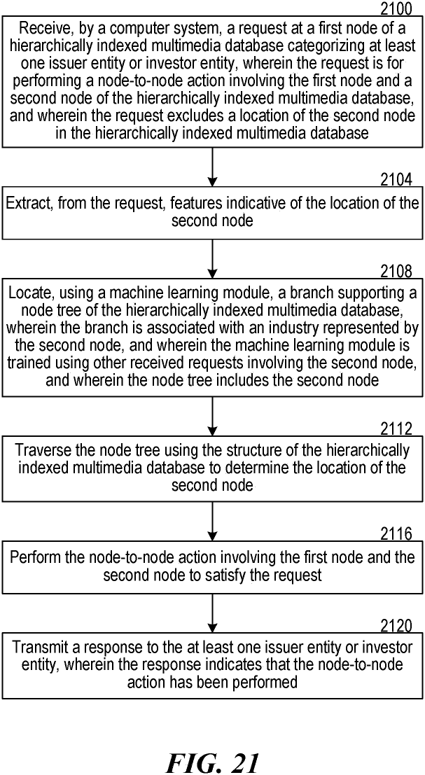

FIG. 21 is a flow diagram illustrating an example process 2100 for organizing unstructured and structured data by node in a hierarchical database, in accordance with one or more embodiments. An example hierarchically indexed multimedia database 206 is illustrated and described in more detail with reference to FIG. 2. In some embodiments, process 2100 is performed by a computer system, e.g., the example computer system 2500 illustrated and described in more detail with reference to FIG. 25. Particular entities, for example, hierarchically indexed multimedia database 206 or a host service perform some or all of the steps of the process in other embodiments. Likewise, embodiments may include different and/or additional steps, or perform the steps in different orders. An example host service 524 is illustrated and described in more detail with reference to FIG. 5.

At 2100, a computer system receives a request at a first node of a hierarchically indexed multimedia database categorizing at least one issuer entity or investor entity. An example database 2000 and example first node 2008 are illustrated and described in more detail with reference to FIG. 20. An example issuer entity or investor entity 1808 is illustrated and described in more detail with reference to FIG. 18. The request is for performing a node-to-node action involving the first node and a second node of the hierarchically indexed multimedia database. An example second node 2012 is illustrated and described in more detail with reference to FIG. 20. The request excludes a location of the second node in the hierarchically indexed multimedia database.

At 2104, the computer system extracts, from the request, features indicative of the location of the second node. Example features 2412 are illustrated and described in more detail with reference to FIG. 24.

At 2108, the computer system locates, using a machine learning module based on the features, a branch supporting a node tree of the hierarchically indexed multimedia database. An example machine learning model 2416 is illustrated and described in more detail with reference to FIG. 24. An example branch 2020 and example node tree 2028 are illustrated and described in more detail with reference to FIG. 20. The machine learning module is trained using other received requests involving the second node. The node tree includes the second node.

In some embodiments, the search engine implements machine learning. For example, the machine learning model is trained to perform search ranking using the other received requests. The search can use multiple phases of ranking that happen in series, such as initial retrieval, primary ranking, contextual ranking, or personalized ranking. Machine learning can be used for ranking at all these phases. In embodiments, the computer system performs query understanding to understand the search query typed by the user. For example, the machine learning model performs at least one of query classification or query expansion on the request. For query classification, the search runs various different classifiers on the search request, e.g., detecting navigational, informational, or transactional queries. In another example, news queries, local intent queries, or shopping queries are classified.

In some embodiments, the machine learning model performs spelling suggestion, correction, or synonyms or query expansion. For example, the search uses synonyms to expand the query keywords and expand the result set. The machine learning model can perform intent disambiguation on the request. For example, URL or document understanding can be performed to understand a URL, i.e., a search result. Page classification (e.g., understanding what types of a page it is) can be performed. In other implementations, the machine learning model classifies blogs, news sites, and forums. In other implementations, the machine learning model performs spam detection, junk or low-quality URL detection, sentiment analysis, or entity/relationship detection.

At 2112, the computer system traverses the node tree using a structure of the hierarchically indexed multimedia database to determine the location of the second node.

At 2116, the computer system performs the node-to-node action involving the first node and the second node to satisfy the request. An example node-to-node action is illustrated and described in more detail with reference to FIG. 20. In some embodiments, performing the node-to-node action includes sending, at the first node, a video of a website to the second node. Responsive to receiving, from the second node, an indication of receipt of the video, a voice over IP (VoIP) channel between the first node and the second node is opened.

At 2120, the computer system transmits a response to the at least one issuer entity or investor entity. The response indicates that the node-to-node action has been performed.

FIG. 22 is a block diagram illustrating an example structure including a portion of a blockchain 2200, in accordance with one or more embodiments. Blockchain system 2200 includes blockchain 2204. In embodiments, the blockchain 2204 is a distributed ledger of transactions (e.g., a continuously growing list of records, such as records of transactions for digital assets such as cryptocurrency, bitcoin, or electronic cash) that is maintained by a blockchain system 2200. For example, the blockchain 2204 is stored redundantly at multiple nodes (e.g., computers) of a blockchain network. Each node in the blockchain network can store a complete replica of the entire blockchain 2204. In some embodiments, the blockchain system 2200 implements storage of an identical blockchain at each node, even when nodes receive transactions in different orderings. The blockchain 2204 shown by FIG. 22 includes blocks 2204a, 2204b, 2204c. Likewise, embodiments of the blockchain system 2200 can include different and/or additional components or be connected in different ways.

The terms “blockchain” and “chain” are used interchangeably herein. In embodiments, the blockchain 2204 is a distributed database that is shared among the nodes of a computer network. As a database, the blockchain 2204 stores information electronically in a digital format. The blockchain 2204 can maintain a secure and decentralized record of transactions (e.g., transactions 2224a, 2224b). For example, the ERC-721 or ERC-1155 standards are used for maintaining a secure and decentralized record of transactions. The blockchain 2204 provides fidelity and security for the data record. In embodiments, blockchain 2204 collects information together in groups, known as “blocks” (e.g., blocks 2204a, 2204b) that hold sets of information.

The blockchain 2204 structures its data into chunks (blocks) (e.g., blocks 2204a, 2204b) that are strung together. Blocks (e.g., block 2204c) have certain storage capacities and, when filled, are closed and linked to a previously filled block (e.g., block 2204b), forming a chain of data known as the “blockchain.” New information that follows a freshly added block (e.g., block 2204b) is compiled into a newly formed block (e.g., block 2204c) that will then also be added to the blockchain 2204 once filled. The data structure inherently makes an irreversible timeline of data when implemented in a decentralized nature. When a block is filled, it becomes a part of this timeline of blocks. Each block (e.g., block 2204a) in the chain 2200 is given an exact timestamp (e.g., timestamp 2212a) when it is added to the chain 2200. In the example of FIG. 22, blockchain 2200 includes multiple blocks 2204a-c. Each of the blocks 2204a-c can represent one or multiple transactions and can include a cryptographic hash of the previous block (e.g., previous hashes 2208a-c), a timestamp (e.g., timestamps 2212a-c), a transactions root hash (e.g., 2216a-c), and a nonce (e.g., 2220a-c). A transactions root hash (e.g., transactions root hash 2216b) indicates the proof that the block 2204b contains all the transactions in the proper order. The transactions root hash 2216b proves the integrity of transactions in the block 2204b without presenting all transactions.

In embodiments, the timestamp 2212a-c of each of corresponding blocks 2204a-c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 2220a-c of each of corresponding blocks 2204a-c include any generated random or semi-random number. The nonce can be used by miners during proof of work (PoW), which refers to a form of adding new blocks of transactions to blockchain 2204. The work refers to generating a hash that matches the target hash for the current block. For example, a nonce is an arbitrary number that miners (e.g., devices that validate blocks) can change in order to modify a header hash and produce a hash that is less than or equal to the target hash value set by the network.

As described above, each of blocks 2204a, 2204b, 2204c of exemplary blockchain 2204 can include respective block hash 2216a, 2216b, 2216c. Each of block hashes 2216a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 22, block 2204b records transactions 2224a-d. Each of the leaf nodes 2228a-d contain a hash corresponding to transactions 2224a-d respectively. As described above, a hash (e.g., the hash in leaf node 2228a) can be a hash of components of a transaction (e.g., transaction 2224a), for example, a reference that identifies an output of a prior transaction that is input to the transaction 2224a, an attachment, and a command. Each of the non-leaf nodes 2232a, 2232b can contain a hash of the hashes of its child nodes (e.g., leaf nodes 2224a-b). In this example, node 2232a can contain a hash of the hashes contained in 2228a, 2228b and node 2232b can contain a hash of the hashes contained in 2228c, 2228d. The root node 2216b can contain a hash of the hashes of child nodes 2232a-b.

A Merkle tree representation of a transaction (e.g., 2224a) allows an entity needing access to the transaction 2224a to be provided with only a portion that includes the components that the entity needs. For example, if an entity needs only the transaction summary, the entity can be provided with the nodes (and each node’s sibling nodes) along the path from the root node to the node of the hash of the transaction summary. The entity can confirm that the transaction summary is that used in the transaction 2224a by generating a hash of the transaction summary and calculating the hashes of the nodes along the path to the root node. If the calculated hash of the root node matches the hash 2228a of the transaction 2224a, the transaction summary is confirmed as the one used in the transaction. Because only the portion of the Merkle tree relating to components that an entity needs is provided, the entity will not have access to other components. Thus, the confidentiality of the other components is not compromised.

In some examples, the blockchain 2200 is a bitcoin system developed to allow digital assets such as electronic cash to be transferred directly from one party to another without going through a central authority, such as financial institution (e.g., as described in the white paper entitled “Bitcoin: A Peer-to-Peer Electronic Cash System” by Satoshi Nakamoto, hereby incorporated by reference in its entirety). A bitcoin (an electronic coin) can be represented by a chain of transactions that transfers ownership from one party to another party.

To transfer ownership of a digital asset, such as a bitcoin, using the blockchain 2200, a new transaction, such as one of transactions 2224a-d, is generated and added to a stack of transactions in a block, e.g., block 2204b. To record a transaction in a blockchain, each party and asset involved with the transaction needs an account that is identified by a digital token. For example, when a first user wants to transfer an asset that the first user owns to a second user, the first and second user both create accounts, and the first user also creates an account that is uniquely identified by the asset’s identification number. The account for the asset identifies the first user as being the current owner of the asset. The first user (i.e., the current owner) creates a transaction (e.g., 2224a) against the account for the asset that indicates that the transaction 2224a is a transfer of ownership and outputs a token identifying the second user as the next owner and a token identifying the asset. The transaction 2224a is signed by the private key of the first user (i.e., the current owner), and the transaction 2224a is evidence that the second user is now the new current owner and that ownership has been transferred from the first to the second user.

The new transaction 2224a, which includes the public key of the new owner (e.g., a second user to whom a digital asset is assigned ownership in the transaction), is digitally signed by the first user with the first user’s private key to transfer ownership to the second user (e.g., new owner), as represented by the second user public key. The signing by the owner of the bitcoin is an authorization by the owner to transfer ownership of the bitcoin to the new owner via the new transaction 2224a. Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 2204 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain 2200 uses one or more smart contracts to enable more complex transactions. A smart contract includes computer code implementing transactions of a contract. The computer code can be executed on a secure platform (e.g., an Ethereum platform, which provides a virtual machine) that supports recording transactions (e.g., 2224a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 2224a in the blockchain 2204 using a token that is a hash 2228a of the computer code so that the computer code that is executed can be authenticated. When deployed, a constructor of the smart contract executes, initializing the smart contract and its state. The state of a smart contract is stored persistently in the blockchain 2204. When a transaction 2224a is recorded against a smart contract, a message is sent to the smart contract, and the computer code of the smart contract executes to implement the transaction (e.g., debit a certain amount from the balance of an account). The computer code ensures that all the terms of the contract are complied with before the transaction 2224a is recorded in the blockchain 2204.

For example, a smart contract can support the sale of an asset. The inputs to a smart contract to sell an asset can be tokens identifying the seller, the buyer, the asset, and the sale price in U.S. dollars or cryptocurrency. The computer code is used to ensure that the seller is the current owner of the asset and that the buyer has sufficient funds in their account. The computer code records a transaction (e.g., 2224a) that transfers the ownership of the asset to the buyer and a transaction (e.g., 2224b) that transfers the sale price from the buyer’s account to the seller’s account. If the seller’s account is in U.S. dollars and the buyer’s account is in Canadian dollars, the computer code can retrieve a currency exchange rate, determine how many Canadian dollars the seller’s account should be debited, and record the exchange rate. If either transaction 2224a, 2224b is not successful, neither transaction is recorded.

When a message is sent to a smart contract to record a transaction 2224a, the message is sent to each node that maintains a replica of the blockchain 2204. Each node executes the computer code of the smart contract to implement the transaction 2224a. For example, if a hundred nodes each maintain a replica of the blockchain 2204, the computer code executes at each of the hundred nodes. When a node completes execution of the computer code, the result of the transaction 2224a is recorded in the blockchain 2204. The nodes employ a consensus algorithm to decide which transactions (e.g., 2224c) to keep and which transactions (e.g., 2224d) to discard. Although the execution of the computer code at each node helps ensure the authenticity of the blockchain 2204, large amounts of computer resources are required to support such redundant execution of computer code.

Although blockchains can effectively store transactions 2224a-d, the large amount of computer resources, such as storage and computational power, needed to maintain all the replicas of the blockchain can be problematic. To overcome this problem, some systems for storing transactions 2224a-d do not use blockchains, but rather have each party to a transaction maintain its own copy of the transaction 2224a. One such system is the CordaTM system developed by R3TM that provides a decentralized distributed ledger platform in which each participant in the platform has a node (e.g., computer system) that maintains its portion of the distributed ledger.

When parties agree on the terms of a transaction 2224a, a party submits the transaction 2224a to a notary, which is a trusted node, for notarization. The notary maintains a consumed output database of transaction outputs that have been input into other transactions. When a transaction 2224a is received, the notary checks the inputs to the transaction 2224a against the consumed output database to ensure that the outputs that the inputs reference have not been spent. If the inputs have not been spent, the notary updates the consumed output database to indicate that the referenced outputs have been spent, notarizes the transaction 2224a (e.g., by signing the transaction or a transaction identifier with a private key of the notary), and sends the notarized transaction to the party that submitted the transaction 2224a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., 2224b), the non-validating notary determines that the prior output of a prior transaction (e.g., 2224a), that is, the input of the current transaction 2224b, has not been consumed. If the prior output has not been consumed, the non-validating notary notarizes the transaction 2224b by signing a hash 2228b of the transaction. To notarize a transaction 2224b, a non-validating notary needs only the identification of the prior output (e.g., the hash 2228a of the prior transaction 2224a and the index of the output) and the portion of the Merkle tree needed to calculate the hash 2228b of the transaction 2224b.

As described herein, in some embodiments, the blockchain 2200 uses one or more smart contracts to enable more complex transactions. For example, a validating notary validates a transaction (e.g., 2224d), which includes verifying that prior transactions 2224a-c in a backchain of transactions are valid. The backchain refers to the collection of prior transactions (e.g., 2224c) of a transaction 2224d, as well as prior transactions 2224a-b of those prior transactions 2224c, and so on. To validate a transaction 2224d, a validating notary invokes validation code of the transaction 2224d. In one example, a validating notary invokes validation code of a smart contract of the transaction 2224d. The validation code performs whatever checks are needed to comply with the terms applicable to the transaction 2224d. This checking may include retrieving the public key of the owner from the prior transaction 2224c (pointed to by the input state of the transaction 2224d) and checks the signature of the transaction 2224d, ensuring that the prior output of a prior transaction that is input has not been consumed, and checking the validity of each transaction (e.g., 2224c) in the backchain of the transactions. If the validation code indicates that the transaction 2224d is valid, the validating notary notarizes the transaction 2224d and records the output of the prior transaction 2224c as consumed.

In some examples, to verify that the transactions 2224a-d in a ledger stored at a node are correct, the blocks 2204a-c in the blockchain 2204 can be accessed from oldest 2204a to newest 2204c, generating a new hash of the block 2204c and comparing the new hash to the hash 2208c generated when the block 2204c was created. If the hashes are the same, then the transactions in the block are verified. In one example, the Bitcoin system also implements techniques to ensure that it would be infeasible to change a transaction 2224a and regenerate the blockchain 2204 by employing a computationally expensive technique to generate a nonce 2220b that is added to the block when it is created. A bitcoin ledger is sometimes referred to as an Unspent Transaction Output (“UTXO”) set because it tracks the output of all transactions that have not yet been spent.

FIG. 23A illustrates a process 2300 that uses a hash algorithm to generate a non-fungible token (NFT) or perform a cryptographic transaction on a blockchain. An exemplary blockchain 2204, e.g., as shown in FIG. 23, is also illustrated and described in detail with reference to FIG. 22. The process 2300 can be performed by a computer system such as that described with reference to FIG. 25 and/or by nodes of the blockchain 2204. Some embodiments include different and/or additional steps or perform steps in different orders.

In embodiments, a digital message, electronic art, a digital collectible, any other form of digital content, or a combination thereof 2304a may be hashed using hashing algorithm 2308a. The hashing algorithm 2308a (sometimes referred to as a “hash function”) may be a function used to map data of arbitrary size (e.g., content 2304a) to fixed-size values (e.g., hash 2312a). The values 2312a that are returned by the hash function 2308a can be called hash values, hash codes, digests, or hashes. The values 2312a can be used to index a fixed-size table called a hash table. A hash table, also known as a hash map, is a data structure that implements an associative array or dictionary, which is an abstract data type that maps keys (e.g., content 2304a) to values 2312a.

The output of the hashed content 2304a (e.g., hash 2312a) can be inserted into a block (e.g., block 2204c) of the blockchain 2204 (e.g., comprising blocks such as blocks 2204a-d). The block 2204c can include, among other things, information such as timestamp 2212c. In order to verify that the block 2204c is correct, a new hash 2312b is generated by applying hashing algorithm 2308b to the digital content 2304b. The new hash 2312b is compared to the hash 2312a in the blockchain 2204 at comparison step 2316. If the new hash 2312b is the same as the hash 2312a of the block 2204c, the comparison yields an indication that they match. For example, the decision 2320 can indicate that the hashes 2312a-b are the same or not. The hashes can be indicated to be the same if the characters of the hash match. The hashing algorithms 2308a-b can include any suitable hashing algorithm. Examples include Message Digest 5 (MD5), Secure Hashing Algorithm (SHA) and/or the likes.

Components of the process 2300 can generate or validate an NFT, which is a cryptographic asset that has a unique identification code and metadata that uniquely identifies the NFT. In one example, the digital content 2304a can be hashed and minted to generate an NFT, or the content 2304a can represent an NFT that is verified using the process 2300 and the content 2304b. An NFT can include digital data (e.g., 2312a) stored in the blockchain 2204. The ownership of an NFT (e.g., 2312a) is recorded in the blockchain 2204 and transferrable by an owner, allowing the NFT 2312a to be sold and traded. The NFT 2312a contains a reference to digital files such as photos, videos, or audio (e.g., content 2304a). Because NFTs are uniquely identifiable assets, they differ from cryptocurrencies, which are fungible. In particular, NFTs function like cryptographic tokens, but unlike cryptocurrencies such as Bitcoin or EthereumTM, NFTs are not mutually interchangeable, and so are not fungible.

The NFT can be associated with a particular digital or physical asset such as images, art, music, and sport highlights (e.g., content 2204a) and can confer licensing rights to use the asset 2204a for a specified purpose. As with other assets, NFTs are recorded on a blockchain when a blockchain 2204 concatenates records containing cryptographic hashes—sets of characters that identify a set of data—onto previous records, creating a chain of identifiable data blocks 2204a-d. A cryptographic transaction process enables authentication of each digital file by providing a digital signature that tracks NFT ownership. In embodiments, a data link that is part of the NFT records points to details about where the associated art (content 2204a) is stored.

Minting an NFT (e.g., 2312a) may refer to the process of turning a digital file (e.g., 2304a) into a crypto collectible or digital asset 2312a on blockchain 2204 (e.g., the EthereumTM blockchain). The digital item or file 2304a may be stored in the blockchain 2204 and may not be able to be edited, modified, or deleted. The process of uploading a specific item onto the blockchain 2204 is known as “minting.” For example, “NFT minting” can refer to a process by which a digital art or digital content 2304a becomes a part of the EthereumTM blockchain. Thus, the process turns digital content 2304a into a crypto asset 2312a, which is easily traded or bought with cryptocurrencies on a digital marketplace without an intermediary.

FIG. 23B is a block diagram illustrating an example cryptographic wallet 2360, in accordance with one or more embodiments. As a general overview, cryptographic wallet 2360 is an electronic entity that allows users to securely manage digital assets. According to various embodiments, the cryptographic wallet 2360 can be a hardware-based wallet (e.g., can include dedicated hardware component(s)), a software-based wallet, or a combination thereof. Example digital assets that can be stored and managed using the cryptographic wallet 2360 include digital coins, digital tokens, and/or the like. In some embodiments, tokens are stored on a blockchain system, such as the blockchain system 2200 described in FIG. 22. In some embodiments, the cryptographic wallet 2360 may be capable of connecting to and managing assets that are native to or associated with multiple, different blockchain systems 2200.

As defined herein , the terms “coin” and “token” refer to a digital representation of a particular asset, utility, ownership interest, and/or access right. Any suitable type of coin or token can be managed using various embodiments of the cryptographic wallet 2360. In some embodiments, tokens include cryptocurrency, such as exchange tokens and/or stablecoins. Exchange tokens and/or stablecoins can be native to a particular blockchain system 2200 and, in some instances, can be backed by a value-stable asset, such as fiat currency, precious metal, oil, or another commodity. In some embodiments, tokens are utility tokens that provide access to a product or service rendered by an operator of the blockchain system 2200 (e.g., a token issuer). In some embodiments, tokens are security tokens, which can be securitized cryptocurrencies that derive from a particular asset, such as bonds, stocks, real estate, and/or fiat currency, or a combination thereof, and can represent an ownership right in an asset or in a combination of assets.

In some embodiments, tokens are NFTs or other non-fungible digital certificates of ownership. In some embodiments, tokens are decentralized finance (DeFi) tokens. DeFi tokens can be used to access feature sets of DeFi software applications (dApps) built on the blockchain system 2200. Example dApps can include decentralized lending applications (e.g., Aave), decentralized cryptocurrency exchanges (e.g., Uniswap), decentralized NFT marketplaces (e.g., OpenSea, Rarible), decentralized gaming platforms (e.g., Upland), decentralized social media platforms (e.g., Steemit), decentralized music streaming platforms (e.g., Audius), and/or the like. In some embodiments, tokens provide access rights to various computing systems and can include authorization keys, authentication keys, passwords, PINs, biometric information, access keys, and other similar information. The computing systems to which the tokens provide access can be both on-chain (e.g., implemented as dApps on a particular blockchain system 2200) or off-chain (e.g., implemented as computer software on computing devices that are separate from the blockchain system 2200).

As shown, the cryptographic wallet 2360 of FIG. 23B is communicatively coupled to the host device 2380 (e.g., a mobile phone, a laptop, a tablet, a desktop computer, a wearable device, a point-of-sale (POS) terminal, an automated teller machine (ATM) and the like) via the communication link 2355. In some embodiments, the host device 2380 can extend the feature set available to the user of the cryptographic wallet 2360 when it is coupled to the host device 2380. For instance, the host device may provide the user with the ability to perform balance inquiries, convert tokens, access exchanges and/or marketplaces, perform transactions, access computing systems, and/or the like.

In some embodiments, the cryptographic wallet 2360 and the host device 2380 can be owned and/or operated by the same entity, user, or a group of users. For example, an individual owner of the cryptographic wallet 2360 may also operate a personal computing device that acts as a host device 2380 and provides enhanced user experience relative to the cryptographic wallet 2360 (e.g., by providing a user interface that includes graphical features, immersive reality experience, virtual reality experience, or similar). In some embodiments, the cryptographic wallet 2360 and the host device 2380 can be owned and/or operated by different entities, users and/or groups of users. For example, the host device 2380 can be a point-of-sale (POS) terminal at a merchant location, and the individual owner of the cryptographic wallet 2360 may use the cryptographic wallet 2360 as a method of payment for goods or services at the merchant location by communicatively coupling the two devices for a short period of time (e.g., via chip, via near-field communications (NFC), by scanning of a bar code, by causing the cryptographic wallet 2360 to generate and display a quick response (QR) code, and/or the like) to transmit payment information from the cryptographic wallet 2360 to the host device 2380.

The cryptographic wallet 2360 and the host device 2380 can be physically separate and/or capable of being removably coupled. The ability to physically and communicatively uncouple the cryptographic wallet 2360 from the host device 2380 and other devices enables the air-gapped cryptographic wallet 2360 to act as “cold” storage, where the stored digital assets are moved offline and become inaccessible to the host device 2380 and other devices. Further, the ability to physically and communicatively uncouple the cryptographic wallet 2360 from the host device 2380 allows the cryptographic wallet 260 to be implemented as a larger block of physical memory, which extends the storage capacity of the cryptographic wallet 2360, similar to a safety deposit box or vault at a brick-and-mortar facility.

Accordingly, in some embodiments, the cryptographic wallet 2360 and the host device 2380 are physically separate entities. In such embodiments, the communications link 2355 can include a computer network. For instance, the cryptographic wallet 2360 and the host device 2380 can be paired wirelessly via a short-range communications protocol (e.g., Bluetooth, ZigBee, infrared communication) or via another suitable network infrastructure. In some embodiments, the cryptographic wallet 2360 and the host device 2380 are removably coupled. For instance, the host device 2380 can include a physical port, outlet, opening, or similar to receive and communicatively couple to the cryptographic wallet 2360, directly or via a connector.

In some embodiments, the cryptographic wallet 2360 includes tangible storage media, such as a dynamic random-access memory (DRAM) stick, a memory card, a secure digital (SD) card, a flash drive, a solid state drive (SSD), a magnetic hard disk drive (HDD), or an optical disc, and/or the like and can connect to the host device via a suitable interface, such as a memory card reader, a USB port, a micro-USB port, an eSATA port, and/or the like.

In some embodiments, the cryptographic wallet 2360 can include an integrated circuit, such as a SIM card, a smart cart, and/or the like. For instance, in some embodiments, the cryptographic wallet 2360 can be a physical smart card that includes an integrated circuit, such as a chip that can store data. In some embodiments, the cryptographic wallet 2360 is a contactless physical smart card. Advantageously, such embodiments enable data from the card to be read by a host device as a series of application protocol data units (APDUs) according to a conventional data transfer protocol between payment cards and readers (e.g., ISO/IEC 7816), which enhances interoperability between the cryptographic payment ecosystem and payment card terminals.

In some embodiments, the cryptographic wallet 2360 and the host device 2380 are non-removably coupled . For instance, various components of the cryptographic wallet 2360 can be co-located with components of the host device 2380 in the housing of the host device 2380. In such embodiments, the host device 2380 can be a mobile device, such as a phone, a wearable, or similar, and the cryptographic wallet 2360 can be built into the host device. The integration between the cryptographic wallet 2360 and the host device 2380 can enable improved user experience and extend the feature set of the cryptographic wallet 2360 while preserving computing resources (e.g., by sharing the computing resources, such as transceiver, processor, and/or display or the host device 2380). The integration further enables the ease of asset transfer between parties. The integration can further enhance loss protection options, as recovering a password or similar authentication information, rather than recovering a physical device, can be sufficient to restore access to digital assets stored in the cryptographic wallet 2360. In some embodiments, the non-removably coupled cryptographic wallet 2360 can be air-gapped by, for example, disconnecting the host device 2380 from the Internet.

As shown, the cryptographic wallet 2360 can include a microcontroller 2362. The microcontroller 2362 can include or be communicatively coupled to (e.g., via a bus or similar communication pathway) at least a secure memory 2364. The cryptographic wallet 2360 can further include a transceiver 2382a, and input/output circuit 2384a, and/or a processor 2386a. In some embodiments, however, some or all of these components can be omitted.

In some embodiments, the cryptographic wallet 2360 can include a transceiver 2382a and therefore can be capable of independently connecting to a network and exchanging electronic messages with other computing devices. In some embodiments, the cryptographic wallet 2360 does not include a transceiver 2382a. The cryptographic wallet 2360 can be capable of connecting to or accessible from a network, via the transceiver 2382b of the host device 2380, when the cryptographic wallet 2360 is docked to the host device 2380. For example, in some embodiments, the user of the cryptographic wallet 2360 can participate in token exchange activities on decentralized exchanges when the cryptographic wallet 2360 is connected to the host device 2380.

In some embodiments, the cryptographic wallet 2360 can include an input/output circuit 2384a, which may include user-interactive controls, such as buttons, sliders, gesture-responsive controls, and/or the like. The user-interactive controls can allow a user of the cryptographic wallet 2360 to interact with the cryptographic wallet 2360 (e.g., perform balance inquiries, convert tokens, access exchanges and/or marketplaces, perform transactions, access computing systems, and/or the like). In some embodiments, the user can access an expanded feature set, via the input/output circuit 2384b of the host device 2380, when the cryptographic wallet 2360 is docked to the host device 2380. For example, host device 2380 can include computer-executable code structured to securely access data from the secure memory 2364 of the cryptographic wallet 2360 and to perform operations using the data. The data can include authentication information, configuration information, asset keys, and/or token management instructions. The data can be used by an application that executes on or by the host device 2380. The data can be used to construct application programming interface (API) calls to other applications that require or use the data provided by cryptographic wallet 2360. Other applications can include any on-chain or off-chain computer applications, such as dApps (e.g., decentralized lending applications, decentralized cryptocurrency exchanges, decentralized NFT marketplaces, decentralized gaming platforms, decentralized social media platforms, decentralized music streaming platforms), third-party computing systems (e.g., financial institution computing systems, social networking sites, gaming systems, online marketplaces), and/or the like.

The secure memory 2364 is shown to include an authentication circuit 2366 and a digital asset management circuit 2372. The authentication circuit 2366 and/or digital asset management circuit 2372 include computer-executable code that, when executed by one or more processors, such as one or more processors 2386a and/or 2386b, performs specialized computer-executable operations. For example, the authentication circuit 2366 can be structured to cause the cryptographic wallet 260 to establish, maintain and manage a secure electronic connection with another computing device, such as the host device 2380. The digital asset management circuit 2372 can be structured to cause the cryptographic wallet 2360 to allow a user to manage the digital assets accessible via the cryptographic wallet 2360. In some embodiments, the authentication circuit 2366 and the digital asset management circuit 2372 are combined in whole or in part.

As shown, the authentication circuit 2366 can include retrievably stored security, authentication, and/or authorization data, such as the authentication key 2368. The authentication key 2368 can be a numerical, alphabetic, or alphanumeric value or combination of values. The authentication key 2368 can serve as a security token that enables access to one or more computing systems, such as the host device 2380. For instance, in some embodiments, when the cryptographic wallet 2360 is paired or docked to (e.g., establishes an electronic connection with) the host device 2380, the user may be prompted to enter authentication information via the input output circuit(s) 2384a and/or 2384b. The authentication information may include a PIN, a password, a pass phrase, biometric information (e.g., fingerprint, a set of facial features, a retinal scan), a voice command, and/or the like. The authentication circuit 2366 can compare the user-entered information to the authentication key 2368 and maintain the electronic connection if the items match at least in part.

As shown, the authentication circuit 2366 can include retrievably stored configuration information 2370. The configuration information 2370 can include a numerical, alphabetic, or alphanumeric value or combination of values. These items can be used to enable enhanced authentication protocols. For instance, the configuration information 2370 can include a timeout value for an authorized connection between the cryptographic wallet 2360 and the host device 2380. The configuration information 2370 can also include computer-executable code. In some embodiments, for example, where a particular cryptographic wallet 2360 is set up to pair with only one or a small number of pre-authorized host devices 2380, the configuration information 2370 can include a device identifier and/or other device authentication information, and the computer-executable code may be structured to verify the device identifier and/or other device authentication information against the information associated with or provided by the host device 2380. When a pairing is attempted, the computer-executable code may initiate or cause the host device 2380 to initiate an electronic communication (e.g., an email message, a text message, etc.) using user contact information stored as configuration information 2370.

As shown, the digital asset management circuit 2372 can include retrievably stored digital asset data, such as the asset key 2374. The asset key 2374 can be a numerical, alphabetic, or alphanumeric value or combination of values. In some embodiments, the asset key 2374 is a private key in a public/private key pair, a portion thereof, or an item from which the private key can be derived. Accordingly, the asset key 2374 proves ownership of a particular digital asset stored on a blockchain system 2200. The asset key 2374 can allow a user to perform blockchain transactions involving the digital asset. The blockchain transactions can include computer-based operations to earn, lend, borrow, long/short, earn interest, save, buy insurance, invest in securities, invest in stocks, invest in funds, send and receive monetary value, trade value on decentralized exchanges, invest and buy assets, sell assets, and/or the like. The cryptographic wallet 2360 can be identified as a party to a blockchain transaction on the blockchain system 2200 using a unique cryptographically generated address (e.g., the public key in the public/private key pair).

As shown, the digital asset management circuit 2372 can also include retrievably stored asset management instructions 2376. The asset management instructions 2376 can include a numerical, alphabetic, or alphanumeric value or combination of values. These items can be used to enable computer-based operations related to managing digital assets identified by the asset key(s) 2374. For instance, the asset management instructions 2376 can include parameter values, metadata, and/or similar values associated with various tokens identified by the asset key(s) 2374 and/or by the blockchain systems 2200 associated with particular tokens. The asset management instructions 2376 can also include computer-executable code. In some embodiments, for example, asset management functionality (e.g., balance inquiry and the like) can be executable directly from the cryptographic wallet 2360 rather than or in addition to being executable from the host device 2380.

FIG. 24 is a block diagram illustrating an example machine learning (ML) system 2400, in accordance with one or more embodiments. The ML system 2400 is implemented using components of the example computer system 2500 illustrated and described in more detail with reference to FIG. 25. For example, the ML system 2400 can be implemented on the computer system 2500 using instructions 2508 programmed in the main memory 2506 illustrated and described in more detail with reference to FIG. 25. Likewise, embodiments of the ML system 2400 can include different and/or additional components or be connected in different ways. The ML system 2400 is sometimes referred to as a ML module.

The ML system 2400 includes a feature extraction module 2408 implemented using components of the example computer system 2500 illustrated and described in more detail with reference to FIG. 25. In some embodiments, the feature extraction module 2408 extracts a feature vector 2412 from input data 2404. The feature vector 2412 includes features 2412a, 2412b, ..., 2412n. The feature extraction module 2408 reduces the redundancy in the input data 2404, e.g., repetitive data values, to transform the input data 2404 into the reduced set of features 2412, e.g., features 2412a, 2412b, ..., 2412n. The feature vector 2412 contains the relevant information from the input data 2404, such that events or data value thresholds of interest can be identified by the ML model 2416 by using this reduced representation. In some example embodiments, the following dimensionality reduction techniques are used by the feature extraction module 2408: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In some embodiments, the ML model 2416 performs deep learning (also known as deep structured learning or hierarchical learning) directly on the input data 2404 to learn data representations, as opposed to using task-specific algorithms. In deep learning, no explicit feature extraction is performed; the features 2412 are implicitly extracted by the ML system 2400. For example, the ML model 2416 can use a cascade of multiple layers of nonlinear processing units for implicit feature extraction and transformation. Each successive layer uses the output from the previous layer as input. The ML model 2416 can thus learn in supervised (e.g., classification) and/or unsupervised (e.g., pattern analysis) modes. The ML model 2416 can learn multiple levels of representations that correspond to different levels of abstraction, wherein the different levels form a hierarchy of concepts. In this manner, the ML model 2416 can be configured to differentiate features of interest from background features.

In one example, the ML model 2416, e.g., in the form of a CNN generates the output 2424, without the need for feature extraction, directly from the input data 2404. In some examples, the output 2424 is provided to the computer device 2428 or video display 2518. The computer device 2428 is a server, computer, tablet, smartphone, smart speaker, etc., implemented using components of the example computer system 2500 illustrated and described in more detail with reference to FIG. 25. In some embodiments, the steps performed by the ML system 2400 are stored in memory on the computer device 2428 for execution.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 2416 can be a CNN that includes both convolutional layers and max pooling layers. The architecture of the ML model 2416 can be “fully convolutional,” which means that variable sized sensor data vectors can be fed into it. For all convolutional layers, the ML model 2416 can specify a kernel size, a stride of the convolution, and an amount of zero padding applied to the input of that layer. For the pooling layers, the model 2416 can specify the kernel size and stride of the pooling.

In some embodiments, the ML system 2400 trains the ML model 2416, based on the training data 2420, to correlate the feature vector 2412 to expected outputs in the training data 2420. As part of the training of the ML model 2416, the ML system 2400 forms a training set of features and training labels by identifying a positive training set of features that have been determined to have a desired property in question, and, in some embodiments, forms a negative training set of features that lack the property in question.

The ML system 2400 applies ML techniques to train the ML model 2416, that when applied to the feature vector 2412, outputs indications of whether the feature vector 2412 has an associated desired property or properties, such as a probability that the feature vector 2412 has a particular Boolean property, or an estimated value of a scalar property. The ML system 2400 can further apply dimensionality reduction (e.g., via linear discriminant analysis (LDA), PCA, or the like) to reduce the amount of data in the feature vector 2412 to a smaller, more representative set of data.

The ML system 2400 can use supervised ML to train the ML model 2416, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 2432 is formed of additional features, other than those in the training data 2420, which have already been determined to have or to lack the property in question. The ML system 2400 applies the trained ML model 2416 to the features of the validation set 2432 to quantify the accuracy of the ML model 2416. Common metrics applied in accuracy measurement include: Precision and Recall, where Precision refers to a number of results the ML model 2416 correctly predicted out of the total it predicted, and Recall is a number of results the ML model 2416 correctly predicted out of the total number of features that had the desired property in question. In some embodiments, the ML system 2400 iteratively re-trains the ML model 2416 until the occurrence of a stopping condition, such as the accuracy measurement indication that the ML model 2416 is sufficiently accurate, or a number of training rounds having taken place. This allows the detected values to be validated using the validation set 2432. The validation set 2432 can be generated based on analysis to be performed.

FIG. 25 is a block diagram illustrating an example computer system, in accordance with one or more embodiments. In some embodiments, components of the example computer system 2500 are used to implement the blockchain system 2200 or the ML system 2400 illustrated and described in more detail with reference to FIGS. 22 and 24. At least some operations described herein can be implemented on the computer system 2500.

The computer system 2500 can include one or more central processing units (“processors”) 2502, main memory 2506, non-volatile memory 2510, network adapters 2512 (e.g., network interface), video displays 2518, input/output devices 2520, control devices 2522 (e.g., keyboard and pointing devices), drive units 2524 including a storage medium 2526, and a signal generation device 2520 that are communicatively connected to a bus 2516. The bus 2516 is illustrated as an abstraction that represents one or more physical buses and/or point-to-point connections that are connected by appropriate bridges, adapters, or controllers. The bus 2516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 2500 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 2500.

While the main memory 2506, non-volatile memory 2510, and storage medium 2526 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 2528. The term “machine-readable medium” and “storage medium” shall also be taken to include any medium that is capable of storing, encoding, or carrying a set of instructions for execution by the computer system 2500.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 2504, 2508, 2528) set at various times in various memory and storage devices in a computer device. When read and executed by the one or more processors 2502, the instruction(s) cause the computer system 2500 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 2510, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 2512 enables the computer system 2500 to mediate data in a network 2514 with an entity that is external to the computer system 2500 through any communication protocol supported by the computer system 2500 and the external entity. The network adapter 2512 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 2512 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

The description and drawings herein are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications may be implemented by those skilled in the art.

What is claimed is:

1. A computer-implemented method for performing a per-node operation, the method comprising:
receiving, by a computer system, a request at a first node of a hierarchically indexed multimedia database categorizing products and services,
wherein the database hierarchically organizes video, audio, and documents per node,
wherein the request is for performing a node-to-node action involving the first node and a second node of the database, and
wherein the request excludes a location of the second node in the database;
extracting, from the request, features indicative of the location of the second node;
locating, using a machine learning module based on the features, a branch supporting a node tree of the database,
wherein the machine learning module is trained using other received requests involving the second node, and
wherein the node tree includes the second node;
traversing the node tree using a structure of the database to determine the location of the second node;
performing the node-to-node action involving the first node and the second node to satisfy the request; and
transmitting a response to the at least one issuer entity or investor entity,
wherein the response indicates that the node-to-node action has been performed.

2. The method of claim 1, wherein the database hierarchically organizes at least one of podcasts-per-node or messaging-per-node.

3. The method of claim 1, wherein the request indicates a search for digital content posted by the second node, and
wherein performing the node-to-node action comprises:
searching, using the machine learning module, the digital content based on social media engagement performed at the first node.

4. The method of claim 1, wherein performing the node-to-node action comprises:
weighting a relevance metric associated with the second node based on a number of times digital content for a particular industry was accessed at the second node; and
retrieving, at the first node, multimedia content based on the relevance metric associated with the second node.

5. The method of claim 1, wherein performing the node-to-node action comprises:
sending, at the first node, a video of a website to the second node; and
responsive to receiving, from the second node, an indication of receipt of the video, opening a communications channel between the first node and the second node.

6. The method of claim 1, wherein performing the node-to-node action comprises:
grouping employment categories referenced by the first and second nodes into groups of jobs based on shared characteristics;
assigning a taxonomic rank to each group;
aggregating groups of a particular rank to generate a taxonomic hierarchy; and
generating an employment taxonomy based on the taxonomic hierarchy.

7. The method of claim 1, wherein performing the node-to-node action comprises:
transferring ownership of a non-fungible token (NFT) from the first node to the second node,
wherein the NFT is stored on a blockchain, and
wherein at least one key referencing the NFT is sent from the first node to the second node to transfer the ownership.

8. The method of claim 1, wherein performing the node-to-node action comprises:
generating a comparison between first technical indicators for a first industry associated with the first node and second technical indicators for a second industry associated with the second node; and
sending the comparison to the at least one issuer entity or investor entity.

9. The method of claim 1, wherein the machine learning model is trained to perform search ranking using the other received requests.

10. The method of claim 1, wherein the machine learning model performs at least one of query classification or query expansion on the request.

11. The method of claim 1, wherein the machine learning model performs intent disambiguation on the request.

12. A computer system for performing a per-node operation, the computer system comprising:
at least one computer processor; and
a non-transitory computer-readable storage medium storing computer instructions, which when executed by the at least one computer processor cause the computer system to:
receive a request at a first node of a hierarchically indexed multimedia database categorizing products and services,
wherein the database hierarchically organizes video, audio, and documents per node,
wherein the request is for performing a node-to-node action involving the first node and a second node of the database, and
wherein the request excludes a location of the second node in the database;
locate, using a machine learning module, a branch supporting a node tree of the database,
wherein the node tree includes the second node;
traverse the node tree using a structure of the database to determine the location of the second node;
perform the node-to-node action involving the first node and the second node to satisfy the request; and
transmit a response to the at least one issuer entity or investor entity,
wherein the response indicates that the node-to-node action has been performed.

13. The computer system of claim 12, wherein the request indicates a search for digital content posted by the second node, and
wherein the instructions to perform the node-to-node action cause the computer system to:
search, using the machine learning module, the digital content based on social media engagement performed at the first node.

14. The computer system of claim 12, wherein the instructions to perform the node-to-node action cause the computer system to:
weight a relevance metric associated with the second node based on a number of times digital content for a particular industry was accessed at the second node; and
retrieve, at the first node, multimedia content based on the relevance metric associated with the second node.

15. The computer system of claim 12, wherein the instructions to perform the node-to-node action cause the computer system to:
send, at the first node, a video of a website to the second node; and
responsive to receiving, from the second node, an indication of receipt of the video, open a voice over IP (VoIP) channel between the first node and the second node.

16. The computer system of claim 12, wherein the instructions to perform the node-to-node action cause the computer system to:
group employment categories referenced by the first and second nodes into groups of jobs based on shared characteristics;
assign a taxonomic rank to each group;
aggregate groups of a particular rank to generate a taxonomic hierarchy; and
generate an employment taxonomy based on the taxonomic hierarchy.

17. The computer system of claim 12, wherein the instructions to perform the node-to-node action cause the computer system to:
transfer ownership of a non-fungible token (NFT) from the first node to the second node,
wherein the NFT is stored on a blockchain, and
wherein at least one key referencing the NFT is sent from the first node to the second node to transfer the ownership.

18. The computer system of claim 12, wherein the instructions to perform the node-to-node action cause the computer system to:
generate a comparison between first technical indicators for a first industry associated with the first node and second technical indicators for a second industry associated with the second node; and
send the comparison to the at least one issuer entity or investor entity.

19. The computer system of claim 12, wherein the machine learning model is trained to perform search ranking using the other received requests.

20. A non-transitory computer-readable storage medium storing computer instructions, which when executed by at least one computer processor cause the at least one computer processor to:
receive a request at a first node of a hierarchically indexed multimedia database categorizing products and services,
wherein the database hierarchically organizes video, audio, and documents per node,
wherein the request is for performing a node-to-node action involving the first node and a second node of the database, and
wherein the request excludes a location of the second node in the database;
locate, using a machine learning module, a branch supporting a node tree of the database,
wherein the node tree includes the second node;
traverse the node tree using a structure of the database to determine the location of the second node;
perform the node-to-node action involving the first node and the second node to satisfy the request; and
transmit a response to the at least one issuer entity or investor entity,
wherein the response indicates that the node-to-node action has been performed.
